(19) United States
(12) Patent Application Publication
(10) Pub. No.: US 2015/0097885 A1
(43) Pub. Date: Apr. 9, 2015

(54) PRINTING APPARATUS AND METHOD OF CONTROLLING PRINTING APPARATUS

(71) Applicant: Seiko Epson Corporation, Tokyo (JP)

(72) Inventor: Yasuhiro HOSOKAWA, Shiojiri (JP)

(21) Appl. No.: 14/504,811

(22) Filed: Oct. 2, 2014

(30) Foreign Application Priority Data
Oct. 8, 2013 (JP) 2013-211021

(51) Int. Cl. B41J 2/045

(52) U.S. Cl. CPC B41J 2/04541; B41J 2/04563; B41J 2/04581
USPC 347/10

(57) ABSTRACT

A printing apparatus includes a driving signal generation unit that generates a driving signal; a piezoelectric element that displaces according to the signal; a cavity whose inside is filled with an ink and in which a pressure in the inside is increased or decreased due to the displacement of the piezoelectric element based on the signal; an ejection unit that includes a nozzle communicating with the cavity and capable of ejecting the ink filled in the inside of the cavity by the increase or the decrease of the pressure in the inside of the cavity; a residual vibration detection unit that detects a change of an electromotive force based on the change of the pressure in the inside of the cavity; and an ejection state determination unit that determines an ejection state of the ink in the ejection unit based on the detection result of the residual vibration detection unit.

### BACKGROUND

1. Technical Field

The present invention relates to a printing apparatus and a method of controlling a printing apparatus.

2. Related Art

An ink jet printer allows an ink filled in a cavity of an ejection unit to be ejected and forms an image on a recording medium such as recording paper by allowing a piezoelectric element provided in the ejection unit of a head to be driven by a driving signal.

However, when the ink in the cavity is thickened, ejection abnormality occurs and the image quality of the image to be printed is degraded in some cases. Further, in a case where the ink in the cavity includes bubbles or paper dust is adhered to the vicinity of a nozzle of the ejection unit, ejection abnormality occurs and the image quality of the image to be printed is degraded in some cases. Accordingly, it is preferable to perform a printing process by inspecting an ejection state of the ink in the ejection unit and confirming non-occurrence of ejection abnormality for realizing high grade printing.

JP-A-2013-028183 discloses a technique of detecting residual vibration generated in the ejection unit which includes a piezoelectric element when the piezoelectric element is driven by the driving signal and inspecting whether the ejection state of the ink in the ejection unit is normal by determining whether a cycle of the detected residual vibration is in a predetermined range.

However, in general, the viscosity of the ink changes according to the temperature of the ink. When the viscosity of the ink in the inside of the cavity is changed, the mode of change of the pressure in the inside of the cavity which is generated after the piezoelectric element is displaced. As a result, when the temperature of the ink is changed, a waveform of the residual vibration of the piezoelectric element based on the change of the pressure in the inside of the cavity is changed.

Accordingly, in a case of inspecting the ejection state of the ink in the ejection unit based on the residual vibration, there is a problem in that accurate inspection cannot be made because the shape of the residual vibration is changed according to the temperature change of the ink when the temperature of the ink is changed. The problem became evident in a case where an ink having properties in which the viscosity of the ink is largely changed according to the temperature change of the ink such as an ultraviolet curable ink.

### SUMMARY

An advantage of some aspects of the invention is to provide a technique of performing determination on an ejection state of an ink in an ejection unit with high precision even in a case where the viscosity of the ink is changed according to the temperature of the ink.

According to an aspect of the invention, there is provided a printing apparatus including a driving signal generation unit that generates a driving signal; an ejection unit that includes a piezoelectric element which is displaced according to the driving signal, a pressure chamber whose inside is filled with a liquid and in which a pressure in the inside is increased or decreased due to the displacement of the piezoelectric element based on the driving signal, and a nozzle which communicates with the pressure chamber and is capable of ejecting the liquid filled in the inside of the pressure chamber due to the increase or the decrease of the pressure in the inside of the pressure chamber; a detection unit that detects a change of an electromotive force of the piezoelectric element as a residual vibration signal based on a change of the pressure in the inside of the pressure chamber, which is generated after the driving signal is supplied to the piezoelectric element in a case where the temperature of the liquid filled in the inside of the pressure chamber is within a predetermined temperature range; and an ejection state determination unit that determines an ejection state of the liquid in the ejection unit based on the detection result of the detection unit.

In general, the viscosity of the ink is changed according to the temperature of the liquid. In addition, in a case where the viscosity of the liquid in the inside of the pressure chamber is changed, the mode of the change of the pressure in the inside of the pressure chamber generated after the piezoelectric element is displaced is changed. That is, when the temperature of the liquid is changed, the waveform of the residual vibration signal of the piezoelectric element is changed based on the change of the pressure in the inside of the pressure chamber. Accordingly, when the temperature change of the liquid is not considered in a case where the ejection state of the liquid in the ejection unit is determined based on the residual vibration signal, since the determination is made without considering the change of the waveform of the residual vibration signal due to the temperature change of the liquid even when the waveform of the residual vibration signal is changed due to the temperature change of the liquid, the ejection state of the liquid cannot be accurately determined in some cases.

In the invention, the ejection state of the liquid in the ejection unit is determined based on the residual vibration signal detected in a case where the temperature of the liquid is within a predetermined temperature range. When the temperature of the liquid is within the predetermined temperature range, the viscosity of the liquid is within a predetermined range. Therefore, in the invention, it is possible to minimize influence due to the change of the viscosity of the liquid on the waveform of the residual vibration signal by comparing with the case of determining the ejection state of the liquid in the ejection unit without considering the temperature of the liquid. Accordingly, in the invention, it is possible to minimize the change of the waveform of the residual vibration signal due to the change of the viscosity of the liquid and to accurately determine the ejection state of the liquid in the ejection unit.

According to an aspect of the invention, there is provided a printing apparatus including a driving signal generation unit that generates a driving signal; an ejection unit that includes a piezoelectric element which is displaced according to the driving signal, a pressure chamber whose inside is filled with a liquid and in which a pressure in the inside is increased or decreased due to the displacement of the piezoelectric element based on the driving signal, and a nozzle which communicates with the pressure chamber and is capable of ejecting the liquid filled in the inside of the pressure chamber due to the increase or the decrease of the pressure in the inside of the pressure chamber; an output unit that outputs a detection signal indicating a value of the volume of the liquid filled in the inside of the pressure chamber according to the temperature; a temperature determination unit that determines whether the value indicated by the detection signal is a value indicating that the temperature of the liquid filled in the inside of the pressure chamber is within a predetermined temperature range; a detection unit that detects a change of an electromotive force of the piezoelectric element as a residual vibration signal based on a change of the pressure in the inside of the pressure chamber, which is generated after the driving signal for inspection is supplied to the piezoelectric element by the driving signal generation unit; and an ejection state determination unit that is capable of determining an ejection state of the liquid in the ejection state based on the detection result of the detection unit, in which the ejection state determination unit determines the ejection state of the liquid in the ejection state in a case where the detection result of the temperature determination unit is positive and does not determine the ejection state of the liquid in the ejection state in a case where the detection result of the temperature determination unit is negative.

In the invention, the ejection state determination unit determines the ejection state of the liquid in the ejection unit in a case where the temperature of the liquid is within the predetermined temperature range. When the temperature of the liquid is within the predetermined temperature range, the viscosity of the liquid is within the predetermined range. Accordingly, in the invention, it is possible to minimize influence due to the change of the viscosity of the liquid on the waveform of the residual vibration signal by comparing with the case of determining the ejection state of the liquid in the ejection unit without considering the temperature of the liquid. Therefore, in the invention, it is possible to minimize the change of the waveform of the residual vibration signal due to the change of the viscosity of the liquid and to accurately determine the ejection state of the liquid in the ejection unit.

Further, according to the aspect of the invention, the printing apparatus including a driving signal generation unit that generates a driving signal; an ejection unit that includes a piezoelectric element which is displaced according to the driving signal, a pressure chamber whose inside is filled with a liquid and in which a pressure in the inside is increased or decreased due to the displacement of the piezoelectric element based on the driving signal, and a nozzle which communicates with the pressure chamber and is capable of ejecting the liquid filled in the inside of the pressure chamber due to the increase or the decrease of the pressure in the inside of the pressure chamber; an output unit that outputs a detection signal indicating a value of the volume of the liquid filled in the inside of the pressure chamber according to the temperature; a temperature determination unit that determines whether the value indicated by the detection signal is a value indicating that the temperature of the liquid filled in the inside of the pressure chamber is within a predetermined temperature range; a detection unit that detects a change of an electromotive force of the piezoelectric element as a residual vibration signal based on a change of the pressure in the inside of the pressure chamber, which is generated after the driving signal for inspection is supplied to the piezoelectric element by the driving signal generation unit; and an ejection state determination unit that is capable of determining an ejection state of the liquid in the ejection state based on the detection result of the detection unit.

Further, according to the aspect of the invention, it is preferable that the above-described printing apparatus include a heating unit that heats the liquid in the inside of the pressure chamber in a case where the value indicated by the detection signal is a value indicating that the temperature of the liquid filled in the inside of the pressure chamber is lower than a lower limit of the predetermined temperature range.

Further, according to the aspect of the invention, it is preferable that the above-described printing apparatus include a decision unit that decides a waveform of the driving signal for inspection according to the value indicated by the detection signal.

In a case where the temperature of the liquid is changed within the predetermined temperature range, since the viscosity of the liquid is changed, the ejection state of the liquid in the ejection unit cannot be accurately determined in some cases. According to the aspect, it is possible to make accurate determination for determining the ejection state of the liquid in the ejection unit using the driving signal for inspection according to the change of the temperature of the liquid in the predetermined temperature range.

Further, in the above-described printing apparatus, it is preferable that the decision unit perform a calibration operation of adjusting the waveform of the driving signal for inspection in a case where the value indicated by the detection signal is a value indicating that the temperature of the liquid filled in the inside of the pressure chamber is within the predetermined temperature range.

Even in a case where the temperature of the liquid is not changed, the change of the composition of the ink or mechanical and electrical characteristics of the ejection unit with time may affect the waveform of the residual vibration signal. According to the aspect of the invention, when the change with time occurs, it is possible to accurately determine the ejection state because the ejection state of the liquid in the ejection unit is determined using the driving signal for inspection in consideration of the change with time.

Further, in the above-described printing apparatus, it is preferable that the liquid having a viscosity at 20° C. of 15 mPa·s to 25 mPa·s.

When the viscosity of the liquid at 20° C. is smaller than or equal to 25 mPa·s, ejection stability of the liquid becomes excellent. In addition, when the viscosity of the liquid at 20° C. is larger than or equal to 15 mPa·s, it is possible to effectively suppress generation of curing wrinkles.

Further, in the above-described printing apparatus, it is preferable that the predetermined temperature range be in the range of 30° C. to 40° C. and the viscosity of the liquid in the predetermined temperature range be in the range of 8 mPa·s to 15 mPa·s.

While the viscosity of the liquid at 20° C. is in the range of 15 mPa·s to 25 mPa·s, the viscosity thereof at 30° C. to 40° C. is 8 mPa·s to 15 mPa·s. That is, the viscosity of the liquid is largely changed according to the change of the temperature.

According to the aspect, in a case where the temperature of the liquid is within the predetermined temperature range, that is, the viscosity of the liquid is within the predetermined range, determination on the ejection state of the liquid in the ejection unit is made. Therefore, it is possible to minimize the change of the waveform of the residual vibration due to the change of the viscosity of the liquid and to accurately determine the ejection state.

Further, in the above-described printing apparatus, it is preferable that the predetermined temperature range be in the range of 30° C. to 40° C. and the liquid be an ultraviolet curable ink having an average equivalent of a polymerizable unsaturated double bond of 100 to 150.

When a photo-curable ink containing a polymerizable compound is irradiated with light, the polymerizable compound is photopolymerized and the photo-curable ink is solidified (cured). At this time, reaction heat is generated due to the photopolymerization reaction. However, since an energy curable ink composition disclosed in Japanese Patent No. 4335955 is a low viscosity and highly reactive ink, an acryl equivalent of the polymerizable compound as a constituent component is defined, but the reaction heat generated at the time of curing the ink is not considered because the acryl equivalent of the entire ink is not defined. Therefore, when ink jet recording is performed using the ink composition disclosed in Japanese Patent No. 4335955, an amount of the reaction heat becomes large with time, the temperature in the printing apparatus becomes largely increased, and thus the viscosity of the ink at the time of ejection is changed. Accordingly, the impact position of the ink is shifted or the ejection amount is change so that the image quality of an image to be obtained is not stabilized in terms of graininess or hue. In this manner, when the ink composition disclosed in Japanese Patent No. 4335955 is used for recording for a long period of time such as continuous printing, excellent curability and ejection stability cannot be established, and thus the recording becomes difficult.

The present inventors have further researched from a viewpoint of the reaction heat. Firstly, they found that the viscosity of the ink is necessary to be high for suppressing the amount of the reaction heat and the temperature of the ink (hereinafter, also referred to as “ejection temperature”) to be ejected from the ejection unit is necessary to be high by warming the ink to be ejected from the ejection unit. However, in this case, there is a problem in that the temperature in the printing apparatus is largely increased. In contrast, the viscosity of the ink is decreased for suppressing the temperature of the ink to be ejected from the ejection unit to be relatively low, the amount of the reaction heat generated at the time of curing becomes increased. Even in this case, the temperature in the printing apparatus becomes highly increased.

From this knowledge, as a result of intensive research on the problem due to the above-described reaction heat, the present inventors found that the image quality of the image to be obtained becomes stabilized and excellent by stably maintaining the temperature in the printing apparatus, particularly the ejection temperature in a state of a relatively low temperature. Specifically, it is possible to sufficiently suppress the amount of the reaction heat generated at the time of curing by maintaining the ejection temperature to be in the range of 30° C. to 40° C.

Further, the present inventors have further researched in consideration of the low viscosity of the ink for establishing the excellent curability and ejection stability in an ink jet recording method.

As a result, they found that the above-described problems can be solved by an ink jet recording method including an ejection process of ejecting an ultraviolet curable ink having a viscosity at 20° C. of 25 Pa·s or less and an average equivalent of a polymerizable unsaturated double bond of 100 to 150 toward a recorded medium from the ejection unit in an ejection temperature of 30° C. to 40° C. and a curing process of curing an ultraviolet curable ink adhered to the recorded medium by performing irradiation of ultraviolet rays from a light source, thereby completing the invention.

Further, in the above-described printing apparatus, it is preferable that the ultraviolet curable ink contain monofunctional (meth)acrylate having a content of 30% by mass to 70% by mass and bifunctional or multi-functional (meth)acrylate having a content of 20% by mass to 60% by mass.

According to the aspect, the viscosity of the ink, specifically, the viscosity of the ink at 20° C. or the viscosity of the ink at the temperature (ejection temperature) within the predetermined temperature range can be easily set to be in a desired range. In addition, when the content thereof more than or equal to the above-described lower limit, the curability becomes more excellent and the solubility of the photopolymerization initiator becomes excellent. Further, when the content thereof is less than or equal to the above-described upper limit, the curability becomes more excellent and adhesive properties become excellent.

Further, in the above-described printing apparatus, it is preferable that the ultraviolet curable ink be an ink which is curable by performing irradiation of an irradiation energy of 200 mJ/cm² or less.

According to the aspect, the ink can be cured using an LED having a relatively small amount of the irradiation energy and generation of heat of the LED can be suppressed to be low, and it is possible to realize low-cost printing at a high printing speed.

According to an aspect of the invention, there is provided a method of controlling a printing apparatus which includes a driving signal generation unit that generates a driving signal; and an ejection unit that includes a piezoelectric element which is displaced according to the driving signal, a pressure chamber whose inside is filled with a liquid and in which a pressure in the inside is increased or decreased due to the displacement of the piezoelectric element based on the driving signal, and a nozzle which communicates with the pressure chamber and is capable of ejecting the liquid filled in the inside of the pressure chamber due to the increase or the decrease of the pressure in the inside of the pressure chamber, the method including detecting change of an electromotive force of the piezoelectric element as a residual vibration signal based on change of the pressure in the inside of the pressure chamber, which is generated after the driving signal is supplied to the piezoelectric element in a case where the temperature of the liquid filled in the inside of the pressure chamber is within a predetermined temperature range; and determining an ejection state of the liquid in the ejection unit based on the detection result of the detection unit.

### BRIEF DESCRIPTION OF THE DRAWINGS

The invention will be described with reference to the accompanying drawings, wherein like numbers reference like elements.

FIG. 1 is a schematic view illustrating an outline of a configuration of an ink jet printer according to a first embodiment of the invention.

FIG. 2 is a cross-sectional schematically illustrating the ink jet printer.

FIG. 3 is a block diagram illustrating the configuration of the ink jet printer.

FIG. 4 is a cross-sectional view schematically illustrating a head unit.

FIG. 5 is a plan view illustrating an arrangement example of nozzles in the head unit.

FIGS. 6A to 6C are explanatory diagrams for describing change in cross-sectional shape of the ejection unit when a driving signal is supplied.

FIG. 7 is a circuit view illustrating a model of simple vibration indicating residual vibration in the ejection unit.

FIG. 8 is a graph illustrating a relationship between test values and calculated values of the residual vibration when the ejection state is normal in the ejection unit.

FIG. 9 is an explanatory diagram illustrating a state of the ejection unit when bubbles are mixed into the inside of a cavity.

FIG. 10 is a graph illustrating test values and calculated values of the residual vibration in a state in which an ink cannot be ejected due to the mixture of bubbles into the inside of the cavity.

FIG. 11 is an explanatory diagram illustrating a state of the ejection unit when the ink is adhered to the vicinity of nozzles.

FIG. 12 is a graph illustrating test values and calculated values of the residual vibration in a state in which the ink cannot be ejected due to fixation of the ink to the vicinity of the nozzles.

FIG. 13 is an explanatory diagram illustrating a state of the ejection unit in a case where paper dust is adhered to the vicinity of the outlet of the nozzles.

FIG. 14 is a graph illustrating test values and calculated values of the residual vibration in a state in which the ink cannot be ejected due to the adhesion of paper dust to the vicinity of the outlet of the nozzles.

FIG. 15 is a block diagram illustrating the configuration of a driving signal generation unit.

FIG. 16 is an explanatory diagram illustrating contents of decoding of a decoder.

FIG. 17 is a timing chart illustrating an operation of the driving signal generation unit in a unit operation period.

FIG. 18 is a timing chart illustrating a waveform of a driving signal in the unit operation period.

FIG. 19 is a block diagram illustrating the configuration of a switching unit.

FIG. 20 is a block diagram illustrating the configuration of an ejection abnormality detection circuit.

FIG. 21 is a timing chart illustrating an operation of the ejection abnormality detection circuit.

FIG. 22 is an explanatory diagram describing a determination result signal generated in an ejection state determination unit.

FIG. 23 is a flowchart illustrating the operation of the ink jet printer in an ejection state determination process and a preparation process thereof.

FIG. 24 is an explanatory diagram illustrating a relationship between a temperature of the ink and a detection temperature.

FIG. 25 is a timing chart illustrating a waveform of a driving waveform signal in the unit operation period.

FIG. 26 is a flowchart illustrating the operation of the ink jet printer in a calibration process and a preparation process thereof.

FIG. 27 is a flowchart illustrating the operation of the ink jet printer in the calibration process.

FIG. 28 is a flowchart illustrating the operation of the ink jet printer in a determination process at the time of startup.

FIG. 29 is a flowchart illustrating the operation of the ink jet printer in the determination process during printing.

FIG. 30 is a cross-sectional view schematically illustrating a head unit according to a modified example.

### DESCRIPTION OF EXEMPLARY EMBODIMENTS

Hereinafter, embodiments for implementing the present invention will be described with reference to the drawings. However, throughout the drawings, dimensions and scaling of the respective parts are appropriately different from those of actual parts. Moreover, since embodiments described herein are preferred concrete examples of the present invention, the embodiments are provided with various limitations that are technologically preferred, but the scope of the present invention is not limited to the embodiments unless there is particularly a disclosure which limits the present invention in the following description.

### A. First Embodiment

In the present embodiment, it will be described that an ink jet printer that ejects ink (one example of a “liquid”) to form an image on recording paper P is exemplified as a printer.

### 1. Configuration of Ink Jet Printer

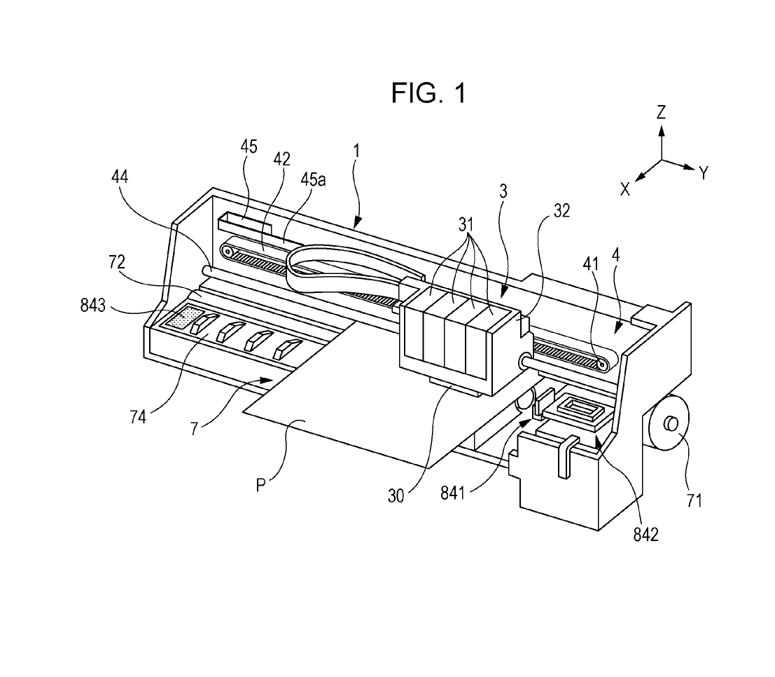

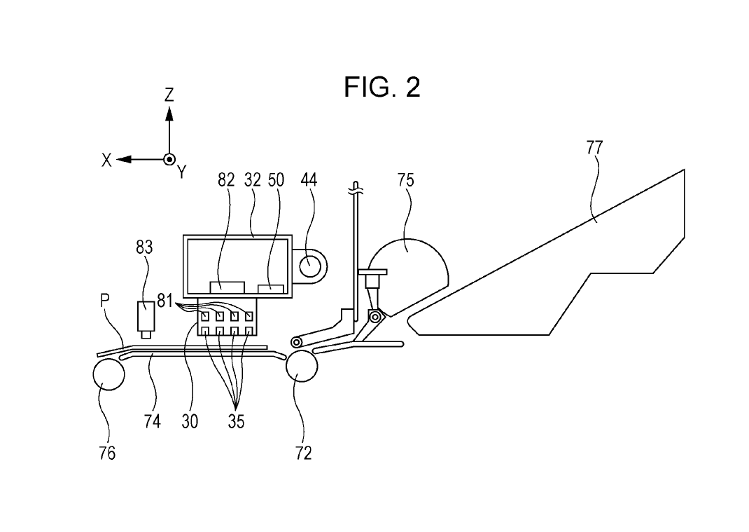

Hereinafter, the configuration of the ink jet printer 1 according to the present embodiment will be described with reference to FIGS. 1 and 2.

FIG. 1 is a perspective view illustrating an outline of the internal configuration of the ink jet printer and FIG. 2 is a cross-sectional view illustrating the outline of the ink jet printer 1.

Moreover, as illustrated in FIG. 1, the ink jet printer 1 includes a reciprocating moving body 3.

The moving body 3 includes a head unit 30 that includes M ejection units 35 (see FIG. 2), four ink cartridges 31, and a carriage 32 on which the head unit 30 and the four ink cartridges 31 are mounted (M is a natural number of four or more). The respective ejection units 35 may have the insides thereof filled with inks supplied from the ink cartridges 31, and eject the filled inks. Moreover, the four ink cartridges 31 are provided in one-to-one correspondence with four colors of yellow, cyan, magenta and black, and the respective ink cartridges 31 are filled with inks of colors corresponding to the ink cartridges 31. Each of the M ejection units 35 receives the ink from any one of the four ink cartridges 31. Accordingly, the four colors of inks can be ejected from the M ejection units 35 as a whole, so that full color printing is realized.

In addition, the ink jet printer 1 according to the embodiment includes four ink cartridges 31 corresponding to four colors of inks, but the invention is not limited thereto, for example, three or less or five or more of ink cartridges 31 corresponding to three or less or five or more of inks may be included. Further, an ink cartridge 31 filled with an ink having a color different from the four colors or only an ink cartridge 31 corresponding to some color among the four colors may be included. That is, the ink jet printer according to the invention may eject one or more colors of inks.

Further, respective ink cartridges 31 may be provided at a separate location in the ink jet printer 1 instead of being mounted on the carriage 32.

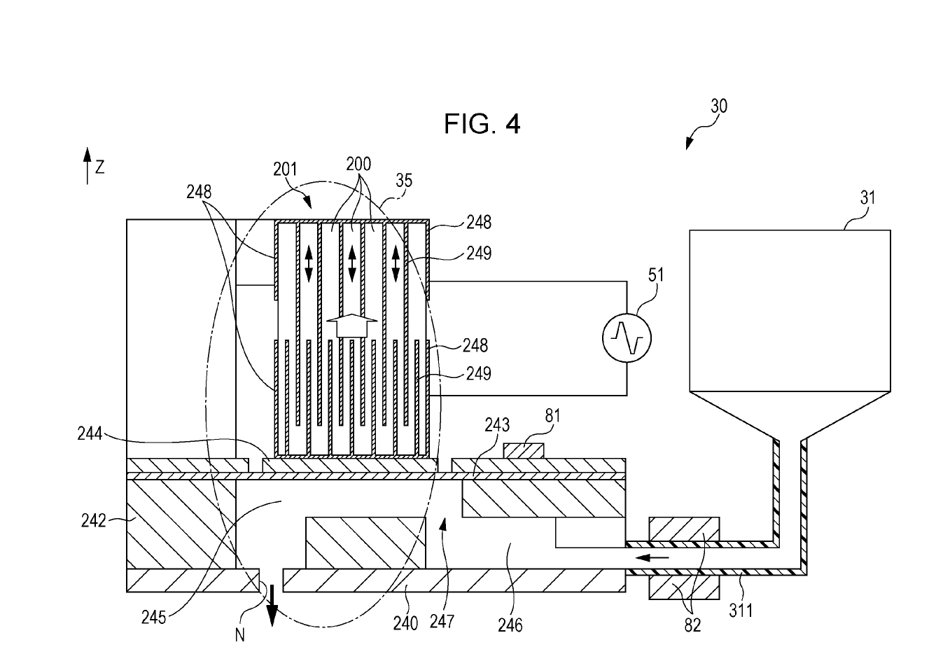

As illustrated in FIG. 2, the moving body 3 is provided with a heater 82 (an example of a “heating unit”) for heating an ink in a channel that supplies the ink (the ink in the ink supply tube 311 illustrated in FIG. 4 described below or in a reservoir 246) to the ejection unit from the ink cartridges 31 or heating the ink in the ejection unit 35, a temperature sensor 81 (an example of an “output unit”) that detects the temperature the ink in the ejection unit 35 in an indirect or direct manner and outputs the detection result, and a head driver 50 that drives the head unit 30.

Further, as illustrated in FIG. 1, the ink jet printer 1 includes a movement mechanism 4 that moves (reciprocates) the moving body 3 in a main scanning direction which is a Y-axis direction in the figure.

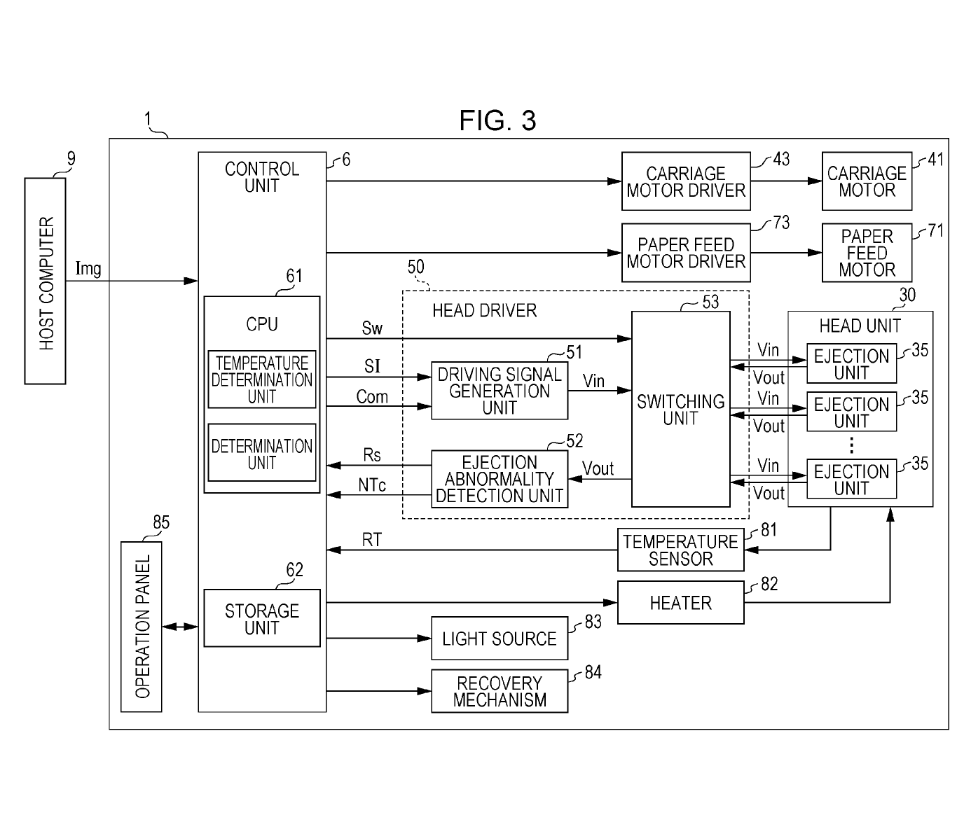

The movement mechanism 4 includes a carriage motor that becomes a driving source reciprocating the moving body 3, a carriage guide shaft 44 to which both ends thereof are fixed, a timing belt 42 that extend in parallel with the carriage guide shaft 44 and is driven by the carriage motor 41, and a carriage motor driver 43 (see FIG. 3) for driving the carriage motor 41.

The carriage 32 of the moving body 3 is supported by the carriage guide shaft 44 of the movement mechanism 4 so as to freely reciprocate and is fixed to a part of the timing belt 42. Accordingly, when the timing belt 42 is moved in a forward or reverse direction through a carriage motor 41, the moving body 3 is guided by the carriage guide shaft 44 and then reciprocates.

Further, the movement mechanism 4 includes a linear encoder 45 for detecting a position of the moving body 3 in the main scanning direction. The linear encoder 45 includes a scale 45a in which a striped pattern is printed at predetermined intervals in the main scanning direction. In addition, a photo-interrupter formed of a pair of a light emitting element and a light receiving element is arranged on the linear encoder 45 side of the carriage 32 and the position of the carriage 32 in the main scanning direction (Y-axis direction) can be recognized by reading the pattern printed on the scale 45a.

As illustrated in FIGS. 1 and 2, the ink jet printer 1 includes a paper feed mechanism 7 for supplying and delivering recording paper P.

The paper feed mechanism 7 includes a paper feed motor 71 serving as a driving source, a paper feed motor driver 73 (see FIG. 3) for driving the paper feed motor 71, a tray 77 that disposes the recording paper P, a paper delivery port (not illustrated) that delivers the recording paper P, a platen 74 that is provided on the lower side (−Z direction in FIGS. 1 and 2) of the head unit 30, paper feed rollers 72 and 75 for feeding the recording paper onto the platen 74 one by one by being rotated through the operation of the paper feed motor 71, and a paper delivering roller 76 that transports the recording paper P on the platen 74 to the paper delivery port by being rotated through the operation of the paper feed motor 71.

The ejection unit 35 performs the printing process of forming an image on the recording paper P by ejecting the ink with respect to the recording paper P at a timing when the recording paper P is transported to the platen 74 by the paper feed mechanism 7.

As illustrated in FIG. 2, the ink jet printer 1 includes a light source 83.

The light source 83 is provided on +X side (downstream side of the recording paper P further than the head unit 30 in a transportation direction) in FIG. 2 further than the head unit 30, and the ink, which is ejected onto the recording paper P from the ejection unit 35, can be irradiated with ultraviolet rays.

Details will be described below, in the present embodiment, an ultraviolet curable ink whose viscosity is changed according to the temperature is used as an ink. Accordingly, the ink is cured and can be fixed to the recording paper P by irradiating the ink ejected onto the recording paper P from the ejection unit 35 with ultraviolet rays from the light source 83.

Further, as the light source 83, a temporary curing light source and an actual curing light source may be provided.

Here, the “temporary curing” means temporarily fixing (pinning) the ink, more specifically, curing before the actual curing for preventing bleeding between dots and controlling dot diameters. In general, the polymerization degree of a polymerizable compound in the temporary curing is lower than that of a polymerizable compound in the actual curing performed after the temporary curing.

In addition, the “actual curing” is curing the dots formed on the recording paper P to enter a cured state required when the recording paper P is used. Here, the “curing” in the present specification means the actual curing unless otherwise noted.

Further, since the ink may be actually cured by performing irradiation ultraviolet rays from the actual curing light source, the curing operation may be completed by performing irradiation ultraviolet rays from the actual curing light source without performing irradiation ultraviolet rays from the temporary light source. In this manner, in the curing operation, only the actual curing may be performed without performing the temporary curing.

The ink jet printer 1 of the present embodiment can secure excellent curability and ejection stability and is excellent for suppressing increase in temperature in a recording device after the continuous printing even in a case where the ultraviolet curable ink with low viscosity.

Further, the ink jet printer 1 includes a recovery mechanism 84 (see FIG. 3) for recovering the ejection state of the ejection unit 35 to a normal ejection state in a case where ejection abnormality occurs in the ejection unit 35.

As illustrated in FIG. 1, the recovery mechanism 84 includes a wiper 841 for wiping foreign materials such as paper dust adhered to a nozzle plate 240 (see FIG. 4) on which the nozzles N of the ejection unit 35 are formed, a cap 842 for sealing the nozzle plate 240 of the head unit 30, and an ink receiving unit 843 to which the ink is ejected in a flushing process of allowing the ink to be preliminarily ejected from the ejection unit 35.

FIG. 3 is a functional block view illustrating the configuration of the ink jet printer 1 according to the present embodiment.

As described above, the ink jet printer 1 includes the head unit 30 including the M ejection units 35, the head driver 50, the temperature sensor 81, the heater 82, the light source 83, and the recovery mechanism 84.

Among these, the temperature sensor 81 detects the temperature and outputs a temperature detection signal RT (an example of the “detection signal”) indicating a detection temperature TS which is the detected temperature. In addition, details of the temperature sensor 81 and the detected temperature TS detected by the temperature sensor 81 will be described below.

Moreover, as described above, the ink jet printer 1 includes the carriage motor 41, the carriage motor driver 43, the paper feed motor 71, and the paper feed motor driver 73.

Further, the ink jet printer 1 is configured of a liquid-crystal display, an organic EL display, an LED lamp, and the like, and includes an operation panel 85 including a display unit (not illustrated) that displays an error message and an operation unit (not illustrated) that includes various switches. The display unit of the operation panel 85 functions as a notification unit.

Moreover, as illustrated in FIG. 3, the ink jet printer 1 includes a control unit 6 for controlling the operation of respective units of the ink jet printer 1.

The control unit 6 performs a printing process of forming an image on the recording paper P according to image data 1 mg by controlling the moving mechanism 4, the paper feed mechanism 7, and the head driver 50 based on image data 1 mg input from a host computer 9 such as a personal computer or a digital camera.

Specifically, the control unit 6 controls the carriage motor 41 so as to intermittently sends the recording paper P in the sub scanning direction (an X-axis direction) one by one by controlling the carriage motor driver 43, controls paper feed motor 71 such that the moving body 3 reciprocates in the main scanning direction (a Y-axis direction) intersecting with the sending direction (the X-axis direction) of the recording paper P by controlling the paper feed motor driver 73, and controls ejection of the ink from the respective ejection units 35, the ejection amount of the ink in a case where the ink is ejected, and the ejection timing by controlling the head driver 50. Accordingly, the control unit 6 adjusts the dot sizes and the dot dispositions formed by the ink ejected on the recording paper P and performs the printing process of forming an image corresponding to image data 1 mg on the recording paper P.

Further, the control unit 6 may perform a process of transferring information related to an error message or ejection abnormality to a host computer 9 if necessary.

The control unit 6 includes a CPU 61 and a storage unit 62.

The storage unit 62 includes an EEPROM (Electrically Erasable Programmable Read-Only Memory) which is a kind of a non-volatile semiconductor memory that stores the image data 1 mg supplied through a non-illustrated interface unit from the host computer 9 in a data storage area, a RAM (Random Access Memory) that temporarily stores data required to perform various processes such as a printing process and the like and temporarily develops a control program for executing various processes such as a printing process and the like, and a PROM which is a kind of a non-volatile semiconductor memory that stores the control program for controlling the respective units of the ink jet printer 1.

The CPU 61 stores the image date 1 mg supplied from the host computer 9 in the storage unit 62.

Moreover, based on various data such as the image data 1 mg stored in the storage unit 62, the CPU 61 generates various signals such as a printing signal SI, a switching control signal Sw, and a driving waveform signal Com for controlling the operation of the head driver 50 to drive the ejection units 35, and outputs the generated signals.

Moreover, the CPU 61 generates various control signals such as control signals for controlling the heater 82 based on the temperature detection signal RT output by the temperature sensor 81, control signals for controlling the operation of carriage motor driver 43, control signals for controlling the operation of the paper feed motor driver 73, control signals for controlling the operation the light source 83, and control signals for controlling the operation of the recovery mechanism 84 based on the various pieces of data stored in the storage unit 62, and outputs generated various control signals.

The head driver 50 includes a driving signal generation unit 51, an ejection abnormality detection unit 52, and a switching unit 53.

The driving signal generation unit 51 generates a driving signal Vin for driving the M ejection units 35 included in the head unit 30 based on the printing signal SI and the driving waveform signal Com supplied from the control unit 6. Further, although details will be described below, the driving waveform signal Com in the present embodiment includes driving waveform signals Com-A, Com-B and Com-C.

The ejection abnormality detection unit 52 detects, as a residual vibration signal Vout, a change of an internal pressure of the ejection unit 35 caused by vibration of the ink within the ejection unit 35 which is generated after the ejection unit 35 is driven by the driving signal Vin. Moreover, the ejection abnormality detection unit 52 determines the ejection state of the ink in the ejection unit 35 such as whether or not the ejection abnormality occurs in the ejection unit 35 based on the residual vibration signal Vout, and outputs a determination result signal Rs representing the determination result. Moreover, the ejection abnormality detection unit 52 outputs a cycle length signal NTc representing a cycle Tc corresponding to a time length which is one wavelength of a waveform represented by the residual vibration signal Vout.

The switching unit 53 electrically connects the respective ejection units 35 to any one of the driving signal generation unit 51 and the ejection abnormality detection unit 52 based on the switching control signal Sw supplied from the control unit 6.

As described above, the control unit 6 (the CPU 61) controls the respective units of the ink jet printer 1 by generating various signals such as the control signals SI, the driving waveform signals Com, and the switching control signals Sw and by supplying the generated signals to the respective units of the ink jet printer 1.

Thus, the control unit 6 (the CPU 61) executes various processes such as the printing process, the ejection state determination process (and the preparation process for performing the ejection state determination process), the recovery process (and the preparation process for performing the calibration process), and the calibration process.

Here, as described above, the printing process is a process of ejecting the ink from the ejection unit 35 and forming an image (dots) on the recording paper P by the control unit 6 controlling the operation of the head driver 50 and supplying the driving signal Vin to the ejection unit 35 based on the image data 1 mg. In the printing process, the control unit 6 controls the operation of the heater 82 such that the temperature (hereinafter, referred to as a “ink temperature T”) of the ink in the inside of the ejection unit 35 becomes appropriate for ejecting the ink from the ejection unit 35, based on the temperature detection signal RT output by the temperature sensor 81. Further, in the printing process, the control unit 6 controls the operation of the light source 83 such that the ink ejected to the recording paper P from the ejection unit 35 is irradiated with ultraviolet rays.

The ejection state determination process is a process of allowing the residual vibration to be generated in the ejection unit 35 and of inspecting the ejection state of the ink in the ejection unit 35 based on the generated residual vibration by the control unit 6 controlling the operation of the head driver 50 and supplying the driving signal Vin to the ejection unit 35.

In the present embodiment, as the ejection state determination process, so-called “non-ejection inspection” that determines the ejection state of the ink in the ejection unit 35 based on the residual vibration generated in the ejection unit 35 when the ejection unit 35 is driven so as not to eject the ink is assumed.

However, the invention is not limited thereto, and the ejection state determination process may be a process on the premise of so-called “ejection inspection” that determines the ejection state of the ink in the ejection unit 35 based on the residual vibration generated in the ejection unit 35 when the ejection unit 35 is driven so as to eject the ink. In a case where the ejection state determination process is a process on the premise of the ejection inspection, the head unit 30 (carriage 32) is moved to a position in which the ink does not impact on the recording paper P even when the ink is ejected from the ejection unit 35, for example, a position facing the ink receiving unit 843, and then the ejection state determination process may be performed.

In addition, the preparation process for performing the ejection state determination process will be described below.

The recovery process is referred to as a process for recovering the ejection state of the ink of the ejection unit 35 to a normal state such as a wiping process of wiping a foreign substance such as paper dust attached to a nozzle plate 240 of the ejection unit 35 by a wiper (not illustrated) when abnormality (ejection abnormality) of the ejection state of the ink is detected in the ejection unit in the ejection state determining process using the recovery mechanism 84, a pumping process of sucking the ink or bubbles thickened within the ejection unit 35 by a tube pump (not illustrated), or a flushing process of preliminarily ejecting the ink from the ejection unit 35. The control unit 6 selects one or more recovery processes appropriate to recover the normal ejection state of the ejection unit 35 from among the flushing process, the wiping process, and the pumping process, based on the result of ejection state determining process, and executes the selected recovery process. Further, ejection abnormality in the ejection unit 35 will be described below.

The calibration process is a process of adjusting a waveform of the driving signal Vin supplied by the head driver 50 to the ejection unit 35 as an object of the ejection state determination process. Further, the preparation process for performing the calibration process will be described below.

Moreover, hereinafter, the driving signal Vin supplied to the ejection unit 35 in the printing process is referred to as the “printing signal Vin for printing.” In addition, the driving signal Vin supplied to the ejection unit 35 in the ejection state determination process and the driving signal Vin as an object of adjusting the waveform in the calibration process is referred to as the “driving signal Vin for inspection.”

Further, in the present embodiment, the printing process, the ejection state determination process, and the calibration process are performed only in a case where an ink temperature T which is the temperature of the ink in the inside of the ejection unit 35 is within the temperature range (hereinafter, referred to as a “printing temperature range TP”) of a temperature Tmin to a temperature Tmax (here, the temperatures Tmin and Tmax satisfy a relationship of Tmin <Tmax). The temperature Tmin and the temperature Tmax are appropriately determined by the characteristics of the ink to be used in the ink jet printer 1. In the present embodiment using the ultraviolet curable ink, details will be described below, but the temperature Tmin is set to 30° C. and the temperature Tmax is set to 40° C. respectively. In addition, the printing temperature range TP is an example of the “predetermined temperature range.”

Further, the control unit 6 (CPU 61) functions as a decision unit or a temperature determination unit in some cases. The decision unit or the temperature determination unit will be described below.

### 2. Configuration of Head Unit

Next, the head unit 30 and the ejection unit 35 provided in the head unit 30 will be described with reference to FIG. 4.

FIG. 4 schematically illustrates an example of a cross-sectional view of the head unit 30 and the ink cartridge 31. Further, for convenience of illustration, in the head unit 30, one ejection unit 35 among the M ejection units 35 and the reservoir 246 communicating with the ejection unit 35 through the ink supply opening 247 are illustrated in the figure.

AS illustrated in FIG. 4, the ejection nit 35 includes a laminated piezoelectric element 201 formed by a plurality of piezoelectric elements 200 being laminated, a cavity 245 whose inside is filled with the ink (an example of a “pressure chamber”), nozzles N communicating with the cavity 245, and a vibration plate 243. In the ejection unit 35, the ink in the cavity 245 is ejected from the nozzles N due to the piezoelectric element 200 being driven by the driving signal Vin.

As illustrated in FIG. 4, the cavity 245 of the ejection unit 35 is a space divided by a cavity plate 242 formed to have a predetermined shape in which a concave portion is formed, a nozzle plate 240 on which the nozzles N are formed, and a vibration plate 243. The cavity 245 communicates with the reservoir 246 which is a space divided by the cavity plate 242 and the nozzle plate 240 through the ink supplying opening 247. The reservoir 246 communicates with the ink cartridge 31 through the ink supply tube 311.

In FIG. 4, a lower end of the laminated piezoelectric element 201 is bonded to the vibration plate 243 through an intermediate layer 244. A plurality of outer electrodes 248 and a plurality of inner electrodes 249 are bonded to the laminated piezoelectric element 201. That is, the outer electrodes 248 are bonded to an outer surface of the laminated piezoelectric element 201, and the inner electrodes 249 are provided between the piezoelectric elements 200 (or the inside of the respective piezoelectric elements) constituting the laminated piezoelectric element 201. In this case, some of the outer electrodes 248 and the inner electrodes 249 are alternately arranged so as to be overlapped in a thickness direction of the piezoelectric element 200.

In addition, the laminated piezoelectric element 201 is deformed as indicated by an arrow of FIG. 4 (expands and contracts in a vertical direction in FIG. 4) to vibrate by supplying the driving signal Vin between the outer electrodes 248 and the inner electrodes 249 from the driving signal generation unit 51, and the vibration plate 243 vibrates by the vibration. The volume of the cavity 245 (the pressure within the cavity 245) is changed by the vibration of the vibration plate 243, and the ink filled in the cavity 245 is ejected from the nozzles N.

When the ink in the cavity 245 is reduced by the ejection of the ink, the ink is supplied from the reservoir 246. Moreover, the ink is supplied from the ink cartridge 31 through an ink supply tube 311 to the reservoir 246.

As illustrated in FIG. 4, the temperature sensor 81 is provided on the upside of the intermediate layer 244 included in the head unit 30. In the ink jet printer 1 according to the present embodiment, the M ejection units 35 include one temperature sensor 81 in common, but the invention is not limited thereto. In addition, in the present embodiment, the ink jet printer 1 is provided with one temperature sensor 81 common with the M ejection units 35, but the invention is not limited to such configuration. For example, four temperature sensors 81 may be provided so as to be in one-to-one correspondence with four colors of inks. That is, one temperature sensor 81 may be included for each nozzle array described below. Further, for example, M temperature sensors 81 may be included so as to be in one-to-one correspondence with the M ejection units 35.

Further, the installation position of the temperature sensor 81 illustrated in FIG. 4 is merely an example, and the temperature sensor 81 may be provided in a position in which the ink temperature T as the temperature of the ink in the inside of the cavity 245 can be directly or indirectly detected. For example, the temperature sensor 81 may be provided on a substrate provided with the driving signal generation unit 51 of the head driver 50. In addition, for example, the temperature sensor 81 may be provided in a position, such as a wall surface of the reservoir 246 or a wall surface of the cavity 245, in which the temperature of the ink in the ejection unit 35 or the temperature of the ink immediately before being supplied to the ejection unit 35 can be directly detected. That is, the temperature sensor 81 may be provided in a position in which the detection temperature TS which is a value indicated by the temperature detection signal RT output by the temperature sensor 81 has the degree according to the ink temperature T.

As illustrated in FIG. 4, the ink jet printer 1 according to the present embodiment is provided with the heater 82 so as to cover the outside of the ink supply tube 311.

Further, the installation position of the heater 82 illustrated in FIG. 4 is merely an example, and the heater 82 may be provided in a position in which the ink supplied to the ejection unit 35 or the ink in the inside of the cavity 245 of the ejection unit 35 can be directly or indirectly heat. However, the heater 82 is necessary to be provided in a position such that detection of the temperature according to the ink temperature T by the temperature sensor 81 is not interrupted, that is, the temperature sensor 81 does not detect the temperature of the heater 82 in a direct manner.

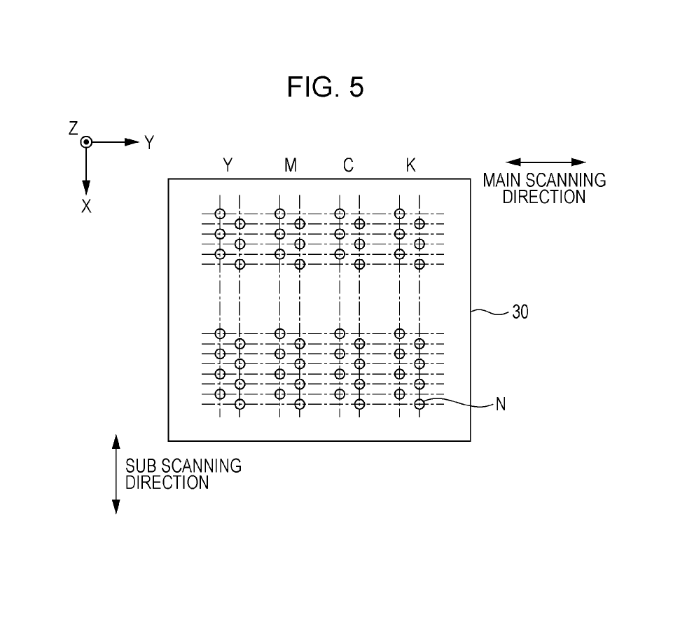

FIG. 5 is a view illustrating a position relationship between the head unit 30 and the M nozzles N included in the head unit 30 when the head unit 30 is seen in a plan view (that is, when seen in a +Z direction or −Z direction).

As illustrated in FIG. 5, the M nozzles N are arranged by dividing into four nozzle arrays of a nozzle array corresponding to yellow (Y), a nozzle array corresponding to cyan (C), a nozzle array corresponding to magenta (M), and a nozzle array corresponding to black (K). Further, in the present embodiment, a plurality of the nozzles N constituting each nozzle array are not arranged to be aligned in one array in the X-axis direction, and arranged by shifting stages in the Y-axis direction in the figure. Further, pitches among the nozzles N may be appropriately set according to printing resolution (dpi: dot per inch).

### 3. Regarding Residual Vibration

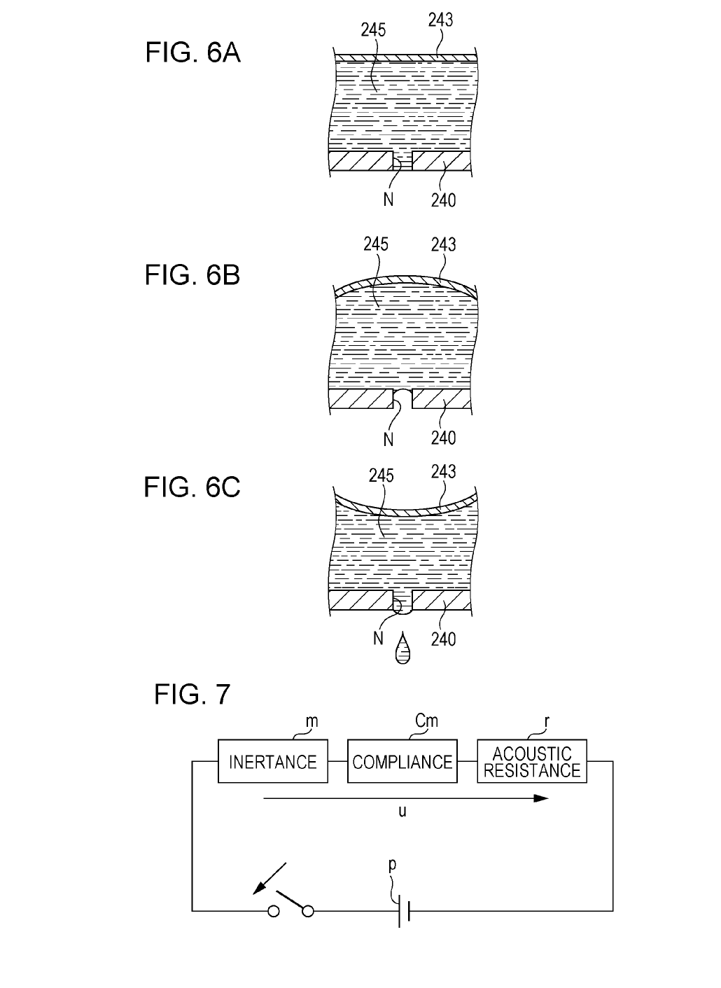

Next, the ejection of the ink in the ejection unit 35 will be described with reference to FIGS. 6A to 6C.

When the driving signal Vin is supplied to the piezoelectric element 200 illustrated in FIG. 4 from the driving signal generation unit 51, a strain which is proportional to an electric field applied to between electrodes is generated, the vibration plate 243 is curved toward the upper direction in FIG. 4 with respect to the initial state illustrated in FIG. 6A, and the volume of the cavity 245 expands as illustrated in FIG. 6B. In this state, when the voltage indicated by the driving signal Vin is changed due to the control of the driving signal generation unit 51, the vibration plate 243 is restored by an elastic restoring force and moves toward the lower direction over the position of the vibration plate 243 in the initial state, and the volume of the cavity 245 illustrated in FIG. 6C is rapidly contracted. At this time, some of the ink filling in the cavity 245 is ejected as ink droplets from the nozzles N communicating with the cavity 245 by the compressed pressure generated in the cavity 245.

The vibration plate 243 of the cavity 245 damping-vibrates, that is, residual vibrates until the subsequent ink ejecting operation starts after a series of ink ejecting operations are finished. It is assumed that the residual vibration of the vibration plate 243 has a natural vibration frequency determined by shapes of the nozzles N and the ink supplying opening 247, or an acoustic resistance r due to ink viscosity, an inertance m due to the weight of the ink within a channel, and a compliance Cm of the vibration plate 243.

A calculation model of the residual vibration of the vibration plate 243 based on the assumption will be described.

FIG. 7 is a circuit view illustrating the calculation model of simple harmonic vibration which assumes the residual vibration of the vibration plate 243. As described above, the calculation model of the residual vibration of the vibration plate 243 is expressed by an acoustic pressure the aforementioned inertance m, compliance Cm, and the acoustic resistance r. Furthermore, if a step response is calculated for a volume velocity u when the acoustic pressure p is applied in the circuit of FIG. 7, the following expressions are obtained.

u={p/(ω·m)}e^{-αt}·sin(ωt)

ω={1/(m·Cm)−α²}^{1/2}

σ=r/(2m)

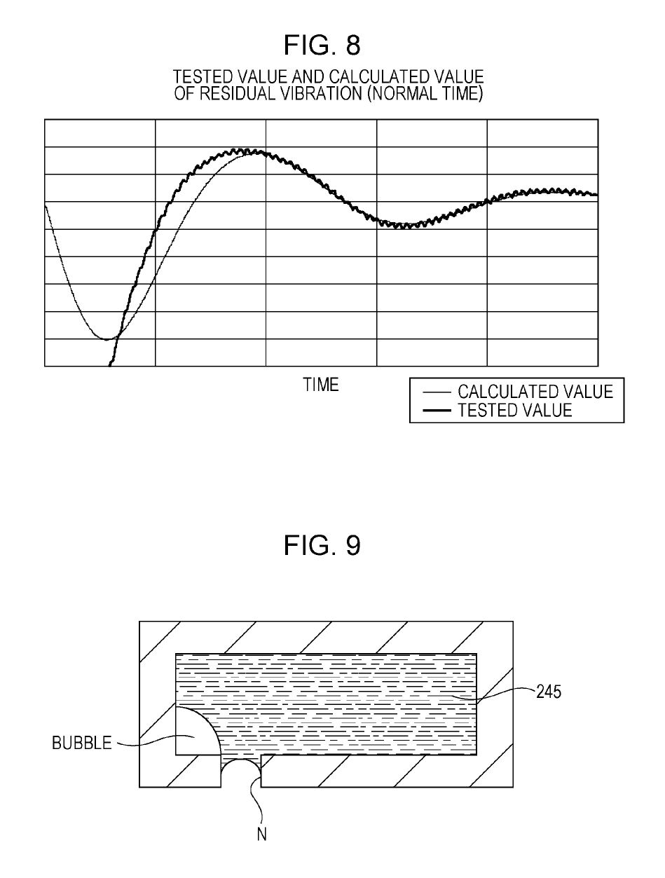

The calculation result obtained from the expression is compared with a test result in a test of the residual vibration of the vibration plate 243 after the ink droplets are separately ejected. FIG. 8 is a graph representing a relation between test values and calculated values of the residual vibration of the vibration plate 243. As can be seen from the graph of FIG. 8, two waveforms of the test values and the calculated values roughly coincide with each other.

In the ejection unit 35, a phenomenon where the ink droplets are not normally ejected from the nozzles N even though the ejecting operation described above is performed, that is, the ejection abnormality of the ink in the ejection unit 35 may occur. As a cause by which the ejection abnormality is generated, there are (1) mixing of bubbles into the cavity 245, (2) drying and thickening (adhering) of the ink in the vicinity of the nozzles N, and (3) attaching of paper dust in the vicinity of outlets of the nozzles N.

When the ejection abnormality occurs, as a result, the liquid droplets are not typically ejected from the nozzles N, that is, the non-ejection phenomenon of the liquid droplets is exhibited. In this case, dot omission of a pixel in an image printed on the recording paper P occurs. Moreover, when the ejection abnormality occurs, even though the liquid droplets are ejected from the nozzles N, the amount of the liquid droplets is too small, or a scattering direction (a trajectory) of the liquid droplets is shifted. Thus, since impact is not appropriately performed, the dot omission of the pixel appears. In this way, in the following description, the ejection abnormality of the liquid droplets is also referred to as “dot omission.”

In the following description, based on the comparison result illustrated in FIG. 8, at least one value of the acoustic resistance r and the inertance m is adjusted so as to allow the calculated values of the residual vibration of the vibration plate 243 and the test values to match (roughly coincide) for each cause of ejection abnormality of the ink in the ejection unit 35 (the dot omission phenomenon occurring in the ejection unit 35 when the printing process is performed).

Firstly, (1) the mixing of bubbles into the cavity 245 which is one cause of the dot omission is inspected. FIG. 9 is a conceptual view in the vicinity of the nozzles N when the bubbles are mixed into the cavity 245. As illustrated in FIG. 9, it is assumed that the generated bubbles are generated and attached to a wall surface of the cavity 245.

As mentioned above, when the bubbles are mixed into the cavity 245, it is considered that the total weight of the ink filled in the cavity 245 is reduced and the inertance m is decreased. Moreover, as exemplified in FIG. 9, when the bubbles are attached in the vicinity of the nozzles N, it is considered that diameters of the nozzles N become larger by the size of diameters of the bubbles and the acoustic resistance r is decreased.

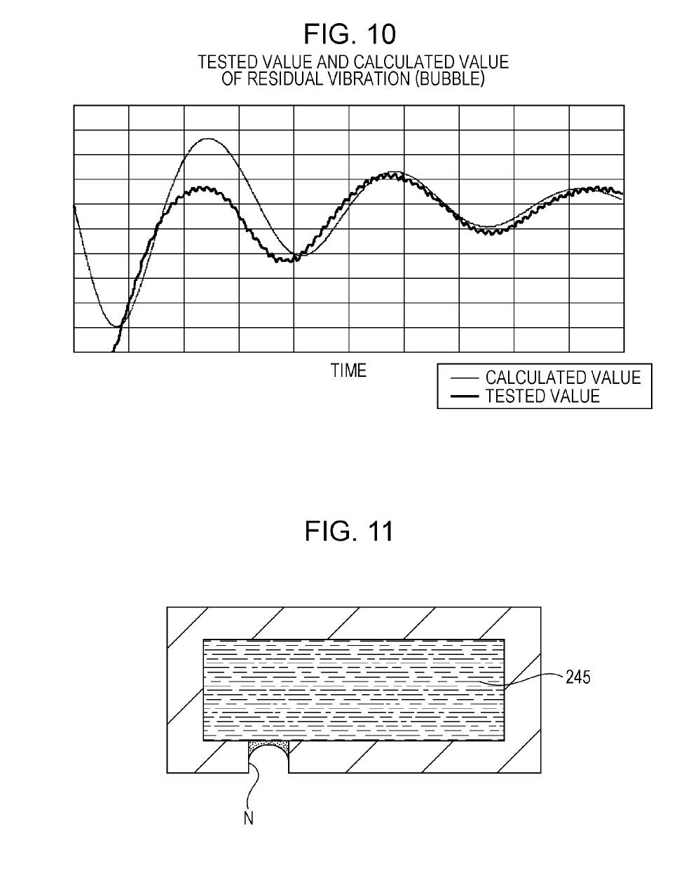

Accordingly, in the case of FIG. 8 where the ink is normally ejected, the acoustic resistance r and the inertance m are set to be small to match the test values of the residual vibration when the bubbles are mixed in, so that a result (a graph) represented in FIG. 10 is obtained. As can be seen from the graphs of FIGS. 8 and 10, when the bubbles are mixed into the cavity 245, a distinctive residual vibration waveform having a frequency higher than that in the case of normal ejection is obtained. Further, it can be seen that since the acoustic resistance r is decreased, a damping rate of an amplitude of the residual vibration is also decreased, so that the amplitude of the residual vibration is slowly decreased.

Next, (2) the drying (fixation, thickening) of the ink in the vicinity of the nozzles N which is another cause of the dot omission is inspected. FIG. 11 is a conceptual view in the vicinity of the nozzles N when the ink in the vicinity of the nozzles N of FIG. 4 adheres by drying. As illustrated in FIG. 11, when the ink in the vicinity of the nozzles N is dried and adheres, the ink within the cavity 245 is enclosed within the cavity 245. As described above, when the ink in the vicinity of the nozzles N is dried and thickened, it is considered that the acoustic resistance r is increased.

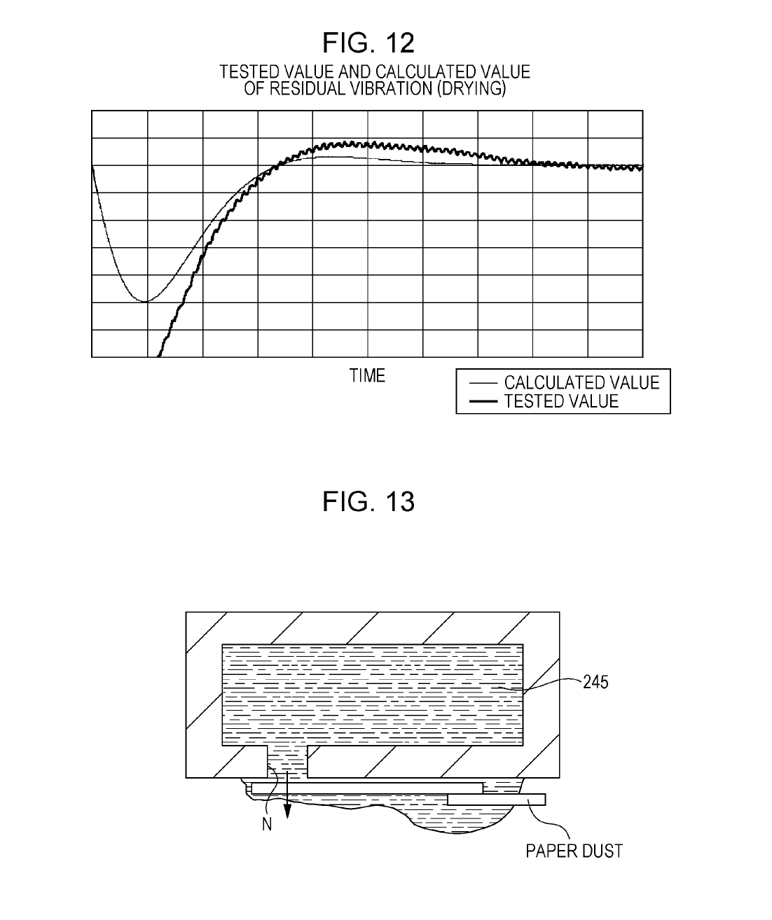

Accordingly, in the case of FIG. 8 where the ink is normally ejected, the acoustic resistance r is set to be large to coincide with the test values of the residual vibration when the ink in the vicinity of the nozzles N is dried and adheres (thickened), so that a result (a graph) represented in FIG. 12 is obtained. Further, the test values represented in FIG. 12 are obtained by measuring the residual vibration of the vibration plate 243 while the ejection units 35 are placed without attaching caps (not illustrated) for several days and the ink is not ejected (the ink adheres) by drying and thickening of the ink in the vicinity of the nozzles N. As can be seen from the graphs of FIGS. 8 and 12, when the ink adheres by drying of the ink in the vicinity of the nozzles N, the frequency is extremely decreased as compared to the normal ejection, and the distinctive residual vibration waveform in which the residual vibration is over-damped is obtained. This is because after the ink is allowed to flow into the cavity 245 from the reservoir 246 by pulling the vibration plate 243 upwards in FIG. 4 in order to eject the ink droplets, since there is no retreat route of the ink within the cavity 245 at the time of moving the vibration plate 243 downwards in FIG. 4, it is difficult for the vibration plate 243 to rapidly vibrate (over-damping).

Next, (3) the attaching of paper dust in the vicinity of outlets of the nozzles N which is the other cause of the dot omission is inspected. FIG. 13 is a conceptual view in the vicinity of the nozzles N when the paper dust is attached in the vicinity of the nozzles N of FIG. 4. As illustrated in FIG. 13, when the paper dust is attached in the vicinity of the nozzles N, the ink is exuded from the inside of the cavity 245 through the paper dust, and it is difficult to eject the ink from the nozzles N. As described above, when the paper dust is attached in the vicinity of the nozzles N and the ink is exuded from the nozzles N, since the ink within the cavity 245 and the exuded ink are more increased than that of the normal state when seen from the vibration plate 243, it is considered that the inertance m is increased. Moreover, it is considered that the acoustic resistance r is increased by fibers of the paper dust attached to the outlets of the nozzles N.

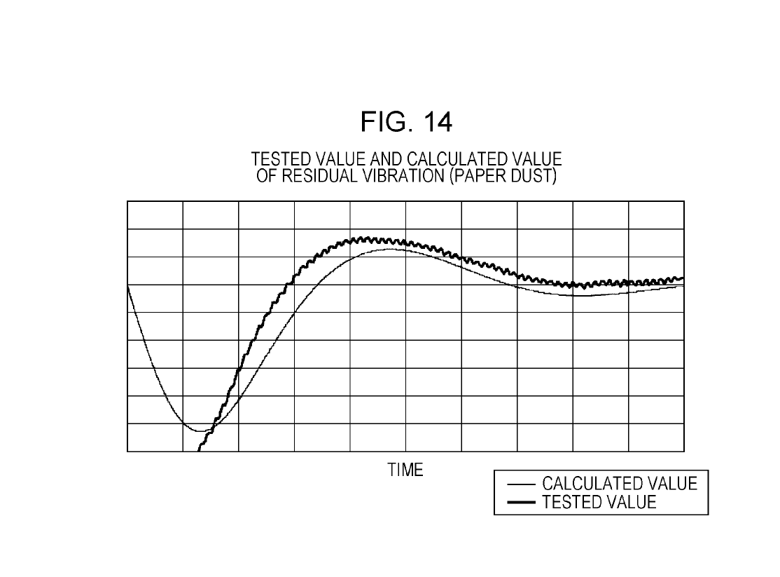

Accordingly, in the case of FIG. 8 where the ink is normally ejected, the inertance m and the acoustic resistance r are set to be large to match the test values of the residual vibration when the paper dust is attached in the vicinity of the nozzles N, so that a result (a graph) of FIG. 14 is obtained. As can be seen from the graphs of FIGS. 8 and 14, when the paper dust is attached in the vicinity of the nozzles N, the distinctive residual vibration waveform having a frequency lower than that in the normal ejection is obtained.

Further, as can be seen from the graphs of FIGS. 12 and 14, when the paper dust is attached, the frequency of the residual vibration is higher than that when the ink is dried.

Here, the frequency of the residual vibrations when the ink in the vicinity of the nozzles N is dried and thickened and also when the paper dust is attached in the vicinity of the outlets of the nozzles N is lower than that when the ink is normally ejected. The causes of the two dot omission can be distinguished by comparing the waveform of the residual vibration of the vibration plate 243, specifically, the frequency or the cycle of the residual vibration with the predetermined threshold value.

As is obvious from the above description, it is possible to determine the ejection state of the ink in the respective ejection units 35 based on the waveform of the residual vibration of the vibration plate 243 when the ink droplets are ejected from the nozzles N in the respective ejection units 35 and, particularly, the frequency or the cycle of the residual vibration. More specifically, based on the frequency or the cycle of the residual vibration, it is possible to determine whether the ejection state in the respective ejection units 35 is normal and to determine that which number (1) to (3) the cause of the ejection abnormality corresponds to when the ejection state in the respective ejection units 35 is abnormal.

The ink jet printer 1 according to the present embodiment operates the ejection state determining process of determining the ejection state by analyzing the residual vibration.

### 4. Configurations and Operations of Head Driver

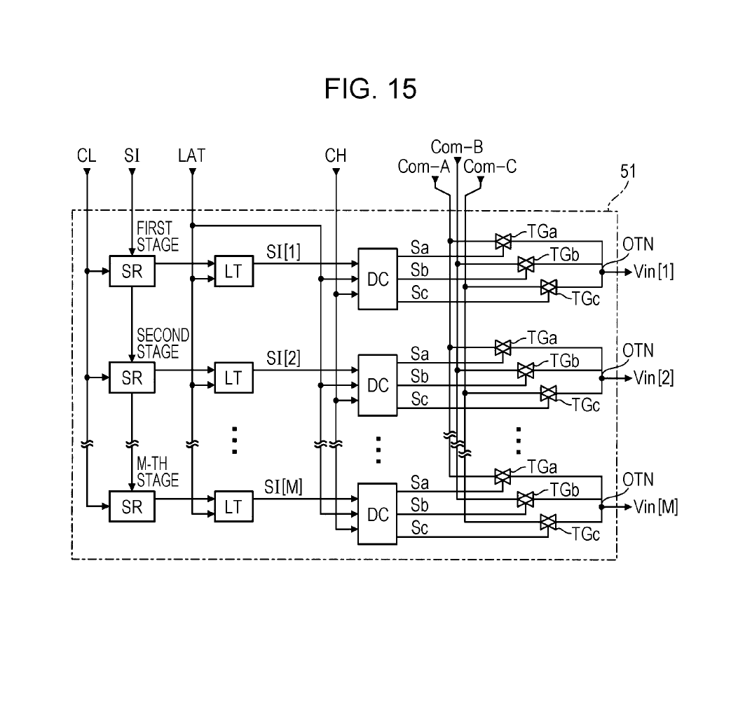

Next, the configurations and the operations of the head driver 50 (the driving signal generation unit 51, the switching unit 53, and the ejection abnormality detection unit 52) will be described with reference to FIGS. 15 to 22.

FIG. 15 is a block diagram illustrating the configuration of the driving signal generation unit 51 of the head driver 50.

As illustrated in FIG. 15, the driving signal generation unit 51 has M number of sets each including shift registers SR, latch circuits LT, decoders DC, and transmission gates TGa, TGb and TGc so as to be in one-to-one correspondence with the M ejection units 35. In the following description, the respective elements constituting the M sets are referred to as a first stage, a second stage, . . . , and an M-th stage in sequence from the top in the drawing.

Further, although details will be described below, the ejection abnormality detection unit 52 includes M ejection abnormality detection circuits DT (DT[1], DT[2], . . . , and DT[M]) so as to be in one-to-one correspondence with the M number of ejection units 35.

Clock signals CL, printing signals SI, latch signals LAT, change signals CH, and driving waveform signals Com (Com-A, Com-B and Com-C) are supplied to the driving signal generation unit 51, from the control unit 6.

Here, the printing signal SI is a digital signal that defines the amount of ink ejected from the ejection unit 35 (the nozzles N) in forming one dot of an image. More specifically, the printing signals SI according to the present embodiment are signals that define the amount of inks ejected from the ejection units 35 by 3 bits of a high-order bit b1, a middle-order bit b2 and a low-order bit b3, and are serially supplied to the driving signal generation unit 51 in synchronization with the clock signals CL from the control unit 6. By controlling the amount of inks ejected from the ejection units 35 by the printing signals SI, it is possible to express four gradations of non-recording, a small dot, a medium dot and a large dot in the respective dots of the recording paper P, and it is possible to generate the residual vibration to generate the driving signal Vin for inspection for inspecting the ejection state of the ink.

The shift registers SR temporarily hold the printing signals SI of 3 bits corresponding to the ejection units 35. Specifically, the 4M shift registers SR having the first stage, the second stage, . . . , and the M-th stage in one-to-one correspondence with the M ejection units 35 are cascade-connected to each other, and the printing signals SI serially supplied are sequentially transferred to the subsequent stage in response to the clock signals CL. Furthermore, the supply of the clock signals CL is stopped at a point of time when the printing signals SI are transferred to all of the M shift registers SR, and each of the M number of shift registers SR maintains a state where each shift register holds data of 3 bits corresponding to each shift register among the printing signals SI.

The M latch circuits LT simultaneously latch the printing signals SI of 3 bits corresponding to the respective stages held by the respective M shift registers SR at a timing when the latch signals LAT rise. In FIG. 15, SI[1], SI[2], . . . , SI[M] are the printing signals SI of 3 bits latched by the latch circuits LT corresponding to the shift registers SR of first, second, . . . and 4M stages.

On the other hand, the operation period which is a period for which the ink jet printer 1 operates at least one process among the printing process, the ejection state determining process, and the calibration process is formed of a plurality of unit operation periods Tu. The respective unit operation periods U are formed of the control period Us2 which follows the control period Us1. In the present embodiment the control periods Us1 and Us2 have an equivalent time length to each other.

In addition, in the present embodiment, a plurality of unit operation periods U constituting the operation period are classified into three unit operation periods U, which are a unit operation period U for which the printing process is performed, and a unit operation period U for which the ejection state determining process is performed, a unit operation period U for which the calibration is performed.

However, the unit operation period U constituting the operation period may include the unit operation period U for which both of the printing process and the ejection state determination process are performed in addition to these three kinds.

The control unit 6 supplies the printing signals SI during each unit operation period U to the driving signal generation unit 51, and controls the driving signal generation unit 51 to allow the latch circuits LT to latch the printing signals SI[1], SI[2], . . . , SI[M] during each unit operation period U. That is, the control unit 6 controls the driving signal generation unit 51 to supply the driving signals Vin to the M number of ejection unit 35 during each unit operation period U.

More specifically, in a case where the control unit 6 controls the driving signal generation unit 51 such that the driving signal Vin for printing is supplied to the M number of ejection units 35 in a case where the printing process is performed in the unit operation period U. Accordingly, the M ejection units 35 eject the ink with an amount according to image data 1 mg and an image corresponding to the image data 1 mg is formed on recording paper P.

The control unit 6 controls the driving signal generation unit 51 such that the driving signal Vin is supplied to the M number of the ejection units 35 in a case where only the ejection state determining process is performed in the unit operation period U.

The decoder DC decodes the printing signal SI of 3 bits latched by the latch circuit LT, and outputs selection signals Sa, Sb and Sc during each of the control periods Us1 and Us2.

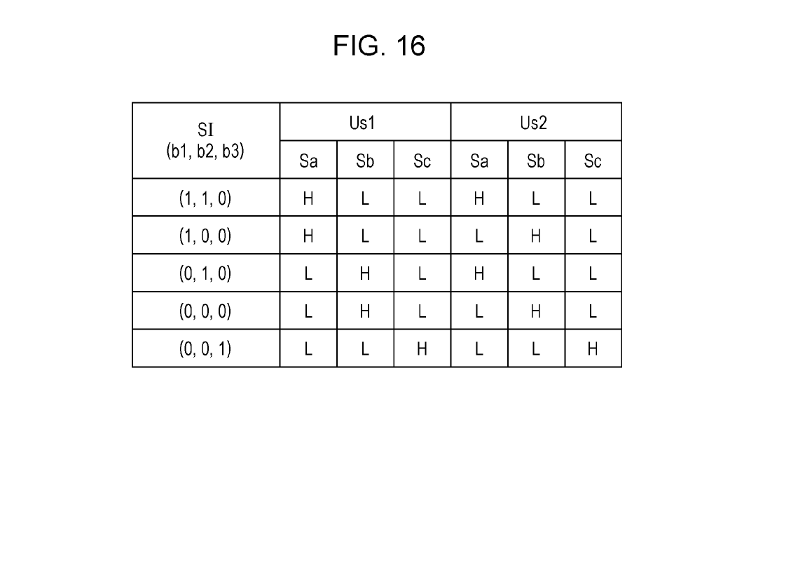

FIG. 16 is an explanatory diagram (a table) illustrating contents of decoding performed by the decoder DC. As illustrated in the figure, when the printing signals SI [m] corresponding to the m stages (m is a natural number which satisfies 1≦m≦M) indicate, for example, (b1, b2, b3)=(1, 0, 0), the decoders DC of M stages set the selection signal Sa to a high level H and set the selection signals Sb and Sc to a low level L during the control period Us1. In addition, the decoders set the selection signals Sb to a high level H and set the selection signal Sa and Sc to a low level L during the control period Us2. Moreover, when the low-order bit b3 is “1,” that is, (b1, b2, b3)=(0, 0, 1), the decoders DC of m stages set the selection signals Sc to a high level H and set the selection signal Sa and Sb to a low level L during the control periods Us1 and Us2.

The description returns to FIG. 15.

As illustrated in FIG. 15, the driving signal generation unit 51 includes M number of sets including transmission gates TGa, TGb and TGc. The M number of sets including transmission gates TGa TGb and TGc are provided in one-to-one correspondence with the M number of ejection units 35.

The transmission gate TGa is turned on when the selection signal Sa is in a high level H, and is turned off when the selection signal Sa is in a low level L. The transmission gate TGb is turned on when the selection signal Sb is in a high level H, and is turned off when the selection signal Sb is in a low level L. The transmission gate TGc is turned on when the selection signal Sc is in a high level H, and is turned off when the selection signal Sc is in a low level L.

For example, in the m-th stage, when the contents indicated by the printing signal Si[m] is (b1, b2, b3)=(1, 0, 0), the transmission gate TGa is turned on and the transmission gates TGb and TGc are turned off during the control period Us1, and the transmission gate TGb is turned on and the transmission gates TGb and TGc are turned off during the control period Us2.

The driving waveform signal Com-A is supplied to one terminal of the transmission gate TGa, the driving waveform signal Com-B is supplied to one terminal of the transmission gate TGb, and the driving waveform signal Com-C is supplied to one terminal of the transmission gate TGc. Moreover, the other terminals of the transmission gates TGa, TGb and TGc are commonly connected to an output terminal OTN to the switching unit 53.

The transmission gates TGa, TGb and TGc are exclusively turned on, and the driving waveform signal Com-A, Com-B or Com-C selected for the control periods Us1 and Us2 are output to the m-th stage output terminal OTN, as the driving signals Vin[m], and supplied to the ejection unit 35 of the m-th stage through the switching unit 53.

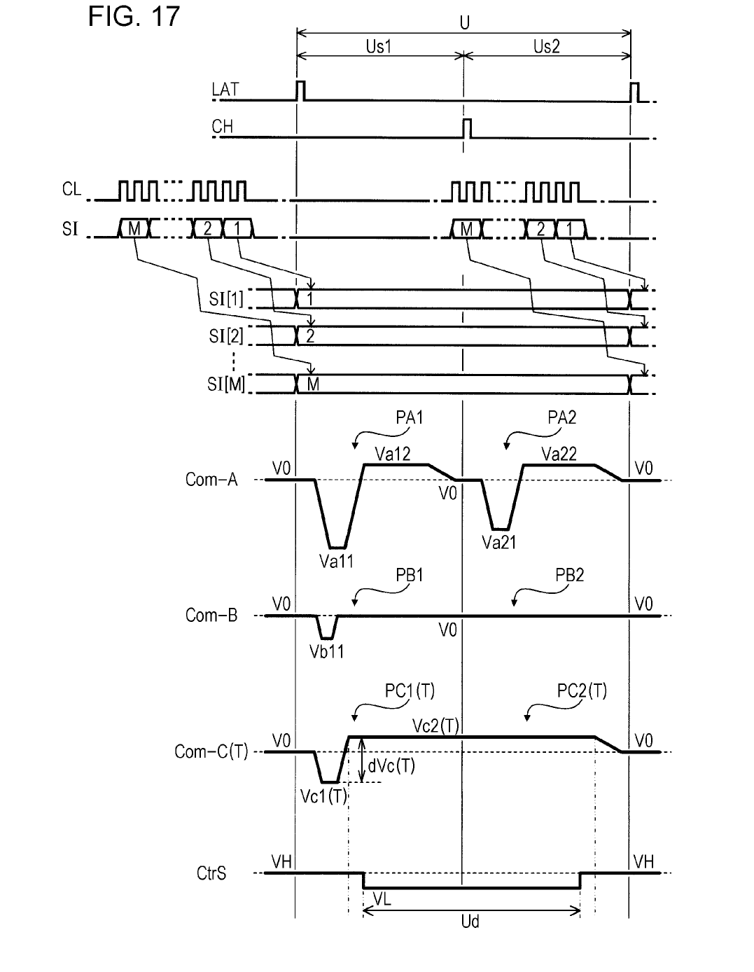

FIG. 17 is a timing chart for describing the operation of the driving signal generation unit 51 during the unit operation period U. As illustrated in FIG. 17, the unit operation period U is defined by the latch signal LAT output from the control unit 6. Moreover, the control periods Us1 and Us2 included in the unit operation period U are defined by the latch signal LAT and the change signal CH output from the control unit 6.

The driving waveform signal Com-A supplied from the control unit 6 during the unit operation period U is a signal for generating the driving signal Vin for printing, and has a waveform that continuously connects a unit waveform PA1 disposed in the control period Us1 of the unit operation period U and a unit waveform PA2 disposed in the control period Us2 as illustrated in FIG. 17. Potentials at a timing when the unit waveform PA1 and the unit waveform PA2 start and end are both reference potentials V0. Moreover, a potential difference between a potential Va11 and a potential Va12 of the unit waveform PA1 is larger than a potential difference between a potential Va21 and a potential Va22 of the unit waveform PA2. For this reason, the amount of the ink ejected from the nozzles N included in the ejection unit 35 when the piezoelectric elements 200 included in the ejection unit 35 are driven by the unit waveform PA1 is larger than the amount of the ink ejected when the piezoelectric elements are driven by the unit waveform PA2.

The driving waveform signal Com-B supplied from the control unit 6 during the unit operation period U is a signal for generating the driving signal Vin for printing, and has a waveform that continuously connects a unit waveform PB1 disposed in the control period Us1 and a unit waveform PB2 disposed in the control period Us2. Potentials at a timing when the unit waveform PB1 starts and ends are both reference potentials V0, and the unit waveform PB2 is maintained at the reference potential V0 over the control period Us2. Moreover, a potential difference between a potential Vb11 of the unit waveform PB1 and a reference potential V0 is smaller than a potential difference between a potential Va21 and a potential Va22 of the unit waveform PA2. In addition, even when the piezoelectric elements 200 included in the ejection unit 35 are driven by the unit waveform PB1, the ink is not ejected from the nozzles N included in the ejection unit 35. Similarly, even when the unit waveform PB2 is supplied to the piezoelectric elements 200, the ink is not ejected from the nozzles N.

The driving waveform signal Com-C supplied from the control unit 6 during the unit operation period U is a signal for generating the driving signal Vin for inspection, and has a waveform that continuously connects a unit waveform PC1 disposed in the control period Us1 and a unit waveform PC2 disposed in the control period Us2.

The waveform (unit waveforms PC1 and PC2) of the driving waveform signal Com-C is decided according to the ink temperature T. Accordingly, hereinafter, in a case of expressing the driving waveform signal Com-C, the unit waveform PC1, the unit waveform PC2, and the driving waveform signal Com-C, the symbol “(T)” is assigned to be expressed as a function for indicating that these are changed according to the ink temperature T.

In the driving waveform signal Com-C(T), the unit waveform PC1(T) is changed to the potential Vc2 after the unit waveform PC1(T) is changed to the potential Vc1 from the reference potential V0, and maintained by the potential Vc2(T) until the control period Us1 ends. Further, in the driving waveform signal Com-C(T), the unit waveform PC2(T) maintains the potential Vc2(T) and then changed to the reference potential V0 from the potential Vc2(T) before the control period Us2 ends.

In addition, as described above, the ejection state determination process is a process assuming non-ejection inspection. Accordingly, in the potentials Vc1(T) and Vc2(T), a driving voltage dVc(T) which is a potential difference of the potentials Vc1(T) and Vc2(T) is smaller than the potential difference of the potentials Va21 and Va22 in the unit waveform PA2 and is decided to a potential so as for the ink is not ejected from the ejection unit 35 in a case where the ejection unit 35 is driven by the driving signal Vin for inspection including the unit waveforms PC1 and PC2.

Further, a relationship of the ink temperature T and the waveform of the driving waveform signal Com-C(T) (unit waveforms PC1(T) and PC2(T)) will be described below.

As illustrated in FIG. 17, the M latch circuits LT output the printing signals SI[1], SI[2], . . . , and SI[M] at a timing when the latch signals LAT rise, that is, at a timing when the unit operation period U starts.

Further, the m-th stage decoder DC outputs selection signals Sa, Sb, and Sc based on the contents of the table illustrated in FIG. 16 in respective control periods Us1 and Us2 according to the printing signal SI[m] as described above.

Moreover, in each of the control periods Us1 and Us2, the transmission gates TGa, TGb and TGc of the m-th stage select any one of the driving waveform signals Com-A, Com-B and Com-C based on the selection signals Sa, Sb, and Sc, and output the selected driving waveform signal Com as the driving signal Vin[m].

Further, a switching period designation signal CtrS illustrated in FIG. 17 is a signal that defines a switching period Ud. The switching period designation signal CtrS and the switching period Ud will be described below.

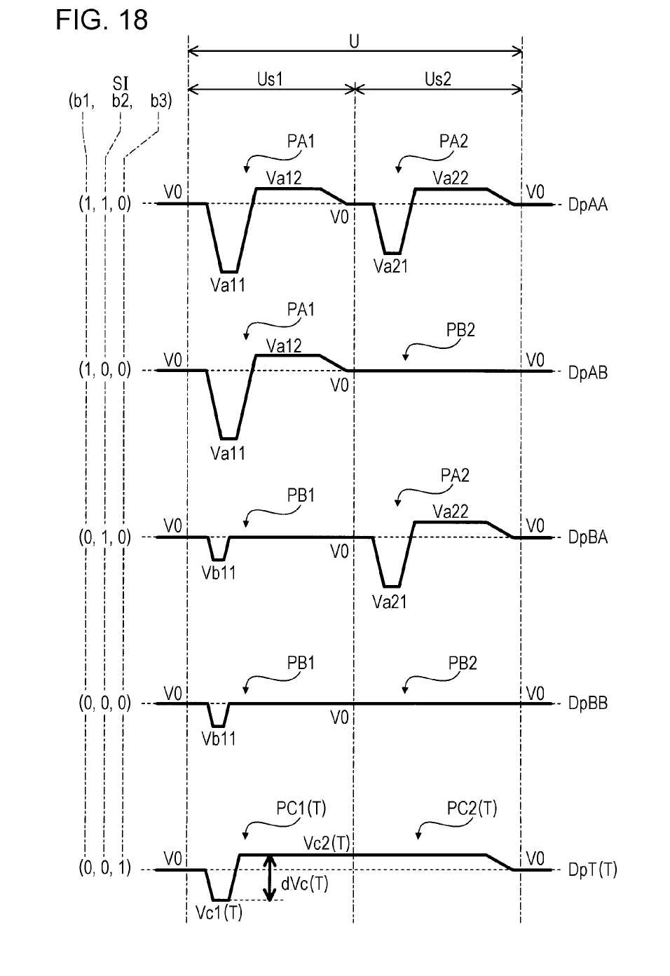

A waveform of the driving signal Vin output from the driving signal generation unit 51 during the unit operation period U will be described with reference to FIG. 18 in addition to FIGS. 15 to 17.

Since the printing signal SI[m] supplied during the unit operation period U indicates (b1, b2, b3)=(1, 1, 0), since the selection signals Sa, Sb and Sc are in a high level H, a low level L, and a low level L during the control period Us1, the driving waveform signal Com-A is selected by the transmission gate TGa, and the unit waveform PA1 is output as the driving signal Vin[m]. Similarly, during the control period Us2, the driving waveform signal Com-A is selected, and the unit waveform PA2 is output as the driving signal Vin[m]. Accordingly, in this case, the driving signal Vin[m] supplied to the ejection unit 35 of the m-th stage during the unit operation period U is the driving signal Vin for printing, and as illustrated in FIG. 18, a waveform thereof is a waveform DpAA including the unit waveform PA1 and the unit waveform PA2. As a result, during the unit operation period U, the ejection unit 35 of the m-th stage performs ejection of the medium amount of ink based on the unit waveform PA1 and ejection of the small amount of ink based on the unit waveform PA2, and the inks ejected twice are united on recording paper P, so that a large dot is formed on the recording paper P.

When the contents of the printing signal SI[m] to be supplied in the unit operation period U indicates (b1, b2, b3)=(1, 0, 0), since the driving waveform signal Com-A is selected during the control period Us1 and the driving waveform signal Com-B is selected during the control period Us2, the driving signal Vin[m] supplied to the ejection unit 35 of the m-th stage during the unit operation period U is the driving signal Vin for printing, and a waveform thereof is a waveform DpAB including the unit waveform PA1 and the unit waveform PB2. As a result, the ejection unit 35 of the m-th stage performs ejection of the medium amount of ink based on the unit waveform PA1 during the unit operation period U, so that a medium dot is formed on the recording paper P.

When the contents of the printing signal SI[m] supplied during the unit operation period U indicate (b1, b2, b3)=(0, 1, 0), since the driving waveform signal Com-B is selected in the control period Us1 and the driving waveform signal Com-A is selected in the control period Us2, the driving signal Vin[m] supplied to the ejection unit 35 of the m-th stage in the unit operation period U and the waveform thereof is a waveform DpBA including the unit waveform PB1 and the unit waveform PA2. As a result, the ejection unit 35 of the m-th stage ejects the ink in a small amount based on the unit waveform PA2 in the unit operation period U and small dots are formed on the recording paper P.

When the contents of the printing signal SI[m] supplied during the unit operation period U indicate (b1, b2, b3)=(0, 0, 0), since the driving waveform signal Com-B is selected in the control period Us1 and the control period Us2, the driving signal Vin[m] supplied to the ejection unit 35 of the m-th stage in the unit operation period U is the driving signal Vin for printing and the waveform thereof becomes a waveform DpBB including the unit waveform PB1 and the unit waveform PB2. As a result, the ink is not ejected from the ejection unit 35 of the m-th stage in the unit operation period U and dots are not formed on the recording paper P (becomes non-recording).

When the contents of the printing signal SI[m] supplied during the unit operation period U indicate (b1, b2, b3)=(0, 0, 1), since the driving waveform signal Com-C is selected in the control period Us1 and the control period Us2, the driving signal Vin[m] supplied to the ejection unit 35 of the m-th stage in the unit operation period U is a driving signal Vin for inspection and the waveform thereof is a waveform DpT including the unit waveform PC1 and the unit waveform PC2. Further, as described above, the unit waveforms PC1 and PC2 are changed according to the ink temperature T. Accordingly, the waveform DpT in a case where the ink temperature is “T” is represented as a symbol of “DpT(T).”

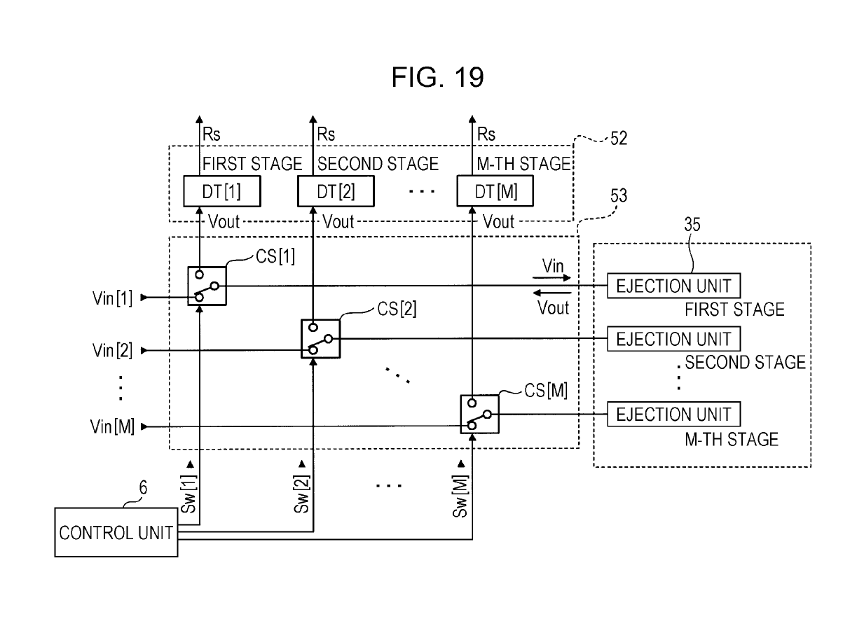

FIG. 19 is a block diagram illustrating a configuration of the switching unit 53 of the head driver 50. In FIG. 19, electric connection relations among the switching unit 53, the ejection abnormality detection unit 52, the ejection unit 35, and the driving signal generation unit 51 is illustrated.

As illustrated in FIG. 19, the switching unit 53 includes M switching circuits CS(CS[1], CS[2], . . . , and CS[4M]) having first to M-th stages in one-to-one correspondence with the M ejection units 35. Moreover, the ejection abnormality detection unit 52 includes M number of ejection abnormality detection circuits DT (DT[1], DT[2], . . . , and DT[M]) having first to M-th stages in one-to-one correspondence with the 4M ejection units 35.

The switching circuit CS[m] of the m-th stage electrically connects the piezoelectric elements 200 of the ejection unit 35 of the m-th stage to any one of an output terminal OTN of the m-th stage included in the driving signal generation unit 51 and the ejection abnormality detection circuit DT[m] of the m-th stage included in the ejection abnormality detection unit 52.

In the following description, in the switching circuits CS, a state where the ejection unit 35 and the output terminal OTN of the driving signal generation unit 51 are electrically connected is referred to as a first connection state. Moreover, a stage where the ejection unit 35 and the ejection abnormality detection circuit DT of the ejection abnormality detection unit 52 are electrically connected is referred to as a second connection state.

The control unit 6 outputs the switching control signals CS for controlling the connection states of the switching circuits U to the switching circuits U.

Specifically, when the ejection unit 35 of the m-th stage is used to perform the printing process during the unit operation period U, the control unit 6 supplies the switching control signal Sw[m] to the switching circuit CS[m] so as to allow the switching circuit CU[m] of the m-th stage corresponding to the ejection unit 35 of the m-th stage to maintain the first connection state over the entire period of the unit operation period U.

Meanwhile, when the ejection unit 35 of the m-th stage is an object of the ejection state determining process or the calibration process during the unit operation period U, the control unit 6 supplies the switching control signal Sw[m] to the switching circuit CS[m] so as to allow the switching circuit CS[m] of the m-th stage corresponding to the ejection unit 35 of the m-th stage to enter the first connection state during a period other than the switching period Ud of the unit operation period U and to enter the second connection state during the switching period Ud of the unit operation period U.

For this reason, the driving signal Vin is supplied to the ejection unit 35 which becomes the object of the ejection state determining process (or the calibration process) from the driving signal generation unit 51 during the period other than the switching period Ud of the unit operation period U, and the residual vibration signal Vin is supplied to the ejection abnormality detection circuit DT from the ejection unit 35 during the switching period Ud of the unit operation period U.

Further, as illustrated in FIG. 17, the switching period Ud is a period during which the switching period designation signal CtrS generated by the control unit 6 is set to a potential VL. Specifically, the switching period Ud is a period determined such that a period of the unit operation period U becomes a partial period or the entire period of a period during which the driving waveform signal Com-C (that is, the waveform DpT) maintains the potential Vc2(T).

The ejection abnormality detection circuit DT detects a change of the electromotive force of the piezoelectric elements 200 of the ejection unit 35 during the switching period Ud, as the residual vibration signal Vout.

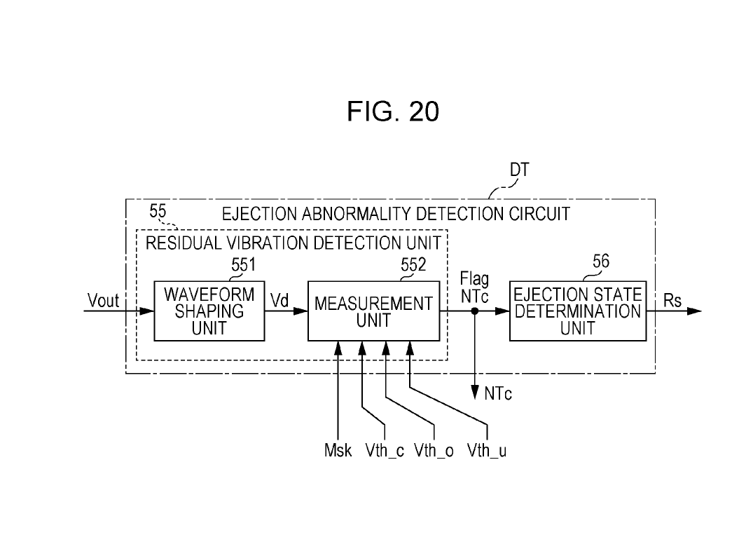

FIG. 20 is a block diagram illustrating the configuration of the ejection abnormality detection circuit DT included in the ejection abnormality detection unit 52.

As illustrated in FIG. 20, the ejection abnormality detection circuit DT includes a residual vibration detection unit 55 (an example of the detection unit) that outputs the cycle length signal NTc representing a time length corresponding to one cycle of the residual vibration of the ejection unit 35 based on the residual vibration signal Vout, and an ejection state determination unit 56 that determines the ejection state (that is, determines the presence of the ejection abnormality, and determine the causes of the ejection abnormality when the ejection abnormality is present) in the ejection unit 35 to output a determination result signal Rs representing the determination result.

Among them, the residual vibration detection unit includes a waveform shaping unit 551 that generates a waveform shaping signal Vd obtained by removing a noise component from the residual vibration signal Vout output from the ejection unit 35, and a measurement unit 552 that generates the cycle length signal NTc based on the waveform shaping signal Vd.

The waveform shaping unit 551 includes a high-pass filter for outputting a signal in which a low-band frequency component lower than a frequency band of the residual vibration signal Vout is damped, and a low-pass filter for outputting a signal in which a high-band frequency component higher than the frequency band of the residual vibration signal Vout is damped, and a configuration capable of limiting a frequency range of the residual vibration signal Vout and outputting the waveform shaping signal Vd from which the noise component is removed.

Moreover, the waveform shaping unit 551 may include a negative feedback type amplifier for adjusting the amplitude of the residual vibration signal Vout and a voltage follower for converting an impedance of the residual vibration signal Vout to output the waveform shaping signal Vd of a low impedance.

The waveform shaping signal Vd obtained by shaping the residual vibration signal Vout in the waveform shaping unit 551, a mask signal Msk generated by the control unit 6, a threshold potential Vth_c determined as a potential of an amplitude center level of the shaping waveform signal Vd, a threshold potential Vth_o determined as a high potential higher than the threshold potential Vth_c, and a threshold potential Vth_u determined as a low potential lower than the threshold potential Vth_c are supplied to the measurement unit 552. The measurement unit 552 outputs the cycle length signal NTc and an effective flag Flag indicating whether the cycle length signal NTc is an effective value based on these signals or the like.

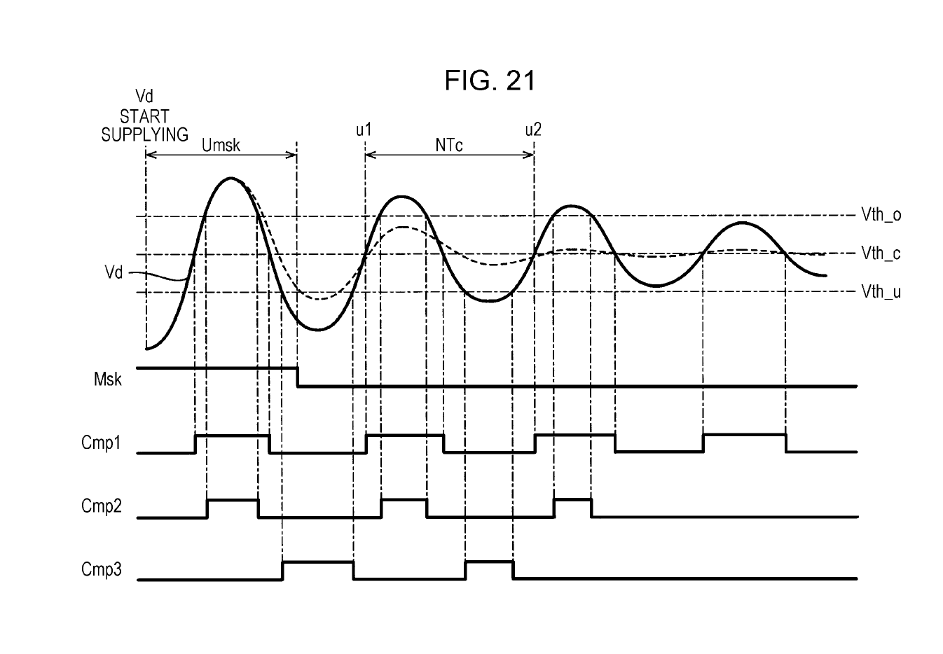

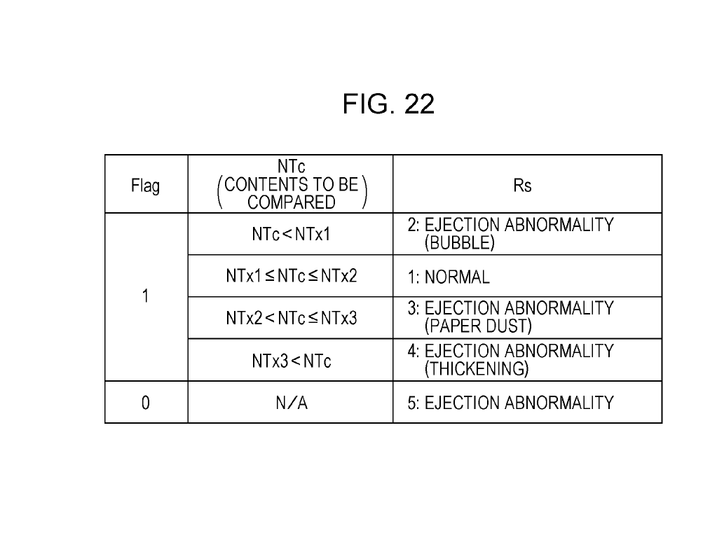

FIG. 21 is a timing chart illustrating an operation of the measurement unit 552.

As illustrated in the figure, the measurement unit 552 compares a potential indicated by the waveform shaping signal Vd with the threshold potential Vth_c, and generates a comparison signal Cmp1 which is in a high level when the potential indicated by the waveform shaping signal Vd is more than or equal to the threshold potential Vth_c and is in a low level when the potential indicated by the waveform shaping signal Vd is less than the threshold potential Vth-c.

Moreover, the measurement unit 552 compares the potential indicated by the waveform shaping signal Vd with the threshold potential Vth_o, and generates a comparison signal Cmp2 which is in a high level when the potential indicated by the shaping waveform signal Vd is more than or equal to the threshold potential Vth_o and is in a low level when the potential indicated by the waveform shaping signal Vd is less than the threshold potential Vth_o.

Moreover, the measurement unit 552 compares the potential indicated by the waveform shaping signal Vd with the threshold potential Vth_u, and generates a comparison signal Cmp3 which is in a high level when the potential indicated by the shaping waveform signal Vd is less than the threshold potential Vth_u and is in a high level when the potential indicated by the waveform shaping signal Vd is more than or equal to the threshold potential Vth_u.

The mask signal Msk is a signal which is in a high level only during a predetermined period Umsk after the supply of the waveform shaping signal Vd from the waveform shaping unit 551 is started. In the present embodiment, it is possible to obtain a high-accuracy cycle length signal NTc from which the superimposed noise components are removed immediately after the residual vibration starts by generating the detection signal NTc with only the waveform shaping signal Vd after the period Umsk elapses as an object among the waveform shaping signals Vd.

The measurement unit 552 includes a counter (not illustrated). After the mask signal Msk falls to a low level, the counter starts to count the clock signal (not illustrated) at a time u1 which is a timing when the potential indicated by the waveform shaping signal Vd is equal to the threshold potential Vth_c for the first time. That is, after the mask signal Msk falls to the low level, the counter starts to count at a time u1 which is an earlier timing to a timing when the comparison signal Cmp1 rises to a high level for the first time and a timing when the comparison signal Cmp1 falls to a low level for the first time.

In addition, after the counter starts, the counter stops counting the clock signal at a time u2 which is a timing when the potential indicated by the waveform shaping signal Vd becomes the threshold potential Vth_c for the second time, and outputs the obtained count value as the cycle length signal NTc. That is, after the mask signal Msk falls to the low level, the counter stops counting at a time u2 which is an earlier timing to a timing when the comparison signal Cmp1 rises to a high level for the second time and a timing when the comparison signal Cmp1 falls to a low level for the second time.

As described above, the measurement unit 552 generates the cycle length signal NTc by measuring a time length from the time u1 to the time u2 as a time length corresponding to one cycle of the waveform shaping signal Vd.

Incidentally, when the amplitude of the shaping waveform signal Vd is small as indicated by a dashed line in FIG. 21, it is highly likely that it is difficult to accurately measure the cycle length signal NTc. Moreover, when the amplitude of the waveform shaping signal Vd is small, even though it is determined that the ejection state of the ejection unit 35 is normal based on only the result of the detection signal NTc, it is likely that the ejection abnormality may occur. For example, when the amplitude of the waveform shaping signal Vd is small, it is considered that since the ink is not injected into the cavity 245, it is difficult to eject the ink.

Here, in the present embodiment, it is determined whether the amplitude of the waveform shaping signal Vd has a magnitude sufficient to measure the cycle length signal NTc to output the determination result as the effective flag Flag.

Specifically, the measurement unit 552 outputs the effective flag Flag by setting a value of the effective flag Flag to a value “1” indicating that the cycle length signal NTc is effective when the potential indicated by the waveform shaping signal Vd is more than the threshold potential Vth_o and is less than the threshold potential Vth_u and by setting the value of the effective flag to “0” in the other cases during the period during which the counting is performed by the counter, that is, the period from the time u1 to the time u2. More specifically, the measurement unit 552 sets the value of the effective flag Flag to “1” when the comparison signal Cmp2 rises to the high level from the low level and then falls to the low level again and the compassion signal Cmp3 rises to the high level from the low level and then falls to the low level again during the period from the time u1 to the time u2, and sets the value of the effective flag Flag to “0.”

In the present embodiment, since the measurement unit 552 determines whether the waveform shaping signal Vd has the amplitude of magnitude sufficient to measure the cycle length signal NTc in addition to generating the cycle length signal NTc indicating the time length corresponding to the one cycle of the waveform shaping signal Vd, it is possible to more accurately detect the ejection abnormality.

The ejection state determination unit 56 determines the ejection state of the ink in the ejection unit 35 based on the cycle length signal NTc and the effective flag Flag, and outputs the determination result as the determination result signal Rs.

FIG. 22 is an explanatory diagram for describing the contents of determination of the ejection state determination unit 56. As illustrated in the figure, the ejection state determination unit 56 compares the time length indicated by the cycle length signal NTc with a threshold value NTx1, a threshold value NTx2 representing a time length longer than the threshold value NTx1, and a threshold value NTx3 representing a time length longer than the threshold value NTx2.

Here, the threshold value NTx1 is a value for indicating a boundary between a time length corresponding to one cycle of the residual vibration when the bubbles are generated within the cavity 245 to increase the frequency of the residual vibration and a time length corresponding to one cycle of the residual vibration when the ejection state is normal.

Moreover, the threshold value NTx2 is a value for indicating a boundary between a time length corresponding to one cycle of the residual vibration when the paper dust is attached in the vicinity of the nozzles N to decrease the frequency of the residual vibration and a time length corresponding to one cycle of the residual vibration when the ejection state is normal.

Moreover, the threshold value NTx3 is a value for indicating a boundary between a time length corresponding to one cycle of the residual vibration when the frequency of the residual vibration becomes further smaller than that when the paper dust is attached by adhering or thickening of the ink in the vicinity of the nozzles N and a time length corresponding to one cycle of the residual vibration when the paper dust is attached in the vicinity of the outlets of the nozzles N.

As illustrated in FIG. 22, when the value of the effective flag Flag is “1” and satisfies “NTx1≦NTc≦NTx2,” the determination state determination unit 56 determines that the ejection state of the ink in the ejection unit 35 is normal, and sets the determination result signal Rs to a value “1” indicating that the ejection state is normal.

Moreover, when the value of the effective flag Flag is “1” and satisfies “NTc<NTx1,” the ejection state determination unit 56 determines that the ejection abnormality occurs due to the bubbles generated in the cavity 245, and sets the determination result signal Rs to a value “2” indicating that the ejection abnormality occurs due to the bubbles.

Moreover, when the value of the effective flag Flag is “1” and satisfies “NTx2<NTc≦NTx3,” the ejection state determination unit 56 determines that the ejection abnormality occurs due to the paper dust attached in the vicinity of the outlets of the nozzles N, and sets the determination result signal Rs to a value “3” indicating that the ejection abnormality occurs due to the paper dust.

Moreover, when the value of the effective flag is “1” and satisfies “NTx3<NTc,” the ejection state determination unit 56 determines that the ejection abnormality occurs due to the thickening of the ink in the vicinity of the nozzles N, and sets the determination result signal Rs to a value “4” indicating that the ejection abnormality occurs due to the thickening of the ink.

Moreover, when the value of the effective flag Flag is “0,” the ejection state determination unit 56 sets the determination result signal to a value “5” indicating that the ejection abnormality occurs due to some causes such as non-injection of the ink.

As described above, the ejection state determination unit 56 determines whether the ejection abnormality occurs in the ejection unit 35, and outputs the determination result as the determination result signal Rs. For this reason, when the ejection abnormality occurs, the control unit 6 stops the printing process if necessary and moves the head unit 30 to a position where the recovery process can be performed by the recovery mechanism 84, so that it is possible to perform an appropriate recovery process depending on the ejection abnormality indicated by the determination result signal Rs.

Further, the determination of the ejection state determination unit 56 may be performed in the control unit 6 (the CPU 61). In this case, the ejection abnormality detection circuit DT of the ejection abnormality detection unit 52 may be configured without including the ejection state determination unit 56, and may output the cycle length signal NTc generated by the residual vibration detection unit 55 to the control unit 6.

### 5. Ejection State Determination Process

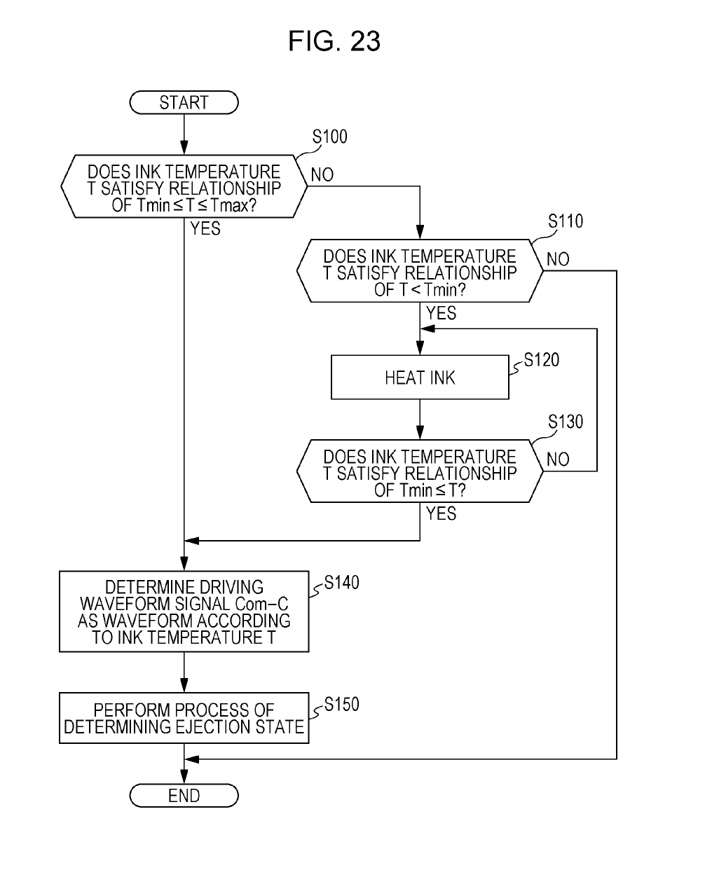

Next, the ejection state determination process and the preparation process for performing the ejection state determination process will be described with reference to FIGS. 23 to 25.

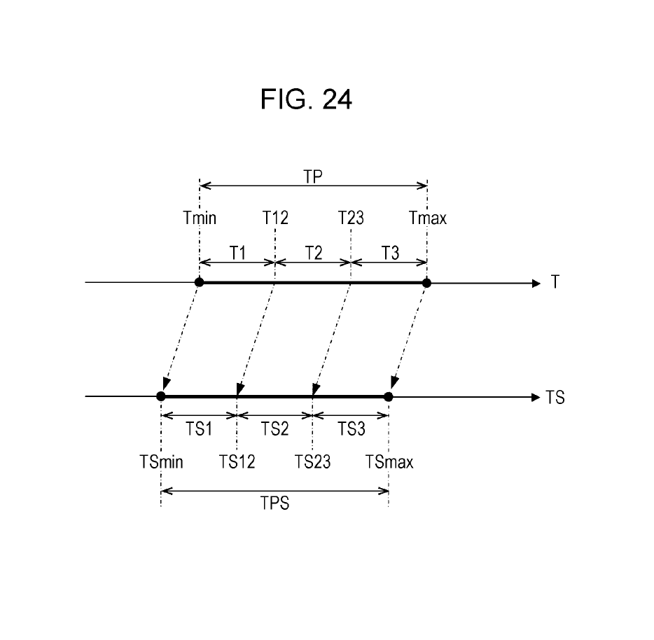

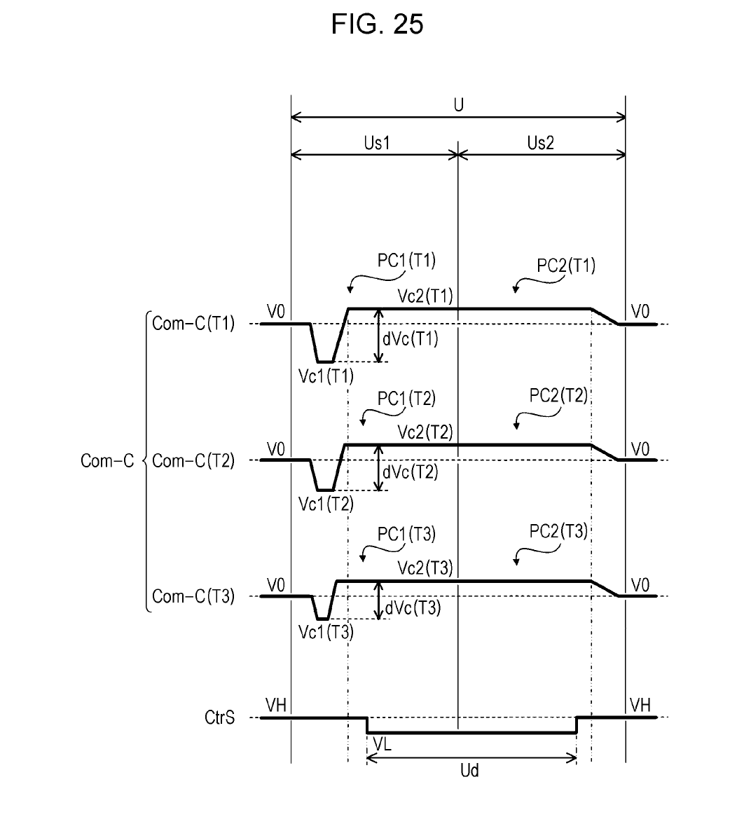

FIG. 23 is a flowchart illustrating an example of the operation of the ink jet printer 1 in the ejection state determination process and the preparation process thereof. In addition, FIG. 24 is an explanatory diagram illustrating a relationship between the ink temperature T and the detection temperature TS. FIG. 25 is a timing chart illustrating the waveform of the driving waveform signal Com-C determined according to the ink temperature T.

As described above, the ejection state determination process is performed only in a case where the ink temperature T belongs to a range (printing temperature range TP) from the temperature Tmin to the temperature Tmax.

Accordingly, as illustrated in FIG. 23, the CPU 61 determines whether the ink temperature T is within the printing temperature range TP based on the temperature detection signal RT output by the temperature sensor 81, that is, whether the ink temperature T satisfies “Tmin T Tmax” when the ejection state determination process is performed (S100).

Further, the temperature sensor 81 according to the present embodiment cannot directly detect the ink temperature T in the inside of the cavity 245 because the temperature sensor 81 is provided at the outside of the cavity 245.

Therefore, in the present embodiment, as illustrated in FIG. 24, a temperature TSmin detected by the temperature sensor 81 is measured in advance in a case where the ink temperature T is the temperature Tmin and a temperature TSmax detected by the temperature sensor 81 is measured in advance in a case where the ink temperature T is a temperature Tmax, and then the values of the temperature TSmin and the temperature TSmax which are measured in advance are stored in the storage unit 62.

In addition, in step S100, the CPU 61 determines whether the ink temperature T is within the printing temperature range TP by determining whether the detection temperature TS indicated by the temperature detection signal RT output by the temperature sensor 81 is within the range of the temperature TSmin to the temperature TSmax.

In a case where a result of the determination in Step S100 is negative, the CPU 61 determines whether the ink temperature T satisfies “T<Tmin” based on the detection temperature TS indicated by the temperature detection signal RT output by the temperature sensor 81 (S110).

Further, the CPU 61 regards that execution of the ejection state determination process is impossible and stops a series of processes illustrated in FIG. 23 in a case where the result of the determination in Step S110 is negative, that is, the ink temperature T is higher than a printing temperature range TP.

However, the CPU 61 waits elapse of a predetermined time, that is, waits until the ink temperature T is decreased to be within the printing temperature range TP in a case where the result of determination in Step S110 is negative, and the process proceeds to Step S100.

On the other hand, the CPU 61 heats the ink in the ejection unit 35 by driving the heater 82 in a case where the result of determination in Step S110 is positive, that is, in a case where the ink temperature T is lower than the printing temperature range TP (S120).

Next, the CPU 61 determines whether the ink temperature T satisfies “T≧Tmin,” that is, whether the ink temperature T is increased up to a temperature higher than or equal to the temperature Tmin which is a lower limit of the printing temperature range TP based on the detection temperature TS (S130).

Further, the CPU 61 proceeds the process to Step S120 for continuously heating the ink in the ejection unit 35 in a case where the result of determination in Step S130 is negative.

Subsequently, the CPU 61 decides a waveform of the driving waveform signal Com-C for generating the driving signal Vin for inspection supplied to the ejection unit 35 in the ejection state determination process in a case where the result of determination in Step S100 is positive or in a case where the result of determination in Step S130 is positive (S140).

In the present embodiment, after a temperature T12 and a temperature T23 satisfying a relationship of “Tmin<T12<T23<Tmax” are determined in advance, and the printing temperature range TP is divided into three temperature ranges of a temperature range T1 from the temperature Tmin to the temperature T12, a temperature range T2 from the temperature T12 to the temperature T23, and a temperature range T3 from the temperature T23 to the temperature Tmax as illustrated in FIG. 24.

Moreover, in Step S130, as illustrated in FIG. 25, the CPU 61 decides the waveform of the driving waveform Com-C as a waveform that continuously connects the unit waveform PC1 (T1) with the unit waveform PC2 (T1) in a case where the ink temperature T is within the temperature range T1, decides the waveform of the driving waveform signal Com-C as a waveform that continuously connects the unit waveform PC1 (T2) with the unit waveform PC2 (T2) in a case where the ink temperature T is within the temperature range T2, and decides the waveform of the driving waveform signal Com-C as a waveform that continuously connects the unit waveform PC1 (T3) with the unit waveform PC2 (T3) in a case where the ink temperature T is within the temperature range T3. Further, hereinafter, among the driving waveform signals Com-C, a signal of a waveform that continuously connects the unit waveform PC1 (T1) with PC2 (T1) is referred to as a driving waveform signal Com-C (T1), a signal of a waveform that continuously connects the unit waveform PC1 (T2) with PC2 (T2) is referred to as a driving waveform signal Com-C (T2), and a signal of a waveform that continuously connects the unit waveform PC1 (T3) with PC2 (T3) is referred to as a driving waveform signal Com-C (T3).

In the present embodiment, the driving waveform signals Com-C (T1), Com-C (T2), and Com-C (T3) are decided to respectively have a driving voltage dVc(T) which is a potential difference between the potentials Vc1(T) and Vc2(T) different from one another. Specifically, the driving voltage dVc(T1) of the driving waveform signal Com-C (T1), the driving voltage dVc(T2) of the driving waveform signal Com-C (T2), and the driving voltage dVc(T3) of the driving waveform signal Com-C (T3) are decided to satisfy a relationship of “dVc(T1)>dVc(T2)>dVc(T3).”

The waveforms of the driving waveform signals Com-C (T1), Com-C (T2), and Com-C (T3), that is, the unit waveform PC1 (T1), PC2 (T1), PC1 (T2), PC2 (T2), PC1 (T3), and PC2 (T3) are decided at the time of shipping products or initializing of the ink jet printer 1 in advance, or are stored in the storage unit 62 by being adjusted through the calibration process described below.

Moreover, in FIG. 24, the printing temperature range TP is divided into three temperature ranges (T1, T2, ad T3), but this is merely an example. For example, the same driving waveform signal Com-C may be supplied as long as the ink temperature T is within the range of the printing temperature range TP without dividing the printing temperature range TP. Further, the printing temperature range TP may be divided into two temperature ranges or may be divided into four or more temperature ranges. In a case where the printing temperature range TP is divided into two or more temperature ranges, a waveform of the driving waveform signal Com-C (T) may be decided for each temperature range in a case where the printing temperature range TP is divided into two or more temperature ranges.

Further, in FIG. 25, the waveform of the driving waveform signal Com-C (T) is decided for each temperature range by deciding the magnitude of the driving voltage dVc(T) for each temperature range, but this is merely an example of decision of a waveform. The decision of the waveform of the driving waveform signal Com-C(T) can be made based on any reference if the waveform appropriate for detection of vibration of the residual vibration can be decided in the ink temperature T.

The description is returned to FIG. 23.

In step S140, the CPU 61 determines whether the ink temperature T belongs to any of the temperature ranges of the temperature ranges T1, T2, and T3 based on the detection temperature TS of the temperature detection signal RT output by the temperature sensor 81. Further, the CPU 61 outputs the driving waveform signal Com-C (T) of the waveform according to the temperature range to which the ink temperature T belongs in Step S140 to the driving signal generation unit 51.

Moreover, the CPU 61 determines which temperature range the ink temperature T belongs to among the temperature ranges T1, T2, and T3 based on the detection temperature TS. Accordingly, in the present embodiment, as illustrated in FIG. 24, a temperature TS12 detected by the temperature sensor 81 is measured in advance in a case where the ink temperature T is the temperature T12 and a temperature TS23 detected by the temperature sensor 81 is measured in advance in a case where the ink temperature T is the temperature T23, and the values of the measured temperature TS12 and TS23 in advance are stored in the storage unit 62.

Subsequently, the CPU 61 allows the ejection unit 35 to be driven by the driving signal Vin generated based on the driving waveform signal Com-C (T) by the driving signal generation unit 51 by supplying the driving waveform signal Com-C (T) decided in Step S140 to the driving signal generation unit 51 and then operates the ejection state determination process by detecting the residual vibration generated in the ejection unit 35 (S150).

In this manner, in the present embodiment, the ink temperature T is adjusted to be within the printing temperature range TP and performs the ejection state determination process (Step S150) by operating the preparation process (Steps S100 to S140) for execution of the ejection state determination process. Therefore, determination on the ejection state of the ink in the ejection unit 35 can be made under the condition of a temperature in the same manner as that of the printing process and the ejection state of the ink in the ejection unit 35 can be accurately determined in a case where the printing process is performed.

Moreover, in the present embodiment, the ejection state determination process is performed by dividing the printing temperature range TP into the temperature ranges T1, T2, and T3 and deciding the waveform of the driving waveform signal Com-C(T) for each divided temperature range. Therefore, the waveform of the driving waveform signal Com-C appropriate for the ejection state determination process can be respectively set for each divided temperature range and the determination on the ejection state of the ink in the ejection unit 35 can be made in consideration of the change of the ink temperature T accurately.

Further, the CPU 61 functions as a “temperature determination unit” by operating Step S100, or Steps S100 and S110, or Steps S100, S110, and S130. Moreover, the CPU 61 functions as a “decision unit” by operating Step S140.

### 6. Calibration Process

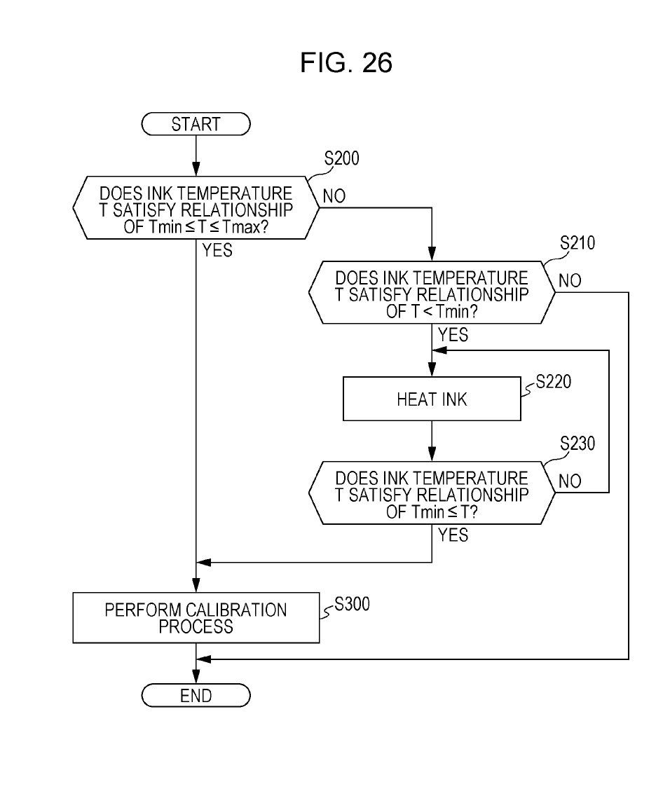

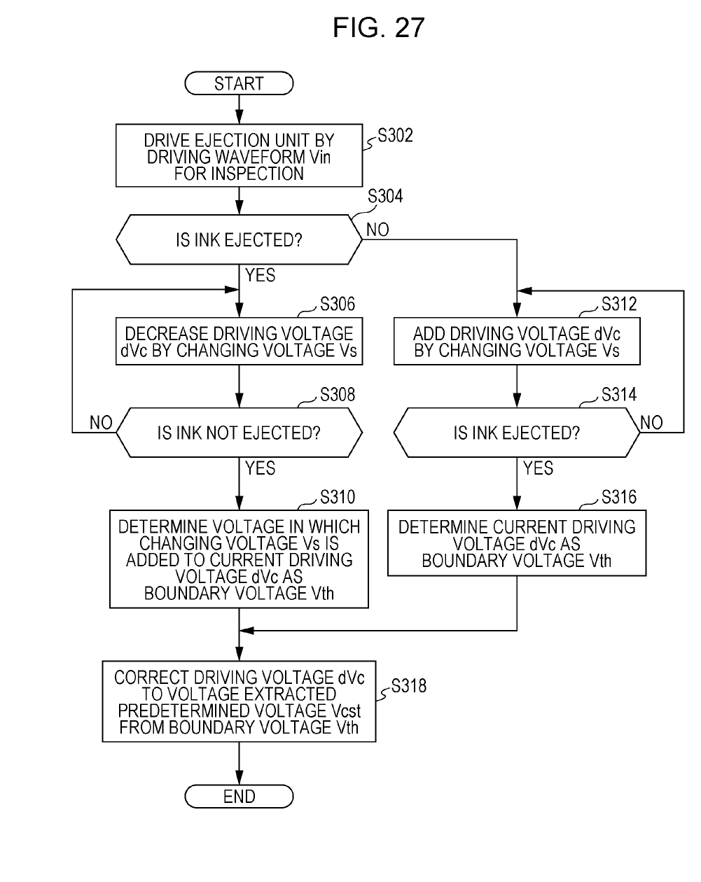

Next, the calibration process and the preparation process for executing the calibration process will be described with reference of FIGS. 26 and 27.

FIG. 26 is a flowchart illustrating an example of the operation of the ink jet printer 1 in the calibration process and the preparation process. FIG. 27 is a flowchart illustrating an example of the operation of the ink jet printer 1 in the calibration process.

As illustrated in FIG. 26, the CPU 61 determines whether the ink temperature T is within the printing temperature range TP, that is, whether the ink temperature T satisfies a relationship of “Tmin≦T≦Tmax” based on the detection temperature TS indicated by the temperature detection signal RT output by the temperature sensor 81 at the time of execution of the calibration process (S200). Specifically, the CPU 61 determines whether the ink temperature T is within the printing temperature range TP by determining whether the detection temperature TS is within the range of the temperature TSmin to the temperature TSmax in Step S200.

In a case where the result of determination in Step S200 is negative, the CPU 61 determines whether the ink temperature T satisfies “T<Tmin” based on the detection temperature TS (S210).

In a case where the result of determination in Step S210 is negative, the CPU 61 regards that the execution of the calibration process is impossible so as to stop a series of processes illustrated in FIG. 26. However, in a case where the result of determination in Step S210 is negative, the CPU 61 waits elapse of the predetermined time, that is, waits until the ink temperature T is decreased to be within the printing temperature range TP, and may proceed the process to Step S200.

In contrast, in a case where the result of determination in Step S210 is positive, the CPU 61 heats the ink in the ejection unit 35 by driving the heater 82 (S220).

Subsequently, the CPU 61 determines whether the ink temperature T satisfies “T≧Tmin” based on the detection temperature TS (S230).

In a case where the result of determination in Step S230 is negative, the CPU 61 proceeds the process to Step S220 for continuously heating the ink in the ejection unit 35.

Moreover, in a case where the result of determination in Step S200 is positive or in a case where the result of determination in Step S230 is positive, the CPU 61 operates the calibration process which is a process of adjusting the waveform of the driving waveform signal Com-C (waveform of the driving signal Vin for inspection) (S300).

On the other hand, the ink composition, mechanical properties and electrical properties of the ejection unit 35, and other physical properties thereof are changed with time in some cases. Further, the surrounding environment such as humidity or the like is changed with time. In a case where the change of the ink composition or the like occurs with time, the waveform (the amplitude, the cycle, or the like) of the residual vibration generated in the ejection unit 35 becomes largely different before and after the change with time even when the ejection unit 35 is driven by the driving signal Vin generated based on the same driving waveform signal Com.

As described above, in the ejection state determination process, the ejection state of the ink in the ejection unit 35 is determined by driving the ejection unit 35 by the driving signal Vin generated based on the driving waveform signal Com according to the ink temperature T. That is, the ejection state determination process in the present embodiment is not a process in which the ejection state is determined in consideration of the ink composition, the change of elements other than the ink temperature T with time, and the like. Accordingly, in a case where the change of the ink composition or the like occurs with time, there is a problem in that the ejection state cannot be accurately determined even when the ejection state determination process is performed.

Moreover, as in the present embodiment, in a case where the ejection state determination process is performed by non-ejection inspection in which the ejection state is determined without allowing the ink to be ejected from the ejection unit 35, the waveform of the driving signal Vin for inspection is adjusted to a waveform such that the ink is not ejected from the ejection unit 35 even when the ejection unit 35 is driven by the driving signal Vin for inspection in advance.

However, even when the waveform of the driving signal Vin for inspection is adjusted to a waveform such that the ink is not ejected from the ejection unit 35, the ink may be ejected from the ejection unit 35 driven by the driving signal Vin for inspection in a case where the change of the ink composition or the like with time occurs after the adjustment. In this case, there is a problem in that the recording paper P becomes contaminated by the ink being ejected onto the recording paper P in the ejection state determination process.

Accordingly, in the present embodiment, in order to prevent the problem which is generated due to the change of the ink composition or the like with time, the calibration process of adjusting the waveform of the driving signal Vin for inspection is performed between the initialization operation of the ink jet printer 1 or the start operation of the ink jet printer 1. In this manner, even in a case where the change of the ink composition or the like occurs with time, since the waveform of the driving signal Vin for inspection (driving waveform signal Com-C) is corrected (adjusted) to a waveform appropriate for the state after the change of the ink composition or the like with time and the ejection state determination process is performed by the driving signal Vin for inspection having a waveform after the adjustment, it is possible to prevent generation of the above-described various problems.

Here, the initialization operation is an operation performed for the ink jet printer 1 to become capable of operating the printing process in a case of installing the ink jet printer 1 and is an operation including filling the inside of the cavity 245 with the ink or a reading process or the like of reading various initialization values.

Further, the start operation is performed after the initialization process and is an operation performed for executing the printing process appropriately after the ink jet printer 1 is turned on or immediately before the ink jet printer 1 operates the printing process, and is an operation including cleaning (recovery process) the ejection unit 35 or heating the ink.

In addition, since the calibration process in the present embodiment is a process on the premise that the ink is ejected from the ejection unit 35, the calibration process is performed after the carriage 32 is moved to a position facing the ink receiving unit 843.

Further, a specific method of adjusting the waveform of the driving signal Vin for inspection in the calibration process may be performed using any method. Hereinafter, an example of specific contents of calibration process will be described with reference to FIG. 27.

As illustrated in FIG. 27, the CPU 61 drives the ejection unit 35 by the driving signal Vin for inspection generated based on the driving waveform signal Com-C in the calibration process (S302). Further, the driving waveform signal Com-C which allows the CPU 61 to be generated in Step S302 has a waveform decided based on information stored in the storage unit 62 at the time immediately before the calibration process is performed.

Next, the CPU 61 determines whether the ink is ejected from the ejection unit 35 to which the driving signal Vin for inspection is supplied in Step S302 (S304). Further, in the present embodiment, the determination whether the ink is ejected from the ejection unit 35 may be made based on an image imaged by an imaging apparatus (not illustrated) or may be made based on a result of an input after the result of visual recognition is input from the operation panel 85.

In a case where the result of determination in Step S304 is positive, that is, in a case where the ink is ejected from the ejection unit 35, the CPU 61 corrects the waveform of the driving waveform signal Com-C by decreasing the driving voltage dVc(T) of the driving waveform signal Com-C by a predetermined driving voltage Vs (S306).

Next, in step S306, the CPU 61 drives the ejection unit 35 by the driving signal Vin for inspection generated based on the driving waveform signal Com-C having a waveform after correction and determines whether the ejection state of the ink is non-ejection in the ejection unit 35 (S308).

In a case where the result of determination in Step S308 is negative, that is, in a case where the ink is ejected from the ejection unit 35, the CPU 61 proceeds the process to Step S306 and decreases the driving voltage dVc(T) of the driving waveform signal Com-C by the change voltage Vs.

In contrast, in a case where the result of determination in Step S308 is positive, the CPU 61 decides the voltage in which the change voltage Vs is added to the current driving voltage dVc(T) as a boundary voltage Vth (S310).

In a case where the result of determination in Step S304 is negative, that is, in a case where the ejection state of the ink in the ejection nit 35 is non-ejection, the CPU 61 corrects the waveform of the driving waveform signal Com-C by increasing the driving voltage dVc(T) of the driving waveform signal Com-C by a predetermined change voltage Vs (S312).

Next, the CPU 61 drives the ejection unit 35 by the driving signal Vin for inspection generated based on the driving waveform signal Com-C having a waveform after correction in Step S312 and determines whether the ink is ejected from the ejection unit 35 (S314).

In a case where the result of determination in Step S314 is negative, the CPU 61 proceeds the process to Step S312 and increases the driving voltage dVc(T) of the driving waveform signal Com-C by the change voltage Vs.

In contrast, in a case where the result of determination in Step S314 is positive, the CPU 61 decides the current driving voltage dVc(T) as a boundary voltage Vth (S316).

Subsequently, the CPU 61 decides the voltage in which a predetermined voltage Vcst is subtracted from the boundary voltage Vth as the driving voltage dVc(T) and decides the driving waveform signal Com-C having the driving voltage dVc(T) as the corrected driving waveform signal Com-C(S318).

In this manner, the waveform of the driving waveform signal Com-C is decided as a waveform including the driving voltage dVc(T) having the same magnitude to a degree that the ejection of the ink from the ejection unit 35 is prevented and the residual vibration can be effectively detected.

In this manner, in the present embodiment, the ink temperature T is adjusted to a temperature in which the ink temperature T is within the printing temperature range TP and the calibration process (Step S300, that is, Steps S302 to S318) is performed by executing the preparation process (Steps S200 to S230) for performing the calibration process. That is, since the waveform of the driving waveform signal Com-C is decided under the conditions of the temperature which is the same as that in the case where the printing process is performed, it is possible to decide a waveform of the driving waveform signal Com-C which is capable of accurately determining the ejection state of the ink of the ejection unit 35 in a case where the printing process is performed.

Further, in FIGS. 26 and 27, the ink temperature T is adjusted to be within the printing temperature range TP, but the invention is not limited thereto.

For example, the ink temperature T is adjusted to be within the temperature range T1, the calibration process is performed with respect to the waveform signal Com-C (T1), the ink temperature T is adjusted to be within the temperature range T2, the calibration process is performed with respect to the driving waveform signal Com-C (T2), the ink temperature T is adjusted to be within the temperature range T3, and the calibration process may be performed with respect to the driving waveform signal Com-C (T3). In this case, the waveform of the driving waveform signal Com-C (T) corresponding to the ink temperature T can be accurately adjusted.

Further, the CPU 61 functions as a “temperature determination unit” by operating Step S200 or Steps S200 and S210 or Steps S200, S210, and S230. Further, the CPU 61 functions as a “decision unit” by performing Step S300 (Steps S302 to S318).

### 7. Ink Used for Present Embodiment

Next, the ink used in the present embodiment will be described.

The ink jet printer 1 according to the present embodiment uses an ultraviolet curable ink (hereinafter, referred to as an “ink composition” in some cases) as an ink.

Hereinafter, the preferred ultraviolet curable ink will be described. The ultraviolet curable ink has the viscosity at 20° C. and the average equivalent of an unsaturated double bond which are within the predetermined ranges respectively.

### 7.1. Viscosity at 20° C. of Ultraviolet Curable Ink

The ultraviolet curable ink has a viscosity at 20° C. of 25 mPa·s or less, preferably in the range of 15 mPa·s to 25 mPa·s, and more preferably in the range of 17 mPa·s to 23 mPa·s. When the viscosity at 20° is less than or equal to the above-described upper limit, the ejection stability of the ink becomes excellent. Further, when the viscosity at 20° C. is more than or equal to the lower value, the generation of curing wrinkles can be effectively suppressed.

The principle of the curing wrinkles being generated will be assumed as follows, but the invention will not be limited to the following assumption. In coating with the ink, it is assumed that the curing wrinkles are generated by the coated surface, which is cured first, being deformed and by the ink in the inside of the coating flowing irregularly until the ink is cured when a coated surface is cured first and a coated inside is cured after the coated surface is cured. Further, it is assumed that the generation of the curing wrinkles is considerate because there is a tendency that the ultraviolet curable ink with low viscosity has a high polymerization contractiveness (a difference between the volume of the ink and the volume of the ink (cured material) after curing with respect to the volume of the ink before curing having a predetermined mass) accompanied by the curing. Further, it is assumed that there is a tendency that the curing wrinkles are easily generated in an ultraviolet curable ink containing a monofunctional (meth)acrylate described below and a vinyl ether group-containing (meth)acrylate represented by the following general formula (I) and the curing wrinkles are considerably generated particularly in an ultraviolet curable ink with low viscosity and containing vinyl ether group-containing (meth)acrylate represented by the general formula (I). In addition, in the ultraviolet curable ink used for a method of ink jet recording of the present embodiment, it is possible to effectively suppress the generation of curing wrinkles by adjusting the viscosity to be within the above-described range.

Here, an example of a method of designing the ink for adjusting the viscosity of the ink to be within a desired range will be described.

The mixed viscosity of the entire polymerizable compounds contained in the ink can be calculated from the viscosity of each polymerizable compound to be used and the mass ratio of each polymerizable compound to the ink composition.

It is assumed that the ink contains N types of polymerizable compounds of a polymerizable compounds A, B, . . . (omitted), and N. The viscosity of the polymerizable compound A is set as VA and the mass ratio of the polymerizable compound A to the total amount of the polymerizable compounds in the ink is set as MA. The viscosity of the polymerizable compound B is set as VB and the mass ratio of the polymerizable compound B to the total amount of the polymerizable compounds in the ink is set as MB. Similarly, the viscosity of the N-th polymerizable compound N is set as VN and the mass ratio of the polymerizable compound N to the total amount of the polymerizable compounds in the ink is set as MN. When an expression is expressed for confirmation, an expression of “MA+MB+ . . . (omitted), +MN=1” is satisfied. In addition, the mixed viscosity of the each polymerizable compound contained in the ink is set as VX. It is assumed that the following expression (1) is satisfied under the above-described conditions.

MA×Log VA+MB×Log VB+ . . . (omitted)+MN×Log Vn=Log VX (1)

Further, for example, in a case where two or more kinds of the polymerizable compounds are included in the ink, the mass ratio of the polymerizable compound subsequent to MB is set to O. The number of types of the polymerizable compounds can be set as an arbitrary number of one or more kinds.

Subsequently, an example of procedures (Steps 1 to 7) for adjusting the viscosity of the ink to be within the desired range will be described below.

Firstly, information related to the viscosity in a predetermined temperature of each polymerizable compound to be used is obtained (Step 1). Examples of the obtaining method include obtaining from the a manufacturer catalog and obtaining by measuring the viscosity at a predetermined temperature of each polymerizable compound. The viscosity of a polymerizable compound varies due to manufacturers even in a case of the same polymerizable compound, so information related to the viscosity due to the manufacturers of the polymerizable compounds to be used may be employed.

Subsequently, a target viscosity is set as VX and a composition ratio (mass ratio) of each polymerizable compound is decided such that VX becomes the target viscosity based on the above-described Expression (1) (Step 2). The target viscosity is a viscosity of the ink composition intended to be finally obtained, for example, is a viscosity in the range of 15 mPa·s to 25 mPa·s. The predetermined temperature is set to 20° C.

Subsequently, a composition of the polymerizable compound (hereinafter, referred to as a “polymerizable composition”) is prepared by actually mixing the polymerizable compounds and the viscosity at the predetermined temperature is measured (Step 3).

Next, in a case where the viscosity of the polymerizable composition is approximately close to the target viscosity (in Step 4, a range of “the target viscosity±5 mPa·s” is necessary to be satisfied), an ink composition containing components other than polymerizable compounds such as the polymerizable composition, a photopolymerization initiator, or a pigment (hereinafter, referred to as “components other than the polymerizable compounds”) is prepared and the viscosity of the ink composition is measured (Step 4). In Step 4, in a case where components other than the polymerizable compounds, which are mixed into the ink composition in a form of a pigment dispersion liquid such as a pigment are present, since the polymerizable compounds contained in the pigment dispersion liquid in advance are brought by the ink composition, it is necessary to adjust the ink composition by the mass ratio in which the mass ratio of the polymerizable compound brought by the ink composition as the pigment dispersion liquid is subtracted from the composition ratio of each polymerizable compound decided in Step 2.

Subsequently, a difference between the measured viscosity of the ink composition and the measured viscosity of the polymerizable composition is calculated and then is set as VY (Step 5). Here, VY generally satisfies “VY>0.” VY varies depending on conditions such as the types or the contents of the components other than the polymerizable compounds, but VY is in the range of 3 mPa·s to 5 mPa·s in the Examples described below.

Next, “target viscosity in Step 2—VY” is decided in VX and the composition ratio of each polymerizable compound is decided again such that VX becomes “target viscosity in Step 2—VY” decided in advance from the above-described Expression (1) (Step 6).

Subsequently, an ink composition is prepared by mixing each polymerizable component having a composition ratio decided in Step 6 and components other than the polymerizable compounds, and the viscosity in the predetermined temperature is measured (Step 7). When the viscosity is the target viscosity, this means that the ink composition prepared in Step 7 is obtained as an ink composition having the target viscosity.

On the other hand, in Step 3, in a case where the measured viscosity of the composition of the prepared polymerizable compounds is out of the range of “target viscosity±5 mPa·s,” the procedures from Step 3 are performed again after minute adjustment described below is performed. Firstly, when the above-described measured viscosity is extremely high, the minute adjustment is performed, for example, the content of the polymerizable compound whose viscosity is higher than the target viscosity as a single substance is decreased and the content of the polymerizable compound whose viscosity is lower than the target viscosity as a single substance is increased. In contrast, the measured viscosity is extremely low, the minute adjustment is performed, for example, the content of the polymerizable compound whose viscosity is lower than the target viscosity as a single substance is decreased and the content of the polymerizable compound whose viscosity is higher than the target viscosity as a single substance is increased. Further, in Step 7, in a case where the measured viscosity of the prepared ink composition does not satisfy the target viscosity, adjustment which is the same as the above-described adjustment is performed and then procedures are performed again from Step 7.

### 7.2. Average Equivalent of Polymerizable Unsaturated Double Bond

The above-described ultraviolet curable ink has an average equivalent of polymerizable unsaturated double bond of 100 to 150, preferably in the range of 110 to 150, and more preferably in the range of 120 to 150. When the average equivalent of the polymerizable unsaturated double bond is more than or equal to the above-described lower limit, since the amount of reaction heat generated due to curing can be minimized, it is possible to prevent increase of the temperature after continuous printing and the storage stability becomes excellent. In addition, when the average equivalent of the polymerizable unsaturated double bond is lower than or equal to the above-described upper limit, curability becomes excellent.

Here, the “average equivalent of the polymerizable unsaturated double bond” in the present specification means an average equivalent of the polymerizable unsaturated double bond. A compound having the polymerizable unsaturated double bond may be a compound having a polymerizable functional group having the polymerizable unsaturated double bond, and examples thereof, which are not limited thereto, include a (meth)acrylate compound, a vinyl compound, a vinyl ether compound, and an allyl compound. A compound having the above-described polymerizable unsaturated double bond may be a compound having one or more polymerizable functional groups, and in a case where a compound having two or more polymerizable functional groups, the polymerizable functional groups may be the same as or different from each other. Further, each compound described above can be classified into a polymerizable compound having an aromatic ring skeleton, a polymerizable compound having a cyclic or linear aliphatic skeleton, and a polymerizable compound having a heterocyclic skeleton from the structures other than the above-described polymerizable functional group.

In the present specification, the average equivalent of the polymerizable unsaturated double bond of the ultraviolet curable ink can be acquired as follows. Firstly, the equivalent of the polymerizable unsaturated double bond of the polymerizable compound is calculated by Expression (2) below.

Equivalent of polymerizable unsaturated double bond of polymerizable compound=molecular weight of polymerizable compound/number of polymerizable unsaturated double bond contained in molecules of polymerizable compound (2)

In Expression (2) above, as the molecular weight of the polymerizable compound or the number of the polymerizable unsaturated double bond, values calculated from the values of the manufacturer catalog or values calculated from the chemical structural formulae can be employed.

Next, the average equivalent of the polymerizable unsaturated double bond of the ink is calculated by Expression (3) below.

Average equivalent of polymerizable unsaturated double bond of ink=(equivalent of polymerizable unsaturated double bond of polymerizable compound A×content in ink of polymerizable compound A+equivalent of polymerizable unsaturated double bond of polymerizable compound B×content in ink of polymerizable compound B+ . . . +equivalent of polymerizable unsaturated double bond of polymerizable compound n×content in ink of polymerizable compound n)/(content in ink of polymerizable compound A+content in ink of polymerizable compound B+ . . . +content in ink of polymerizable compound n) (3)

Expression (3) above is an expression at the time when it is assumed that the ink contains n types of polymerizable compounds and “n” is an arbitrary integer of 1 or more. In Expression (3) above, the “content” indicates % by mass with respect to the total mass of the ink.

As the average equivalent of the polymerizable unsaturated double bond of the ink is smaller, the ink includes the polymerizable unsaturated double bond in a larger amount and the amount of reaction heat generated accompanied by polymerization of the ink becomes larger. In contrast, as the average equivalent of the polymerizable unsaturated double bond of the ink is larger, the ink includes the polymerizable unsaturated double bond in a smaller amount and the amount of reaction heat generated accompanied by polymerization of the ink becomes smaller.

Hereinafter, an additive (component) which can be contained the ultraviolet curable ink in the present embodiment will be described.

### 7.3. Polymerizable Compound

The polymerizable compound contained in the ink is polymerized alone by an action of a photopolymerization initiator described below at the time of irradiation of light and can allow the printed ink to be cured. As the polymerizable compound, monofunctional, bifunctional, trifunctional, and multi-functional various known monomers and oligomers in the related art can be used. Examples of the monomer include unsaturated carboxylic acid, salts thereof such as (meth)acrylic acid, itaconic acid, crotonic acid, isocrotonic acid or maleic acid, ester, urethane, amide, and anhydrides thereof, acrylonitrile, styrene, various unsaturated polyesters, unsaturated polyether, unsaturated polyamide, and unsaturated urethane. Further, examples of the oligomer include oligomer formed from the monomers such as linear acrylic oligomer, epoxy(meth)acrylate, oxetane(meth)acrylate, cyclic or linear aliphatic urethane(meth)acrylate, aromatic urethane(meth)acrylate, and polyester(meth)acrylate.

Among these, ester of (meth)acrylic acid, that is, (meth)acrylate is preferable. Among the (meth)acrylate, a combination of a monofunctional (meth)acrylate and bifunctional or multi-functional (meth)acrylate is preferable, and a combination of monofunctional (meth)acrylate and bifunctional (meth)acrylate is more preferable.

Hereinafter, the polymerizable compound will be described in detail using (meth)acrylate and then the above-described vinyl ether group-containing (meth)acrylic acid esters will be described because vinyl ether group-containing (meth)acrylic acid esters represented by the general formula (I) is preferably exemplified.

### 7.3.1. Vinyl Ether Group-Containing (Meth)Acrylic Acid Esters

It is preferable that the ink contain vinyl ether group-containing (meth)acrylate represented by the following general formula (I).

CH2=CR¹—COOR²—O—CH═CH—R³ (I)

(in the formula, R¹ represents a hydrogen atom or a methyl group, R² represents a divalent organic residue having 2 to 20 carbon atoms, R³ represents a hydrogen atom or a monovalent organic residue having 1 to 11 carbon atoms)

By the ink containing the vinyl ether group-containing (meth)acrylic acid esters, the viscosity of the ink can be decreased, the curability of the ink can be excellent, and the generation of curing wrinkles can be effectively suppressed. Further, it is preferable to use a compound having a vinyl ether group and a (meth)acrylic group together in a molecule rather than separately using a compound having a vinyl ether group and a compound having a (meth)acrylic group.

In the above-described general formula (I), as the divalent organic residue having 2 to 20 carbon atoms represented by R2, a linear, branched, or cyclic alkylene group, which can be substituted, having 2 to 20 carbon atoms, and alkylene group, which can be substituted, having oxygen atoms by an ether bond and/or an ester bond in the structure and having 2 to 20 carbon atoms, and a divalent aromatic group, which can be substituted, having 6 to 11 carbon atoms are preferable. Among these, an alkylene group having 2 to carbon atoms such as an ethylene group, an n-propylene group, an isopropylene group, or a butylene group and an alkylene group having 2 to 9 carbon atoms having oxygen atoms by an ether bond in the structure such as an oxyethylene group, an oxy n-propylene group, or an oxybutylene group is preferably used.

In the above-described general formula (I), as the monovalent organic residue having 1 to 11 carbon atoms represented by R3, a linear, branched, or cyclic alkyl group which has 1 to 10 carbon atoms and may be substituted and an aromatic group which has 6 to 11 carbon atoms and may be substituted are preferable. Among these, an alkyl group having 1 to 2 carbon atoms such as a methyl group or an ethyl group, and an aromatic group having 6 to 8 carbon atoms such as a phenyl group or a benzyl group can be preferably used.

In a case where the above-described respective organic residues are groups which may be substituted, the substituents are divided into a group containing carbon atoms and a group with no carbon atoms. Firstly, in a case where the above-described substituent is a group containing carbon atoms, the carbon atoms are counted by carbon numbers of the organic residue. Examples of the group containing carbon atoms, which are not particularly limited, include a carboxyl group and an alkoxy group. Next, examples of the group with no carbon atoms, which are not particularly limited, include a hydroxyl group and a halogen group.

Examples of the above-described vinyl ether group-containing (meth)acrylic acid esters, which are not limited thereto, include 2-vinyloxyethyl(meth)acrylic acid, 3-vinyloxypropyl(meth)acrylic acid, 1-methyl-2-vinyloxyethyl(meth)acrylic acid, 2-vinyloxypropyl(meth)acrylic acid, 4-vinyloxybutyl(meth)acrylic acid, 1-methyl-3-vinyloxypropyl(meth)acrylic acid, 1-vinyloxymethylpropyl (meth)acrylic acid, 2-methyl-3-vinyloxypropyl(meth)acrylic acid, 1,1-dimethyl-2-vinyloxyethyl(meth)acrylic acid, 3-vinyloxybutyl(meth)acrylic acid, 1-methyl-2-vinyloxypropyl(meth)acrylic acid, 2-vinyloxybutyl(meth)acrylic acid, 4-vinyloxycyclohexyl(meth)acrylic acid, 6-vinyloxyhexyl(meth)acrylic acid, 4-vinyloxymethylcyclohexylmethyl(meth)acrylic acid, 3-vinyloxymethylcyclohexylmethyl(meth)acrylic acid, 2-vinyloxymethylcyclohexylmethyl(meth)acrylic acid, p-vinyloxymethylphenylmethyl(meth)acrylic acid, m-vinyloxymethylphenylmethyl(meth)acrylic acid, o-vinyloxymethylphenylmethyl(meth)acrylic acid, 2-(vinyloxyethoxy)ethyl(meth)acrylic acid, 2-(vinyloxyisopropoxy)ethyl(meth)acrylic acid, 2-(vinyloxyethoxy)propyl(meth)acrylic acid, 2-(vinyloxyethoxy)isopropyl(meth)acrylic acid, 2-(vinyloxyisopropoxy)propyl(meth)acrylic acid, 2-(vinyloxyisopropoxy)isopropyl(meth)acrylic acid, 2-(vinyloxyethoxyethoxy)ethyl(meth)acrylic acid, 2-(vinyloxyethoxyisopropoxy)ethyl(meth)acrylic acid, 2-(vinyloxyisopropoxyethoxy)ethyl(meth)acrylic acid, 2-(vinyloxyisopropoxyisopropoxy)ethyl(meth)acrylic acid, 2-(vinyloxyethoxyethoxy)propyl(meth)acrylic acid, 2-(vinyloxyethoxyisopropoxy)propyl(meth)acrylic acid, 2-(vinyloxyisopropoxyethoxy)propyl(meth)acrylic acid, 2-(vinyloxyisopropoxyisopropoxy)propyl(meth)acrylic acid, 2-(vinyloxyethoxyethoxy)isopropyl(meth)acrylic acid, 2-(vinyloxyethoxyisopropoxy)isopropyl(meth)acrylic acid, 2-(vinyloxyisopropoxyethoxy)isopropyl(meth)acrylic acid, 2-(vinyloxyisopropoxyisopropoxy)ispropyl(meth)acrylic acid, 2-(vinyloxyethoxyethoxyethoxy)ethyl(meth)acrylic acid, 2-(vinyloxyethoxyethoxyethoxyethoxy)ethyl(meth)acrylic acid, 2-(isopropenoxyethoxy)ethyl(meth)acrylic acid, 2-(isopropenoxyethoxyethoxy)ethyl(meth)acrylic acid, 2-(isopropenoxyethoxyethoxyethoxy)ethyl(meth)acrylic acid, 2-(isopropenoxyethoxyethoxyethoxyethoxy)ethyl, (meth)acrylic acid polyethylene glycol monovinyl ether, and (meth)acrylic acid polypropylene glycol monovinyl ether.

Among these, from viewpoints that the viscosity of the ink can be further reduced, the flash point is high, and the curability of the ink is excellent, 2-(vinyloxyethoxy)ethyl(meth)acrylic acid, that is, any one of 2-(vinyloxyethoxy)ethyl acrylate and 2-(vinyloxyethoxy)ethyl methacrylate is preferable, 2-(vinyloxyethoxy)ethyl acrylate is more preferably. Particularly, since both of 2-(vinyloxyethoxy)ethyl acrylate and 2-(vinyloxyethoxy)ethyl methacrylate have simple structures and small molecular weight, the viscosity of the ink can be made considerably low. Examples of 2-(vinyloxyethoxy)ethyl(meth)acrylic acid include 2-(2-vinylxyethoxy)ethyl(meth)acrylic aid and 2-(1-vinyloxyethoxy)ethyl(meth)acrylic acid and examples of 2-(vinyloxyethoxy)ethyl acrylate include 2-(2-vinyloxyethoxy)ethyl acrylate, and 2-(1-vinylxyethoxy)ethyl acrylate. Further, 2-(vinyloxyethoxy)ethyl acrylate is excellent in terms of curability compared to 2-(vinyloxyethoxy)ethoxy methacrylate.

Vinyl ether group-containing (meth)acrylic acid esters may be used alone or in combination of two or more kinds thereof.

As a method of producing the vinyl ether group-containing (meth)acrylic acid esters, which is not particularly limited, a method of esterifying (meth)acrylic acid and hydroxyl group-containing vinyl ether (production method B), a method of esterifying (meth)acrylic acid halide and hydroxyl group-containing vinyl ether (production method C), a method of esterifying (meth)acrylic acid anhydride and hydroxyl group-containing vinyl ether (production method D), a method of performing ester-exchanging of (meth)acrylate and hydroxyl group-containing vinyl ether (production method E), a method of esterifying (meth)acrylate and halogen-containing vinyl ether (production method F), a method of esterifying (meth)acrylic acid alkaline(earth)metal salt and halogen-containing vinyl ether (production method G), a method of performing vinyl-exchanging of hydroxyl group-containing (meth)acrylate and carboxylic acid vinyl (production method H), or a method of performing ester-exchanging of hydroxyl group-containing (meth)acrylic acid ester and alkyl vinyl ether.

Among these, since desirable effects can be further exhibited in the present invention, the production method EE is preferable.

### 7.3.2. Monofunctional (Meth)Acrylate

It is preferable that the ink contain monofunctional (meth)acrylate. Here, in a case where the ink contains the above-described vinyl ether group-containing (meth)acrylic acid esters (in this case, limited to monofunctional (meth)acrylate), the vinyl ether group-containing (meth)acrylate is contained in the above-described monofunctional (meth)acrylate, but description on the vinyl ether group-containing (meth)acrylic acid esters will be omitted. Hereinafter, monofunctional (meth)acrylate other than vinyl ether group-containing (meth)acrylic acid esters will be described. The viscosity of the ink can be made low, the curability of the ink becomes more excellent, and the solubility of photopolymerization initiators and other additives become excellent by the ink containing the monofunctional (meth)acrylate. Further, the ejection stability of the ink becomes more excellent due to the fact that the solubility of the photopolymerization initiator and other additives becomes more excellent, and toughness, heat resistance, and chemical resistance of a coating film are improved.

Examples of the above-described monofunctional (meth)acrylate include phenoxyethyl (meth)acrylate, isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol(meth)acrylate, 2-hydroxybutyl(meth)acrylate, 4-hydroxybutyl(meth)acrylate, 2-methoxyethyl(meth)acrylate, buthoxyethyl (meth)acrylate, ethoxy diethylene glycol (meth)acrylate, methoxy diethylene glycol (meth)acrylate, methoxy polyethylene glycol (methOacrylate, methoxy propylene glycol (meth)acrylate, tetrahydrofurfuryl (meth)acrylate, 2-hydroxypropyl(meth)acrylate, 2-hydroxy-3-phenoxypropyl (meth)acrylate, lactone-modified flexible (meth)acrylate, t-butylcyclohexyl(meth)acrylate, dicyclopentanyl (meth)acrylate, dicyclopentenyloxyethyl (meth)acrylate, benzyl (meth)acrylate, ethoxylated nonyl phenyl (meth)acrylate, alkoxylated nonyl phenyl (meth)acrylate, and p-cumyl phenol EO-modified (meth)acrylate.

Among these, the monofunctional (meth)acrylate having an aromatic ring skeleton in a molecule in terms of more excellent curability, storage stability, and solubility of the photopolymerization initiator. Preferred examples of the monofunctional (meth)acrylate having an aromatic ring skeleton, which are not limited thereto, include phenoxyethyl (meth)acrylate, benzyl (meth)acrylate, 2-hydroxyphenoxypropyl (meth)acrylate, and phenoxy diethylene glycol (meth)acrylate. Among these, at least one of phenoxyethyl (meth)acrylate and benzyl (meth)acrylate is preferable and phenoxyethyl (meth)acrylate is more preferable because the viscosity of the ink can be made low and curability, abrasion resistance, adhesion properties of the ink to a recorded medium, and the solubility of the photopolymerization initiator can be excellent.

The monofunctional (meth)acrylate other than the above-described vinyl ether group-containing (meth)acrylic acid esters may be used alone or in combination of two or more kinds thereof.

The content of the monofunctional (meth)acrylate is preferably in the range of 30% by mass to 70% by mass and more preferably in the range of 40% by mass to 60% by mass based on the total mass (100% by mass) of the ink. When the content is within the above-described range, specifically, both of the viscosity of the ink at 20° C. and the viscosity of the ink at the ink temperature T (ejection temperature) can be easily adjusted to be within a desirable range. In addition, when the content thereof is more than equal to the above-described lower limit, the curability becomes more excellent and the solubility of the photopolymerization initiator becomes excellent. Further, when the content thereof is less than or equal to the above-described upper limit, the curability becomes excellent and adhesion properties become excellent.

Moreover, in a case where the ink contains the above-described vinyl ether group-containing (meth)acrylic acid esters which are monofunctional (meth)acrylate, the content of the monofunctional (meth)acrylate is a content containing the same.

Particularly, in a case where the ink contains the above-described vinyl ether group-containing (meth)acrylic acid esters, the content of the vinyl ether group-containing (meth)acrylic acid esters is preferably in the range 10% by mass to 50% by mass and more preferably in the range of 15% by mass to 40% by mass based on the total mass (100% by mass) of the ink. When the content thereof is more than or equal to the above-described lower limit, the viscosity of the ink can be made low and the curability of the ink can be more excellent. In addition, when the content thereof is less than or equal to the above-described upper limit, it is possible to maintain the storage stability of the ink in an excellent state and to suppress the generation of curing wrinkles more effectively.

Moreover, in a case where the ink contains monofunctional (meth)acrylate other than the above-described vinyl ether group-containing (meth)acrylic acid esters, the content of (meth)acrylate is preferably in the range of 10% by mass to 40% by mass and more preferably in the range of 10% by mass to 30% by mass. When the content thereof is more than or equal to the above-described lower limit, the solubility of the photopolymerization initiator becomes more excellent in addition to the curability. In addition, in a case where the content thereof is less than or equal to the above-described upper limit, the adhesion property becomes more excellent in addition to the curability. The monofunctional (meth)acrylate is preferable because the monofunctional (meth)acrylate other than the above-described vinyl ether group-containing (meth)acrylic acid esters has more excellent curability and solubility of the photopolymerization initiator.

### 7.3.3 Bifunctional or Higher-Functional (Meth)Acrylate

The ink preferably contains bifunctional or higher-functional (meth)acrylate. As mentioned above, a combination of monofunctional (meth)acrylate and bifunctional or higher-functional (meth)acrylate is more preferable.

The bifunctional (meth)acrylate includes, for example, diethylene glycol di(meth)acrylate, triethylene glycol di(meth)acrylate, tetraethylene glycol di(meth)acrylate, polyethylene glycol di(meth)acrylate, dipropylene glycol di(meth)acrylate, triethylene glycol di(meth)acrylate, polypropylene glycol di(meth)acrylate, 1,4-butanediol di(meth)acrylate, 1,6-hexanediol di(meth)acrylate, 1,9-nonane diol di(meth)acrylate, neopentyl glycol di(meth)acrylate, dimethylol tricyclodecane (meth)acrylate, bisphenol A EO (ethylene oxide) adduct di(meth)acrylate, bisphenol A PO (propylene oxide) adduct di(meth)acrylate, Hydroxypivalic acid neopentyl glycol di(meth)acrylate, and polytetramethylene glycol di(meth)acrylate

The trifunctional or higher-multifunctional (meth)acrylate includes, for example, Trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerol propoxy tri(meth)acrylate, carprolactone-modified trimethylolpropane tri(meth)acrylate, ethoxylated pentaerythritol tetra(meth)acrylate, and caprolactam-modified dipentaerythritol hexa(meth)acrylate.

The bifunctional or higher-functional (meth)acrylate may be used alone, and two or more kinds thereof may be used.

The content of the bifunctional or higher-functional (meth)acrylate is preferably determined from a relationship with the above-described preferable content of monofunctional (meth)acrylate. The content of the bifunctional or higher-functional (meth)acrylate is preferably 20% to 60%, and is more preferably 20% to 50%, relative to the total mass (100% by mass) of ink. If the corresponding content is within the above range, curability of ink or abrasion resistance of a cured object is good, and viscosity of ink is easily designed to desired viscosity. In addition, monofunctional (meth)acrylate of a polymerizable compound whose simple substance has relatively low viscosity, particularly, the above ether group-containing (meth)acrylic acid esters are preferably combined with other polymerizable compounds with relatively high viscosity. Accordingly, it becomes easier to design viscosity of the above-described ink to a desired range. In addition, from the relationship with the above-described preferable content of the monofunctional (meth)acrylate, monofunctional (meth)acrylate of 30% by mass to 70% by mass and bifunctional or higher-functional (meth)acrylate of 20% by mass to 60% by mass are preferably contained.

In addition, the total content of the polymerizable compound may be about 50% by mass to 95% by mass relative to the total mass (100% by mass) of the ink from a relationship with the content of other components.

Further, a photopolymerizable compound is used as the polymerizable compound, and thus addition of a photopolymerization initiator may be omitted, but using the photopolymerization initiator enables initiation of polymerization to be easily adjusted, and is thus preferable.

### 7.4. Photopolymerization Initiator

The ink of the present embodiment may include a photopolymerization initiator. The photopolymerization initiator is use to form a print by curing ink present on a surface of the recording paper P through photopolymerization due to irradiation with ultraviolet rays. Among rays, using ultraviolet rays (UV) ensures excellent safety and minimizes costs of light source lamps. An initiator is not limited as long as the initiator generates active kinds such as radicals or cations so as to initiate polymerization of the polymerizable compound, but a photo-radical polymerization initiator or a photo-cation polymerization initiator may be used, and, of the two initiators, the photo-radical polymerization initiator is preferably used.

The above photo-radical polymerization initiator may include, for example, aromatic ketones, acyl phosphine oxide compounds, aromatic onium salt compounds, organic peroxides, thio compounds (thioxanthone compound, a thiophenyl group-containing compound, and the like), hexaarylbiimidazole compounds, ketoxime ester compounds, borate compounds, azinium compounds, metallocene compounds, active ester compounds, compounds having a carbon-halogen bond, and alkyl amine compounds.

Among the compounds, particularly, the acyl phosphine oxide compounds can make curability of ink more favorable and are thus preferable.

Specific examples of the photo-radical polymerization initiator may include acetophenone, acetophenone benzyl ketal, 1-hydroxy cyclohexyl phenyl ketone, 2,2-dimethoxy-2-phenyl acetophenone, xanthone, fluorenone, benzaldehyde, fluorene, anthraquinone, triphenylamine, carbazole, 3-methylacetophenone, 4-chloro-benzophenone, 4,4′-dimethoxy benzophenone, 4,4′-diaminobenzophenone, Michler's ketone, benzoin propyl ether, benzoin ethyl ether, benzyl dimethyl ketal, 1-(4-isopropyl-phenyl)-2-hydroxy-2-methyl-1-one, 2-hydroxy-2-methyl-1-phenyl-1-one, thioxanethone, diethylthioxanthone, 2-isopropylthioxanthone, 2-chlorothioxantone, 2-methyl-1-[4-(methylthio)phenyl]-2-morpholino-propan-1-one, bis(2,4,6-trimethyl benzoyl)-phenyl phosphine oxide, 2,4,6-trimethyl benzoyl-diphenyl-phosphine oxide, 2,4-diethylthioxanthone, and bis-(2,6-dimethoxyphenyl)-2,4,4-trimethyl pentyl phosphine oxide.

As commercial products of the photo-radical polymerization initiator, there are, for example, IRGACURE 651 (2,2-dimethoxy-1,2-diphenylethan-1-one), IRGACURE 184 (1-hydroxy-cyclohexyl-phenyl-ketones), DAROCUR 1173 (2-hydroxy-2-methyl-1-phenyl-propan-1-one), IRGACURE 2959 (1-[4-(2-hydroxyethoxy)-phenyl]-2-hydroxy-2-methyl-1-propane-1-one), IRGACURE 127 (2-hydroxy-1-{4-[4-(2-hydroxy-2-methyl-propionyl)-benzyl]phenyl]-2-methyl-propan-1-on}, IRGACURE 907 (2-methyl-1-(4-methyl thio)-2-morpholinopropan-1-on), IRGACURE 369 (2-benzyl-2-dimethyl-1-(4-morpholino phenyl)-butanone-1), IRGACURE 379 (2-(dimethylamino)-2-[(4-methylphenyl)methyl]-1-[4-(4-morpholinyl)phenyl]-1-butanone), DAROCUR TPO (2,4,6-trimethyl benzoyl-diphenyl-phosphine oxide), IRGACURE 819 (bis(2,4,6-trimethyl benzoyl)-phenyl phosphine oxide), IRGACURE 784 (bis(η5-2,4-cyclopentadien-1-yl)-bis(2,6-difluoro-3-(1H-pyrrol-1-yl)-phenyl)titanium), IRGACURE OXE 01 (1.2-octanedione, 1-[4-(phenylthio)-, 2-(O-benzoyl oxime)]), IRGACURE OXE 02 (ethanone, 1-[9-ethyl-6-(2-methyl-benzoyl)-9H-carbazol-3-yl]-, 1-(O-acetyl oxime)) IRGACURE 754 (a mixture of oxy-phenyl acetic acid ethyl ester, 2-oxy-phenylacetic acid, and 2-[phenylacetoxyethoxy-2-oxo-(2-hydroxyethoxy)ethyl ester) (the above are the names of products manufactured by BASF Corporation), KAYACURE DETX-S (2,4-diethylthioxanthone) (the above is the trade name of the product manufactured by Nippon Kayaku Co., Ltd.), Speedcure TPO (2,4,6-trimethyl benzoyl-diphenyl-phosphine oxide), Speedcure DETX (2,4-diethylthioxanthone-9-one) (the above are the trade names of the products manufactured by Lambson Corporation), Lucirin TPO, LR8893, and LR8970 (the above are the trade names of the products manufactured by BASF Corporation), and Ubecryl P36 (the above is the trade name of the product manufactured by UCB Co., Ltd.).

The photopolymerization initiator may be used alone, and a combination of two or more kinds thereof may be used.

The content of the photopolymerization initiator is preferably 20% by mass or less relative to the total mass (100% by mass) of ink in order to obtain good curability by improving an ultraviolet-ray curing rate and to avoid coloring caused by a photopolymerization initiator remaining after the photopolymerization initiator is melted.

Particularly, in a case where the photopolymerization initiator contains an acyl phosphine oxide compound, the content thereof is more preferably 5% by mass to 15% by mass, and is the most preferably 7% by mass to 13% by mass, relative to the total mass (100% by mass) of ink. If the content is equal to or more than the lower limit value, the curability becomes better. More specifically, since a sufficient curing rate can be obtained when curing is performed, especially, by using an LED (a preferable peak wavelength: 360 nm to 420 nm), the curability becomes better. On the other hand, if the content is equal to or less than the upper limit value, solubility of the photopolymerization initiator becomes better.

### 7.5 Coloring Material

The ink of the present embodiment may include a coloring material. As a coloring material, at least one of a pigment or a dye may be used.

### 7.5.1 Pigment

If a pigment is used as the coloring material, light resistance of the ink can be improved. The pigment may use an inorganic pigment and an organic pigment.

As the inorganic pigment, carbon black such as furnace black, lamp black, acetylene black, channel black (C. I. Pigment Black 7), iron oxide, or titanium oxide may be used.

The organic pigment may include an azo pigment such as an insoluble azo pigment, a condensed azo pigment, an azo lake pigment, or a chelate azo pigment, a polycyclic pigment such as a phthalocyanine pigment, perylene and perinone pigments, an anthraquinone pigment, a quinacridone pigment, a dioxane pigment, a thioindigo pigment, an isoindolinone pigment, or a quinophthalone pigment, dye chelates (for example, basic dye chelates, acidic dye chelates, and the like), color lakes (basic dye lakes, and acidic dye lakes), a nitro pigment, a nitroso pigment, aniline black, and daylight fluorescent pigment.

Pigments used in white ink may include C. I. Pigment White 6, 18 and 21.

Pigments used in yellow ink may include C. I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Pigments used in magenta ink may include C. I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224 and 245, or C. I. Pigment Violet 19, 23, 32, 33, 36, 38, 43 and 50.

Pigments used in cyan ink may include C. I. Pigment Blue 1, 2, 3, 15, 15:1, 15:2, 15:3, 15:34, 15:4, 16, 18, 22, 25, 60, 65 and 66, and C. I. Vat Blue 4 and 60.

In addition, pigments other than the magenta, cyan and yellow pigments may include, for example, C. I. Pigment Green 7 and 10, C. I. Pigment Brown 3, 5, 25 and 26, and C. I. Pigment Orange 1, 2, 5, 7, 13, 14, 15, 16, 24, 34, 36, 38, 40, 43 and 63.

The pigment may be used alone, and two or more kinds thereof may be used together.

In a case where the pigments are used, an average particle diameter is preferably 300 nm or less, and is more preferably 50 nm to 200 nm. If the average particle diameter is within the range, reliability such as ejection stability or dispersion stability is further improved, and an image with good image quality can be formed. Here, an average particle diameter in the present specification is measured by using a dynamic light scattering method.

### 7.5.2 Dye

As the coloring material, a dye may be used. As the dye, without particularly being limited, an acid dye, a direct dye, a reactive dye, and a basic dye may be used. The dye may include, for example, C. I. Acide Yellow 17, 23, 42, 44, 79 and 142, C. I. acid Red 52, 80, 82, 249, 254 and 289, C. I. Acid Blue 9, 45 and 249, C. I. Acid Black 1, 2, 24 and 94, C. I. Food Black 1 and 2, C. I. Direct Yellow 1, 12, 24, 33, 50, 55, 58, 86, 132, 142, 144 and 173, C. I. Direct Red 1, 4, 9, 80, 81, 225 and 227, C. I. Direct Blue 1, 2, 15, 71, 86, 87, 98, 165, 199 and 202, C. I. Direct Black 19, 38, 51, 71, 154, 168, 171 and 195, C. I. Reactive Red 14, 32, 55, 79 and 249, and C. I. Reactive Black 3, 4 and 35.

The dye may be used alone, and two or more kinds thereof may be used together.

The content of the coloring material is preferably 1% by mass to 20% by mass relative to the total mass (100% by mass) of ink in order to obtain a high hiding property and color reproducibility.

### 7.6 Dispersant

In a case where the ink of n the present embodiment contains pigments, a dispersant may be contained in order to make pigment dispersibility more favorable. Although not particularly limited, the dispersant may include, for example, a dispersant which is customarily used to prepare a pigment dispersion such as a polymer dispersant. Specific examples thereof may include dispersants containing, as main components, one or more kinds of polyoxyalkylene polyalkylene polyamines, vinyl-based polymers and copolymers, acrylic polymers and copolymers, polyesters, polyamides, polyimides, polyurethanes, amino-based polymer, silicon-containing polymers, sulfur-containing polymers, fluorine-containing polymers, and epoxy resins. As commercial products of the polymer dispersant, there may be Ajisper series (trade name) manufactured by Ajinomoto Fine-Techno Co., Inc., Solsperse series (Solsperse 32000, 36000, and the like (trade names)) available from Avecia Co., Disperbyk series (trade name) manufactured by BYKChemic Corporation, and Disperon series (trade name) manufactured by Kusumoto Chemicals, Ltd.

The dispersant may be used alone, and a combination of two or more kinds thereof may be used. In addition, the content of the dispersant is not particularly limited, and a preferable amount thereof may be added as appropriate.

### 7.7. Other Additives

The ink of the present embodiment may contain not only the above-described additives but also other additives (components). Such components are not particularly limited, but may be, for example, a fluorescent brightening agent (sensitizer), a silicon-based surfactant, a polymerization inhibitor, a polymerization accelerator, a permeation promoter, a wetting agent (moisturizer), and other additives, which are well-known in the related art. The other additives may be, for example, a fixing agent, an antifungal agent, an antiseptic, an oxidation inhibitor, an ultraviolet absorbing agent, a chelating agent, a pH adjuster, and a thickener.

Subsequently, description will be made of the recording paper P used in the ink jet printer 1 according to the present embodiment, and each step included in a recording method.

### 7.8 Recording Medium

The recording paper P may include, for example, ink non-absorbent or low absorbent recording media. Among the recording media, the ink non-absorbent recording medium may include, for example, a plastic film on which surface treatment for ink jet recording is not performed (that is, an ink absorbent layer is not formed), a medium in which plastic is coated on a base material such as paper, or a medium to which a plastic film is adhered. The plastic mentioned here may include polyvinyl chloride (PVC), polyethylene terephthalate (PET), polycarbonate (PC), polystyrene (PS), polyurethane (PU), polyethylene (PE), and polypropylene (PP). Examples of the ink low absorbent recording medium may include print paper such as art paper, coated paper, or mat paper.

### 7.9 Ejection Process

In an ejection process of the present embodiment, an ultraviolet-ray curable ink is ejected onto the recording paper P from the ejection unit 35 after an ink temperature T becomes a temperature in a printing temperature range TP (ejection temperature). In addition, the printing temperature range TP is 30° C. to 40° C.

The printing temperature range TP of 30° C. to 40° C. is a temperature which is increased through heating and is relatively low. As mentioned above, if the ejected ink temperature T is relatively low, a temperature variation scarcely occurs, and thus there is an advantageous effect in which ejection stability of an ink is favorable.

Hereinafter, the ejection temperature will be described more in detail. If the ejection temperature is 30° C. or more, the ejection stability becomes better. In addition, an ultraviolet-ray curable ink which can be ejected at below 30° C. has extremely low viscosity, but there is a problem in that curing wrinkle tends to occur due to the low viscosity. In contrast, the ink of the present embodiment can solve the problem. Further, the problem is notable, especially, in a case where a printer type is a line printer and a light source is a light emitting diode (LED). For this reason, in the present embodiment, when the line printer or the LED is used, a considerable effect is achieved.

On the other hand, if the ejection temperature is 40° C. or less, it is possible to minimize a temperature increase in the ink jet printer 1.

In addition, the printing temperature range TP which is a range of the ejection temperature is preferably 34° C. to 40° C. in order to further increase the effect and more reliably solve the problem.

Further, viscosity of the ink in the printing temperature range TP is preferably 8 mPa·s to 15 mPa·s, and more preferably 8 mPa·s to 13 mPa·s. If the viscosity is within the range, it is possible to effectively minimize the occurrence of curing wrinkle caused by a composition of the ink, and ejection stability becomes better as a result of preventing unstable ejection caused by high viscosity.

In addition, as described above, the ultraviolet-ray curable ink has viscosity higher than viscosity of an aqueous ink used as a typical ink jet ink, and thus has a great viscosity variation due to a temperature variation during ejection. This viscosity variation of the ink has great influence on variations in liquid droplet sizes and variations in liquid droplet ejection rates. For this reason, a temperature (ejection temperature) of an ejected ink is preferably maintained as constant as possible. The ink of the present embodiment has a relatively low ejection temperature, and its ejection temperature can be maintained approximately constant. Therefore, the ink of the present embodiment is excellent in image quality stability.

### 7.10 Curing Process

In a curing process included in the recording method of the present invention, an ultraviolet-ray curable ink attached to the recording paper P is cured by irradiating the ink with ultraviolet rays (light) from the light source 83. In this process, a photopolymerizable initiator contained in the ink is decomposed by irradiation with the ultraviolet rays so as to generate initiation kinds such as radicals, acids, and bases, and a polymerization reaction of a polymerizable compound is promoted by functions of the initiation kinds. Alternatively, in this process, a polymerization reaction of the polymerizable compound is initiated by irradiation with the ultraviolet rays. At this time, if there is a sensitizing dye along with the photopolymerization initiator, the sensitizing dye in the system absorbs the ultraviolet rays so as to be excited and to promote decomposition of the photopolymerization initiator through contact with the photopolymerization initiator, and thus it is possible to achieve a more highly sensitive curing reaction.

A mercury lamp or a gas or solid-state laser is mainly used as the light source 83, and a mercury lamp or a metal halide lamp is widely used as the light source 83 used for curing the ultraviolet-ray curable ink. On the other hand, a mercury-free lamp is currently considerably desirable from the viewpoint of the protection of the environment, and replacement with a GaN-based semiconductor ultraviolet-ray light emitting device is very useful in terms of industry and environment. In addition, a light emitting diode (LED) such as a ultraviolet-ray light emitting diode (UV-LED) and an ultraviolet-ray laser diode (UV-LD) is small-sized, long in lifetime, highly efficient, and cheap, and is expected as a light source for the ultraviolet-ray curable ink.

As mentioned above, the ultraviolet-ray curable ink of the present embodiment can be suitably used in a case where the light source 83 is either the LED or the metal halide lamp, but the LED is more preferable of the two light sources.

An emission peak wavelength of the light source 83 is preferably within a range of 360 nm to 420 nm, and more preferably within a range of 380 nm to 410 nm. If the emission peak wavelength is within the range, a UV-LED can be easily available and is also cheap, which is thus suitable.

In addition, a peak intensity (irradiation peak intensity) of ultraviolet rays applied from the light source (preferably, an LED) having an emission peak wavelength in the range is preferably 500 mW/cm² or more, more preferably 800 mW/cm² or more, and the most preferably 1,000 mW/cm² or more. If the irradiation peak intensity is within the range, curability becomes better, and the occurrence of curing wrinkle can be more effectively minimized. Particularly, if an irradiation peak intensity of ultraviolet rays which are initially applied to an ink which is ejected onto the recording paper P is within the range, the occurrence of curing wrinkle can be more effectively minimized. A principle in which the curing wrinkle is estimated as mentioned above, but if the irradiation peak intensity is within the range, a coating film surface can be cured, and its inside can also be cured, and thus it is estimated that the occurrence of curing wrinkle can be more effectively minimized. In addition, if viscosity of the ink of the present embodiment at 20° C. is 15 mPa·s or more, the occurrence of curing wrinkle can be more effectively minimized. Particularly, if the ultraviolet-ray curable ink contains vinyl ether group-containing (meth)acrylic acid esters expressed in the above Chem. (1), and an irradiation peak intensity is within the range, curability becomes better, and the occurrence of curing wrinkle can be even more effectively minimized.

Further, the irradiation peak intensity in the present specification employs a value which is measured by using an ultraviolet intensity meter UM-10 and a receiver UM-400 (both are manufactured by KONICA MINOLTA SENSING, INC.). However, this is not intended to limit a measurement method of the irradiation peak intensity, and a well-know measurement method of the related art may be used.

In addition, preferably, the ultraviolet-ray curable ink of the present embodiment can be cured at irradiation energy of 200 mJ/cm² or less. If the ultraviolet-ray curable ink is used in the recording method of the present embodiment, curing can be performed even if an LED with a relatively small irradiation energy amount is used, and thus heat generation from the LED can be reduced. Therefore, it is possible to realize low cost printing and a high printing speed. A lower limit of irradiation energy which can cure an ink is not particularly limited, but may be 100 mJ/cm² or more.

In addition, irradiation energy during recording is preferably 600 mJ/cm² or less, and more preferably 500 mJ/cm² or less, in order to minimize the heat generation due to the irradiation. A lower limit of irradiation energy during recording is not particularly limited, but may be 200 mJ/cm² or more in order to perform sufficient curing. Here, the irradiation energy during recording is a total amount of irradiation energy which sums a plurality of amounts of irradiation energy in a case where irradiation is performed for multiple times.

In addition, the irradiation energy in the present specification is calculated by multiplying the irradiation peak intensity by the time from irradiation start to irradiation end. In addition, in a case where the irradiation is performed for multiple times, the irradiation energy is represented by an irradiation energy amount which sums a plurality of number of times of irradiation. One or a plurality of emission peak wavelengths may be present within the preferable wavelength range. Even in a case where there are a plurality of emission peak wavelengths, a total irradiation energy amount of ultraviolet rays having the emission peak wavelength within the range is used as the irradiation energy.

Such an ink can be obtained as a result of containing at least one of a photopolymerization initiator which is decomposed through ultraviolet-ray irradiation within the wavelength range and a polymerizable compound which initiates polymerization through the ultraviolet-ray irradiation within the wavelength range.

In addition, an ink ejection amount (an attachment amount or a hitting amount) per unit area during ejection onto the recording paper P is preferably 5 mg/inch² to 16 mg/inch² in order to prevent wasteful use of the ink.

In addition, although an ink ejection amount per unit area varies depending on a recording resol and an ink amount which is hit per recording unit region (pixel) defined by the recording resolution, the recording resolution (printing resolution) is preferably 300 dpi×300 dpi to 1500 dpi×1500 dpi when represented by “a resolution in a sub-scanning direction×a resolution (main scanning direction) in a direction intersecting the sub-scanning direction”. In addition, a nozzle density of the head unit 30 and an ejection amount are preferably adjusted according to the recording resolution.

In addition, an ink ejection amount per pixel is preferably 2 ng/pixel to 50 ng/pixel, and more preferably 3 ng/pixel to 20 ng/pixel. In addition, the nozzle density (a distance between nozzles in a nozzle string) is preferably 180 dpi to 720 dpi, and more preferably 300 dpi to 720 dpi.

As mentioned above, according to the present embodiment, it is possible to provide a recording method which is excellent in all of curability, ejection stability, and minimization of a temperature increase in the ink jet printer 1 after consecutive printing is performed, and which can minimize the occurrence of curing wrinkle. Further, the recording method of the present embodiment which ensures good curability and ejection stability even if an ultraviolet-ray curable ink with low viscosity is used, and which is excellent in the minimization of a temperature increase in the recording apparatus after consecutive printing is performed.

### B. Second Embodiment

In the above-described first embodiment, the ejection state determination process (and the preparation process for performing the ejection state determination process) is (are) performed by performing the process illustrated in the flowchart of FIG. 23. In other words, in the first embodiment, even in a case where the ink temperature T is lower than the temperature Tmin as right after the ink jet printer 1 is powered on, and even in a case where an ink is heated to the temperature Tmin or higher as during a printing process, the process illustrated in the flowchart of FIG. 23 is performed in the same way so as to perform the ejection state determination process and the preparation process thereof.

In contrast, the second embodiment is different from the first embodiment in that, in a case where it is expected that the ink temperature T is lower than the temperature Tmin as right after the ink jet printer 1 is powered on, and in a case where it is expected that the ink temperature T is higher than the temperature Tmin as during a printing process, process procedures (flowchart) of the ejection state determination process and the preparation process thereof are made different.

In addition, an ink jet printer according to the second embodiment has the same configuration as that of the ink jet printer 1 according to the first embodiment except that process procedures of the ejection state determination process and the preparation process thereof are different from those of the ink jet printer 1 according to the first embodiment.

In the second embodiment exemplified below, constituent elements having the same operation or function as that in the first embodiment are given the same reference numerals used in the above description, and detailed description thereof will be appropriately omitted (this is also the same for modified examples described below).

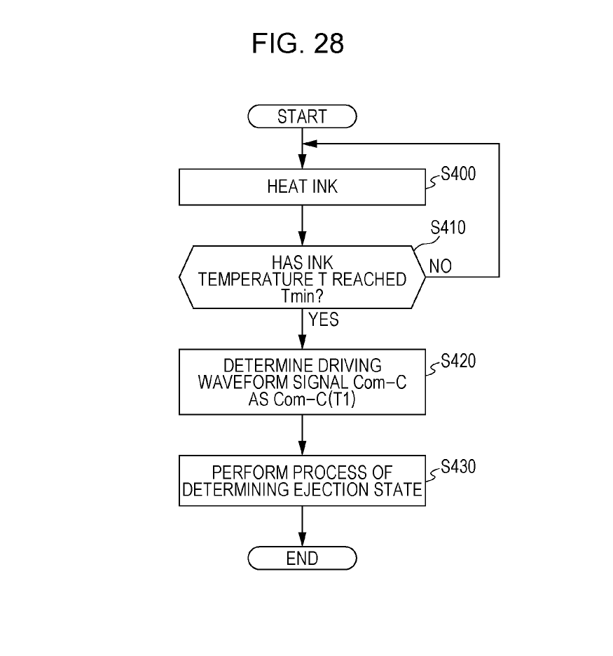

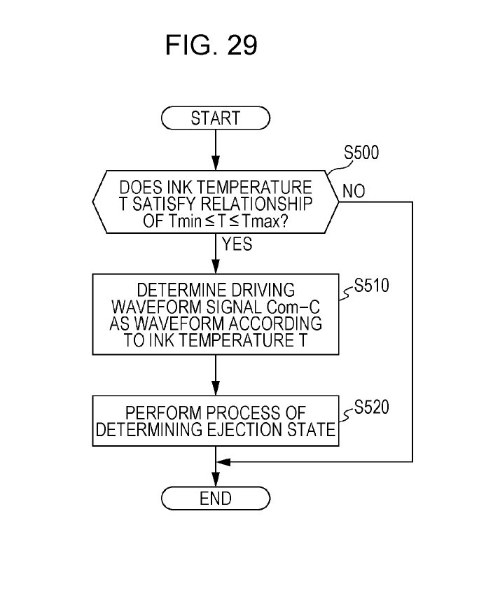

FIGS. 28 and 29 are flowcharts illustrating an example of an operation of the ink jet printer 1 in an ejection state determination process and a preparation process thereof according to the second embodiment.

Of the two flowcharts, FIG. 28 is a flowchart illustrating an example of an ejection state determination process and a preparation process thereof which are performed in a case where it is expected that the ink temperature T is lower than the temperature Tmin as right after the ink jet printer 1 is powered on.

In addition, FIG. 29 is a flowchart illustrating an example of an ejection state determination process and a preparation process thereof which are performed by the ink jet printer 1 in a case where it is expected that the ink temperature T is higher than the temperature Tmin as during a printing process or in a period right before the printing process is performed and right after an ink is heated to the temperature Tmin or higher.

Hereinafter, the ejection state determination process and the preparation process thereof illustrated in FIG. 28 are referred to as a “determination process on starting” in some cases. In addition, the ejection state determination process and the preparation process thereof illustrated in FIG. 29 are referred to as a “determination process during recording” in some cases.

The CPU 61 of the ink jet printer 1 according to the second embodiment performs the determination process on starting illustrated in FIG. 28 in a period until an ink is initially heated from power-on of the ink jet printer 1, or in a period after a sufficient predetermined time when the ink temperature T is reduced to the temperature Tmin or lower has elapsed from finishing of a printing process.

In the determination process on starting, first, the CPU 61 drives the heater 82 so as to heat an ink inside the ejection unit 35 (S400).

Next, the CPU 61 determines whether or not the ink temperature T satisfies “T≧Tmin”, that is, the ink temperature T is increased to the temperature Tmin or higher, on the basis of a detected temperature TS indicated by a temperature detection signal RT which is output by the temperature sensor 81 (S410).

In addition, if a determination result in step S410 is negative, the CPU 61 makes the process proceed to step S400 in order to continuously heat the ink inside the ejection unit 35.

On the other hand, if the determination result in step S410 is affirmative, the CPU 61 sets a waveform of a driving waveform signal Com-C for generating an inspection driving signal Vin which is to be supplied to the ejection unit 35 in the ejection state determination process, to a driving waveform signal Com-C(T1) (S420).

Then, the CPU 61 supplies the driving waveform signal Com-C(T1) to the driving signal generation unit 51. The driving signal generation unit 51 drives the ejection unit 35 by using the driving signal Vin which is generated on the basis of the driving waveform signal Com-C(T1), and, as a result, the ejection state determination process is performed by detecting residual vibration which occurs in the ejection unit 35 (S430).

On the other hand, the CPU 61 of the ink jet printer 1 according to the second embodiment performs the determination process during printing illustrated in FIG. 29, during a printing process, in a period in which the ink has been heated to the temperature Tmin or higher right before performing the printing process, and in which the printing process is not started, or in a period in which the printing process has been finished and a sufficient predetermined time when the ink temperature T is reduced to the temperature Tmin or lower has not elapsed from finishing of a printing process.

In the determination process during printing, first, the CPU 61 determines whether or not the ink temperature T is included in the printing temperature range TP, that is, the ink temperature T satisfies “Tmin≦T≦Tmax”, on the basis of a detected temperature TS indicated by a temperature detection signal RT which is output by the temperature sensor 81 (S500).

If a determination result in step S500 is negative, that is, the ink temperature T is not included in the printing temperature range TP, the CPU 61 regards that the determination process during printing cannot be performed, and finishes the series of processes illustrated in FIG. 29.

On the other hand, if the determination result in step S500 is affirmative, the CPU 61 sets a waveform of the driving waveform signal Com-C for generating an inspection driving signal Vin which is to be supplied to the ejection unit 35 in the ejection state determination process (S510).

Then, the CPU 61 supplies the driving waveform signal Com-C(T) set in step S510 to the driving signal generation unit 51. The driving signal generation unit 51 drives the ejection unit 35 by using the driving signal Vin which is generated on the basis of the driving waveform signal Com-C(T), and, as a result, the ejection state determination process is performed by detecting residual vibration which occurs in the ejection unit 35 (S520).

The CPU 61 functions a “temperature determination unit” by performing at least one of step S410 or step S500. In addition, the CPU 61 functions as a “decision unit” by performing at least one of step S420 or step S510.

As mentioned above, in the present embodiment, it is possible to reduce a process load related to the ejection state determination process and the preparation process thereof by changing process flows related to the ejection state determination process and the preparation process thereof depending on timing at which the ejection state determination process is performed.

In addition, the ink jet printer 1 according to the second embodiment performs the ejection state determination process and the preparation process thereof so as to perform both the determination process on starting and the determination process during printing, but the invention is not limited to this aspect, and at least one of the determination process on starting and the determination process during printing may be performed.

### C. Modified Examples

The above-described respective aspects may be variously modified. Aspects of specific modified examples will be exemplified below. Two or more aspects which are randomly selected from the following exemplified modified examples may be appropriately combined with each other within the scope without mutual conflict.

### Modified Example 1

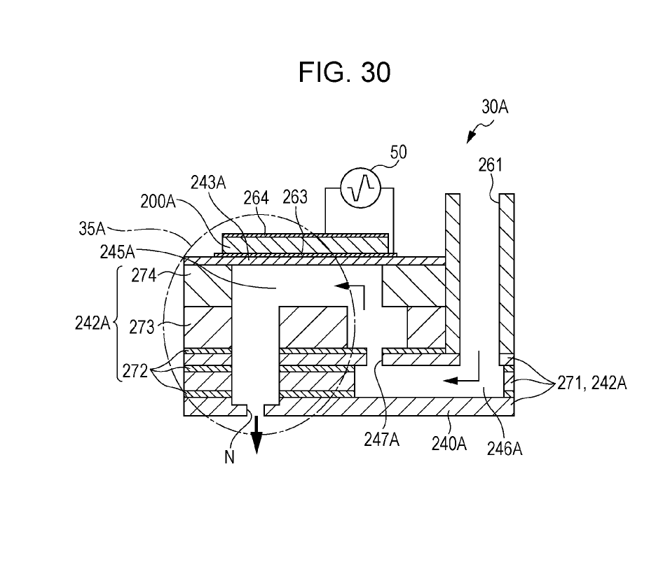

In the above-described embodiments and modified example, the ink jet printer 1 includes the head portion 30 illustrated in FIG. 4, but the invention is not limited to this aspect, and a head unit 30A illustrated in FIG. 30 may be provided instead of the head unit 30 illustrated in FIG. 4.

The head unit 30A illustrated in FIG. 30 is different from the head unit 30 illustrated in FIG. 4 in that an ejection unit 35A is provided instead of the ejection unit 35, and a reservoir 246A is provided instead of the reservoir 246. In addition, the head unit 30A is different from the head unit 30 in that a nozzle plate 240A is provided instead of the nozzle plate 240, and a cavity plate 242A is provided instead of the cavity plate 242.

The ejection unit 35A illustrated in FIG. 30 is different from the ejection unit 35 illustrated in FIG. 4 in that a single piezoelectric element 200A is provided instead of a plurality of piezoelectric elements 200, and a cavity 245A is provided instead of the cavity 245. In the ejection unit 35A, a vibration plate 243A vibrates due to driving of the piezoelectric element 200A, so as to eject ink in the cavity 245A from nozzles N.

The cavity plate 242A includes a first plate 271, an adhesive film 272, a second plate 273, and a third plate 274.

The first plate 271 is joined to the nozzle plate 240A made of stainless steel, provided with the nozzles N, via the adhesive film 272, and the same first plate 271 made of stainless steel is joined thereonto via the adhesive film 272. In addition, the second plate 273 and the third plate 274 are sequentially joined thereonto.

The nozzle plate 240A, the first plate 271, the adhesive film 272, the second plate 273, and the third plate 274 are formed in predetermined shapes (recessed shapes), and are made to overlap each other, so that the cavity 245A and the reservoir 246A are formed. The cavity 245A and the reservoir 246A communicate with each other via an ink supply port 247A. In addition, the reservoir 246A communicates with an ink intake port 261.

The vibration plate 243A is provided in an upper opening of the third plate 274, and the piezoelectric element 200A is joined to the vibration plate 243A via a lower electrode 263. In addition, an upper electrode 264 is joined to the piezoelectric element 200A on an opposite side to the lower electrode 263. The driving signal generation unit 51 supplies a driving signal Vin between the upper electrode 264 and the lower electrode 263, so as to cause the piezoelectric element 200A to vibrate, and thus to cause the vibration plate 243A joined thereto to vibrate. A volume of the cavity 245A (pressure in the cavity) varies due to the vibration of the vibration plate 243A, and thus ink which fills the cavity 245A is ejected from the nozzles N.

In a case where the ink is ejected, and thus an ink amount in the cavity 245A is reduced, ink is supplied from the reservoir 246A. In addition, ink is supplied to the reservoir 246A from the ink cartridge 31 via the ink intake port 261.

### Modified Example 2

In the above-described embodiments and modified examples, the serial printer in which a main scanning direction of the head unit 30 is different from a sub-scanning direction of the recording paper P to be transported has been described as an example of an ink jet printer, but the invention is not limited thereto, and a line printer may be used in which a width of the head unit is equal to or greater than a width of the recording paper P.

### Modified Example 3

In the above-described embodiments and modified examples, a driving signal waveform signal Com includes three signals including Com-A, Com-B, and Com-C, but the invention is not limited to this aspect. The driving signal waveform signal Com may include a single signal (for example, only Com-A), and may include any number of signals of two or more (for example, Com-A and Com-B).

In addition, in the above-described embodiments and modified examples, the control unit 6 simultaneously supplies, as the driving waveform signal Com, driving waveform signals Com-A and Com-B (hereinafter, referred to as printing driving waveform signals) for generating a driving signal Vin for printing along with a driving waveform signal Com-C (hereinafter, referred to as an inspection driving waveform signal) for generating a driving signal Vin for inspection in each unit operation period Tu, and the invention is not limited to this aspect. For example, in a case where a printing process is performed in a certain unit operation period Tu, the control unit 6 supplies the driving waveform signal Com (for example, the driving waveform signal Com including only Com-A and Com-B) including the printing driving waveform signals, and, in a case where an ejection state determination process or a determination reference setting process is performed in a certain unit operation period Tu, the control unit supplies the driving waveform signal Com (for example, Com-C instead of Com-A) including only an inspection driving waveform signal. As mentioned above, a waveform of each signal included in the driving waveform signal Com may be changed depending on a type of process performed in each unit operation period Tu.

In addition, the number of bits of the printing signal SI is not limited to 3 bits, and may be determined as appropriate depending on a grayscale to be displayed or the number of signals included in the driving waveform signal Com.

### Modified Example 4

In the above-described embodiments and modified examples, in a case where a printing process is performed in a certain unit operation period U, a printing driving signal Vin is supplied to the ejection unit 35, and in a case where an ejection state determination process or a calibration process is performed in another unit operation period U, an inspection driving signal Vin is supplied to the ejection unit 35, but the invention is not limited to this aspect. For example, both the printing driving signal Vin and the inspection driving signal Vin may be supplied to the ejection unit 35 in each unit operation period U, for example, in a time division manner.

In a case where both the printing driving signal Vin and the inspection driving signal Vin are supplied to the ejection unit 35 in a unit operation period U in a time division manner, the CPU 61 may perform both the present disclosure and the ejection state determination process in the corresponding unit operation period U.

However, in this case, the ejection state determination process is preferably in a “non-ejection inspection” state in which an ejection state is inspected without ejecting ink from the ejection unit 35.

In addition, in a case where both the printing driving signal Vin and the inspection driving signal Vin are supplied to the ejection unit 35 in each unit operation period U in a time division manner, the CPU 61 may control the switching unit 53 to be turned to a second connection state in a switching period Ud of each unit operation period U. In other words, in any case where the ink jet printer 1 performs the printing process, the ejection state determination process, or the calibration process, and in a case where the ink temperature T is any temperature, a connection state of the switching unit 53 may be controlled so that the switching unit 53 is in the second connection state at all times in the switching period Ud of each unit operation period U.

In this case, the residual vibration detection unit 55 may detect a residual vibration signal Vout at all times regardless of the type of process performed by the ink jet printer 1, or regardless of the ink temperature T.

In addition, in this case, the ejection state determination unit 56 may output a determination result signal Rs at all times regardless of the type of process performed by the ink jet printer 1, or regardless of the ink temperature T.

Further, in this case, the CPU 61 may acquire the determination result signal Rs output by the ejection state determination unit 56 (for example, a process of storing a value of the determination result signal Rs is stored in the storage unit 62) only in a case the ink temperature T is included in the printing temperature range TP, and the ejection state determination process or the calibration process is performed in a certain unit operation period U. In other words, the CPU 61 may not acquire but discard the determination result signal Rs in a case where the printing process is performed, and in a case where the ink temperature T is not included in the printing temperature range TP.

As mentioned above, even in a case where the residual vibration detection unit 55 detects the residual vibration signal Vout all unit operation periods U or a case where the ejection state determination unit 56 outputs the determination result signal Rs in all unit operation periods U, the CPU 61 acquires the determination result signal Rs only in a case where the ink temperature T is included in the printing temperature range TP, and thus can accurately determine an ink ejection state in the ejection unit 35.

### Modified Example 5

In the above-described embodiments and modified examples, an ultraviolet-ray curable ink is exemplified as ink used in the ink jet printer 1, but the ink jet printer 1 of the embodiments of the invention is not limited to using the ultraviolet-ray curable ink, and may use any kind of ink.

Typically, viscosity of ink varies depending on a temperature of the ink. For this reason, regardless of the kind of ink used in the ink jet printer 1, as in the embodiments of the invention, the ejection state determination process is performed in consideration of a temperature of the ink, and thus it is possible to perform accurate ejection state determination based on a viscosity variation of the ink.

### Modified Example 6

In the above-described embodiments and modified examples, a temperature range in which the printing process is performed, a temperature range in which the ejection state determination process is performed, and a temperature range in which the calibration process is performed are all the same temperature range (printing temperature range TP), but the invention is not limited to this aspect, and the temperature ranges may not match each other.

In other words, the printing process may be performed in a temperature range suitable for performing the printing process, the ejection state determination process may be performed in a temperature range suitable for performing the ejection state determination process, and the calibration process may be performed in a temperature range suitable for performing the calibration process.

### Modified Example 7

In the above-described embodiments and modified examples, the head driver 50 generates driving signals Vin which are supplied to the M ejection units 35, on the basis of the same driving waveform signal Com, but the invention is not limited to this aspect. The head driver may generate driving signals Vin for each of the M ejection units 35 corresponding to each nozzle string on the basis of the four driving waveform signals Com which have a one-to-one relationship with four nozzle strings.

For example, the control unit 6 may output four driving waveform signals Com including a driving waveform signal Com corresponding to yellow, a driving waveform signal Com corresponding to cyan, a driving waveform signal Com corresponding to magenta, and a driving waveform signal Com corresponding to black, to the head driver 50. In addition, in this case, the head driver 50 may supply a driving signal Vin which is generated on the basis of the driving waveform signal Com corresponding to yellow, to the M ejection units 35 corresponding to a yellow nozzle string, may supply a driving signal Vin which is generated on the basis of the driving waveform signal Com corresponding to cyan, to the M ejection units 35 corresponding to a cyan nozzle string, may supply a driving signal Vin which is generated on the basis of the driving waveform signal Com corresponding to magenta, to the M ejection units 35 corresponding to a magenta nozzle string, and may supply a driving signal Vin which is generated on the basis of the driving waveform signal Com corresponding to black, to the M ejection units 35 corresponding to a black nozzle string. In addition, in this case, the head driver 50 may include, for example, four driving signal generation units 51 including a driving signal generation unit 51 corresponding to yellow, a driving signal generation unit 51 corresponding to cyan, a driving signal generation unit 51 corresponding to magenta, and a driving signal generation unit 51 corresponding to black.

### Modified Example 8

In the above-described embodiments and modified examples, the ink jet printer 1 includes the heater 82 as a device which changes the ink temperature T, but the invention is not limited to this aspect, and a cooler having a function of reducing the ink temperature T may be provided as a device which changes the ink temperature T.

For example, if a determination result in step S110 of FIG. 23 or in step S210 of FIG. 26 is negative, the ejection state determination process may be performed after the ink temperature T is reduced to the temperature Tmax or lower by the cooler.

The entire disclosure of Japanese Patent Application No. 2013-211021, filed Oct. 8, 2013 is expressly incorporated by reference herein.

What is claimed is:

1. A printing apparatus, comprising:
a driving signal generation unit that generates a driving signal;
an ejection unit that includes a piezoelectric element which is displaced according to the driving signal, a pressure chamber whose inside is filled with a liquid and in which a pressure in the inside is increased or decreased due to the displacement of the piezoelectric element based on the driving signal, and a nozzle which communicates with the pressure chamber and is capable of ejecting the liquid filled in the inside of the pressure chamber due to the increase or the decrease of the pressure in the inside of the pressure chamber;
a detection unit that detects a change of an electromotive force of the piezoelectric element as a residual vibration signal based on a change of the pressure in the inside of the pressure chamber, which is generated after the driving signal is supplied to the piezoelectric element in a case where the temperature of the liquid filled in the inside of the pressure chamber is within a predetermined temperature range; and
an ejection state determination unit that determines an ejection state of the liquid in the ejection unit based on the detection result of the detection unit.

2. A printing apparatus, comprising:
a driving signal generation unit that generates a driving signal;
an ejection unit that includes a piezoelectric element which is displaced according to the driving signal, a pressure chamber whose inside is filled with a liquid and in which a pressure in the inside is increased or decreased due to the displacement of the piezoelectric element based on the driving signal, and a nozzle which communicates with the pressure chamber and is capable of ejecting the liquid filled in the inside of the pressure chamber due to the increase or the decrease of the pressure in the inside of the pressure chamber;
an output unit that outputs a detection signal indicating a value of a volume of the liquid filled in the inside of the pressure chamber according to the temperature;
a temperature determination unit that determines whether the value indicated by the detection signal is a value indicating that the temperature of the liquid filled in the inside of the pressure chamber is within a predetermined temperature range;
a detection unit that detects a change of an electromotive force of the piezoelectric element as a residual vibration signal based on a change of the pressure in the inside of the pressure chamber, which is generated after the driving signal for inspection is supplied to the piezoelectric element by the driving signal generation unit; and
an ejection state determination unit that is capable of determining an ejection state of the liquid in the ejection state based on the detection result of the detection unit,
wherein the ejection state determination unit determines the ejection state of the liquid in the ejection state in a case where the detection result of the temperature determination unit is positive and does not determine the ejection state of the liquid in the ejection state in a case where the detection result of the temperature determination unit is negative.

3. The printing apparatus according to claim 2, further comprising a heating unit that heats the liquid in the inside of the pressure chamber in a case where the value indicated by the detection signal is a value indicating that the temperature of the liquid filled in the inside of the pressure chamber is lower than a lower limit of the predetermined temperature range.

4. The printing apparatus according to claim 2, further comprising a decision unit that decides a waveform of the driving signal for inspection according to the value indicated by the detection signal.

5. The printing apparatus according to claim 4, wherein the decision unit performs a calibration operation of adjusting the waveform of the driving signal for inspection in a case where the value indicated by the detection signal is a value indicating that the temperature of the liquid filled in the inside of the pressure chamber is within the predetermined temperature range.

6. The printing apparatus according to claim 1, wherein a viscosity of the liquid at 20° C. is in the range of 15 mPa·s to 25 mPa·s.

7. The printing apparatus according to claim 6,
wherein the predetermined temperature range is in the range of 30° C. to 40° C., and
the viscosity of the liquid in the predetermined temperature range is in the range of 8 mPa·s to 15 mPa·s.

8. The printing apparatus according to claim 6,
wherein the predetermined temperature range is in the range of 30° C. to 40° C., and
the liquid is an ultraviolet curable ink having an average equivalent of a polymerizable unsaturated double bond of 100 to 150.

9. The printing apparatus according to claim 8, wherein the ultraviolet curable ink contains monofunctional (meth)acrylate having a content of 30% by mass to 70% by mass and bifunctional or multi-functional (meth)acrylate having a content of 20% by mass to 60% by mass.

10. The printing apparatus according to claim 8, wherein the ultraviolet curable ink is an ink which is cured by performing irradiation of an irradiation energy of 200 mJ/cm² or less.

11. A method of controlling a printing apparatus which includes a driving signal generation unit that generates a driving signal; and an ejection unit that includes a piezoelectric element which is displaced according to the driving signal, a pressure chamber whose inside is filled with a liquid and in which a pressure in the inside is increased or decreased due to the displacement of the piezoelectric element based on the driving signal, and a nozzle which communicates with the pressure chamber and is capable of ejecting the liquid filled in the inside of the pressure chamber due to the increase or the decrease of the pressure in the inside of the pressure chamber, the method comprising:
detecting a change of an electromotive force of the piezoelectric element as a residual vibration signal based on a change of the pressure in the inside of the pressure chamber, which is generated after the driving signal is supplied to the piezoelectric element in a case where the temperature of the liquid filled in the inside of the pressure chamber is within a predetermined temperature range; and
determining an ejection state of the liquid in the ejection unit based on the detection result of the detection unit.
